(19) United States
(12) Patent Application Publication
(10) Pub. No.: US 2025/0113227 A1
(43) Pub. Date: Apr. 3, 2025

(54) MANAGING GATEWAY FUNCTION OPERATION IN WIRELESS NETWORK

(71) Applicant: SAMSUNG ELECTRONICS CO., LTD., Suwon-si (KR)

(72) Inventors: Murali REDDIBOYANA, Bangalore (IN); Gururaj B. MALANNAVAR, Bangalore (IN); Abhilasha SHARMA, Bangalore (IN); Mustque AHMED, Bangalore (IN)

(73) Assignee: SAMSUNG ELECTRONICS CO., LTD., Suwon-si (KR)

(21) Appl. No.: 18/618,411

(22) Filed: Mar. 27, 2024

Related U.S. Application Data
(63) Continuation of application No. PCT/KR2024/002168, filed on Feb. 20, 2024.

(30) Foreign Application Priority Data
Sep. 29, 2023 (IN) 202341065649

(51) Int. Cl. H04W 24/10; H04W 24/08; H04W 88/16

(52) U.S. Cl. CPC H04W 24/10; H04W 24/08; H04W 88/16

(57) ABSTRACT

A method for managing an operation of a wireline access gateway function (W-AGF) in a wireless network is disclosed. The method comprises transmitting, by a W-AGF control plane (W-AGF-C) entity of the W-AGF to a W-AGF user plane (W-AGF-U) entity of the W-AGF, a performance statistics request message for at least one object; and receiving, by the W-AGF-C entity from the W-AGF-U entity, a performance statics response message in response to the performance statistics request message.

### CROSS-REFERENCE TO RELATED APPLICATIONS

This application is a continuation of International Application No. PCT/KR2024/002168, designating the United States, filed on Feb. 20, 2024, in the Korean Intellectual Property Receiving Office and claiming priority to Indian Patent Application No. 202341065649, filed on Sep. 29, 2023, in the Indian Patent Office, the disclosures of which are incorporated by reference herein in their entireties.

### TECHNICAL FIELD

The disclosure relates to wireless networks, and more particularly, to methods and a wireless network for managing a gateway function operation.

### BACKGROUND

A control and user plane separation (CUPS) architecture may be adopted in a fourth generation (4G) core network and/or a fifth generation (5G) core network. Alternatively or additionally, the CUPS architecture may be adopted in a gNodeB (gNB) in the 5G core network between a gNB central unit control plane (gNB-CU-CP) and a gNB central unit user plane (gNB-CU-UP). However, the CUPS architecture may not be adopted in a Trusted Non-3rd Generation Partnership Project (Non-3GPP) Gateway Function (TNGF). For example, according to a 3GPP standard, the TNGF may be monolithic. In other words, the TNGF may have a role that may be similar to the role of the gNB in a 5G network. The TNGF and the gNB may have a N2 interface towards an access and mobility management function (AMF) entity and a N3 interface towards a user plane function (UPF). The gNB may be split into the gNB-CU-CP and the gNB-CU-UP. A 3GPP E1 interface may be used between the gNB-CU-CP and the gNB-CU-UP. However, the TNGF may be a single network element. It may be desirable to have the CUPS architecture on the TNGF. Thus, there is a need for a new 3GPP interface (e.g., E11) between a TNGF control plane (TNGF-C) entity and a TNGF user plane (TNGF-U) entity.

Similarly, the CUPS architecture may be adopted in the 4G core network and/the 5G core network. The CUPS architecture may be adopted in the gNB in the 5G core network between the gNB-CU-CP and the gNB-CU-UP. However, the CUPS architecture may not be adopted in a wireline access gateway function (W-AGF). For example, according to a 3GPP standard, the W-AGF may be monolithic. In other words, the W-AGF may have a role that may be similar to the role of the gNB in the 5G network. The W-AGF and the gNB may have a N2 interface towards the AMF entity and a N3 interface towards the UPF entity. The gNB may be split into the gNB-CU-CP and the gNB-CU-UP. A 3GPP E1 interface may be used between the gNB-CU-CP and the gNB-CU-UP. However, the W-AGF may be single network element. It may be desirable to have the CUPS architecture on the W-AGF. Thus, there is a need for a new 3GPP interface (E12) between a W-AGF control plane (W-AGF-C) entity and a W-AGF user plane (W-AGF-U) entity.

There exists a need for further improvements in gateway function operation technology, as the need for interfaces between control plane and user plane entities may be constrained by a lack of adoption of a CUPS architecture. Improvements are presented herein. These improvements may also be applicable to other wireless communication technologies and the telecommunication standards that employ these technologies.

### SUMMARY

Example embodiments of the present disclosure provide methods and a wireless network for managing a gateway function operation (e.g., trusted non-3GPP gateway function (TNGF) operation, and wireline access gateway function (W-AGF) operation) in the wireless network.

Further, one or more example embodiments of the present disclosure provide control and user plane separation (CUPS) on a TNGF by splitting the TNGF into a TNGF-C entity and a TNGF-U entity.

Further, one or more example embodiments of the present disclosure provide CUPS on a W-AGF by splitting the W-AGF into a W-AGF-C entity and a W-AGF-U entity.

According to an aspect of the disclosure, a method for managing an operation of a wireline access gateway function (W-AGF) in a wireless network is disclosed. The method may comprise transmitting, by a W-AGF control plane (W-AGF-C) entity of the W-AGF to a W-AGF user plane (W-AGF-U) entity of the W-AGF, a performance statistics request message for at least one object. The method may comprise receiving, by the W-AGF-C entity from the W-AGF-U entity, a performance statics response message in response to the performance statistics request message.

According to an aspect of the disclosure, an apparatus for wireline access gateway function (W-AGF) in a wireless network is disclosed. The apparatus may comprise a memory storing instructions; and at least one processor configured to, when executing the instructions, may cause the apparatus to perform operations. The operations may comprise transmitting, by a W-AGF control plane (W-AGF-C) entity of the W-AGF to a W-AGF user plane (W-AGF-U) entity of the W-AGF, a performance statistics request message for at least one object. The operations may comprise receiving, by the W-AGF-C entity from the W-AGF-U entity, a performance statics response message in response to the performance statistics request message.

According to an aspect of the disclosure, a non-transitory computer readable storage medium storing instructions is disclosed. The instructions, when executed by at least one processor of an apparatus for a wireline access gateway function (W-AGF) in a wireless network, may cause the apparatus to perform operations. The operations may comprise transmitting, by a W-AGF control plane (W-AGF-C) entity of the W-AGF to a W-AGF user plane (W-AGF-U) entity of the W-AGF, a performance statistics request message for at least one object. The operations may comprise receiving, by the W-AGF-C entity from the W-AGF-U entity, a performance statics response message in response to the performance statistics request message.

According to an aspect of the disclosure, a method for managing a trusted non-3rd Generation Partnership Project (Non-3GPP) gateway function (TNGF) operation in a wireless network includes splitting a TNGF function as a TNGF control plane (TNGF-C) entity and a TNGF user plane (TNGF-U) entity, performing control plane signalling by the TNGF-C entity, and performing user plane signalling by the TNGF-U entity.

According to an aspect of the disclosure, a TNGF-C entity includes a processor, a memory, and an interface controller, coupled with the processor and the memory, configured to perform control plane signalling of the TNGF-C entity, add an E11 interface between the TNGF-C entity and at least one TNGF-U entity, and monitor at least one of an operation associated with the E11 interface and a service associated with the E11 interface.

According to an aspect of the disclosure, a TNGF-U entity includes a processor, a memory, and an interface controller, coupled with the processor and the memory, configured to perform user plane signalling of the TNGF-U entity, add an E11 interface between a TNGF-C entity and the TNGF-U entity, and monitor at least one of an operation associated with the E11 interface and a service associated with the E11 interface.

According to an aspect of the disclosure, a method for managing a wireline access gateway function (W-AGF) operation in a wireless network includes splitting a W-AGF function as a W-AGF control plane (W-AGF-C) entity and a W-AGF user plane (W-AGF-U) entity, performing control plane signalling by the W-AGF-C entity, and performing user plane signalling by the W-AGF-U entity.

According to an aspect of the disclosure, a W-AGF-C entity includes a processor, a memory, and an interface controller, coupled with the processor and the memory, configured to perform control plane signalling of the W-AGF-C entity, add an E12 interface between the W-AGF-C entity and at least one W-AGF-U entity, and monitor at least one of an operation associated with the E12 interface and a service associated with the E12 interface.

According to an aspect of the disclosure, a W-AGF-U entity includes a processor, a memory, and an interface controller, coupled with the processor and the memory, configured to performing user plane signalling of the W-AGF-U entity, add an E12 interface between a W-AGF-C entity and the W-AGF-U entity, and monitor at least one of an operation associated with the E12 interface and a service associated with the E12 interface.

The above and other aspects of the example embodiments described herein may be apparent when considered in conjunction with the following description and the accompanying drawings. It is to be understood, however, that the following descriptions, while indicating example embodiments and numerous specific details thereof, may be given by way of illustration and not of limitation. Many changes and modifications may be made within the scope of the example embodiments herein without departing from the scope thereof, and the example embodiments herein may include such modifications.

### BRIEF DESCRIPTION OF FIGURES

The above and other aspects, features, and advantages of certain embodiments of the present disclosure may be more apparent from the following description taken in conjunction with the accompanying drawings, in which:

FIG. 1 illustrates a Trusted Non-3GPP Gateway Function (TNGF) control and user plane separation (CUPS) architecture, according to an embodiment;

FIG. 2 illustrates a signalling for a user plane establishment, according to an embodiment;

FIG. 3 illustrates an E11 interface protocol structure, according to an embodiment;

FIG. 4A and FIG. 4B illustrate a control plane connection, according to an embodiment;

FIG. 5 illustrates a user plane connectivity and a user plane terminating at a TNGF user plane (TNGF-U) entity, according to an embodiment;

FIG. 6 is a sequence diagram illustrating a reset procedure initiated from a TNGF control plane (TNGF-C) entity, according to an embodiment;

FIG. 7 is a sequence diagram illustrating a reset procedure initiated from a TNGF-U entity, according to an embodiment;

FIG. 8 is a sequence diagram illustrating an error indication procedure originated at the TNGF-C entity, according to an embodiment;

FIG. 9 is a sequence diagram illustrating an error indication procedure originated at the TNGF-U entity, according to an embodiment;

FIG. 10 is a sequence diagram illustrating a TNGF-U E11 setup procedure during a success scenario, according to an embodiment;

FIG. 11 is a sequence diagram illustrating a TNGF-U E11 setup procedure during a failure scenario, according to an embodiment;

FIG. 12 is a sequence diagram illustrating a TNGF-C E11 setup procedure during a success scenario, according to an embodiment;

FIG. 13 is a sequence diagram illustrating a TNGF-C E11 setup procedure during a failure scenario, according to an embodiment;

FIG. 14 is a sequence diagram illustrating a TNGF-U configuration update procedure during a success scenario, according to an embodiment;

FIG. 15 is a sequence diagram illustrating a TNGF-U configuration update procedure during a failure scenario, according to an embodiment;

FIG. 16 is a sequence diagram illustrating a TNGF-C configuration update procedure during a success scenario, according to an embodiment;

FIG. 17 is a sequence diagram illustrating a TNGF-C configuration update procedure during a failure scenario, according to an embodiment;

FIG. 18 is a sequence diagram illustrating an E11 release procedure initiated from the TNGF-C entity, according to an embodiment;

FIG. 19 is a sequence diagram illustrating a E11 release procedure initiated from the TNGF-U entity, according to an embodiment;

FIG. 20 is a sequence diagram illustrating a TNGF-U status indication procedure, according to an embodiment;

FIG. 21 is a sequence diagram illustrating a resource status reporting initiation during a success scenario, according to an embodiment;

FIG. 22 is a sequence diagram illustrating a resource status reporting initiation during a failure scenario, according to an embodiment;

FIG. 23 is a sequence diagram illustrating a resource status reporting during a success scenario, according to an embodiment;

FIG. 24 is a sequence diagram illustrating a bearer context setup procedure during a success scenario, according to an embodiment;

FIG. 25 is a sequence diagram illustrating a bearer context setup procedure during a failure scenario, according to an embodiment;

FIG. 26 is a sequence diagram illustrating a bearer context modification procedure during a success scenario, according to an embodiment;

FIG. 27 is a sequence diagram illustrating a bearer context modification procedure during a failure scenario, according to an embodiment;

FIG. 28 is a sequence diagram illustrating a bearer context modification required procedure during a success scenario, according to an embodiment;

FIG. 29 is a sequence diagram illustrating a bearer context release procedure, according to an embodiment;

FIG. 30 is a sequence diagram illustrating a bearer context release request procedure, according to an embodiment;

FIG. 31 is a sequence diagram illustrating a bearer context inactivity notification procedure, according to an embodiment;

FIG. 32 is a sequence diagram illustrating a DL data notification procedure, according to an embodiment;

FIG. 33 is a sequence diagram illustrating a data usage report procedure, according to an embodiment;

FIG. 34 is a sequence diagram illustrating a UL data notification procedure, according to an embodiment;

FIG. 35 is a sequence diagram illustrating a trace start procedure, according to an embodiment;

FIG. 36 is a sequence diagram illustrating a deactivate trace procedure, according to an embodiment;

FIG. 37 is a sequence diagram illustrating a TNGF-C heartbeat procedure, according to an embodiment;

FIG. 38 is a sequence diagram illustrating a TNGF-U heartbeat procedure, according to an embodiment;

FIG. 39 is a sequence diagram illustrating a performance statistics reporting initiation during a success scenario, according to an embodiment;

FIG. 40 is a sequence diagram illustrating a performance statistics reporting initiation during a failure scenario, according to an embodiment;

FIG. 41 is a sequence diagram illustrating a performance statistics reporting during a success scenario, according to an embodiment;

FIG. 42 is a sequence diagram illustrating a peer user plane feedback reporting initiation during a success scenario, according to an embodiment;

FIG. 43 is a sequence diagram illustrating a peer user plane feedback reporting initiation during a failure scenario, according to an embodiment;

FIG. 44 is a sequence diagram illustrating a peer user plane feedback reporting during a success scenario, according to an embodiment;

FIG. 45 is a sequence diagram illustrating an IPSec performance statistics reporting initiation during a success scenario, according to an embodiment;

FIG. 46 is a sequence diagram illustrating an Internet Protocol Security (IPSec) performance statistics reporting initiation during a failure scenario, according to an embodiment;

FIG. 47 is a sequence diagram illustrating a IPSec performance statistics reporting during a success scenario, according to an embodiment;

FIG. 48 is a sequence diagram illustrating a peer IPSec feedback reporting initiation during a success scenario, according to an embodiment;

FIG. 49 is a sequence diagram illustrating a peer IPSec feedback reporting initiation during a failure scenario, according to an embodiment;

FIG. 50 is a sequence diagram illustrating a peer IPSec feedback reporting during a success scenario, according to an embodiment;

FIG. 51 shows various hardware components of an wireless network, according to an embodiment;

FIG. 52 is a flowchart illustrating methods for managing a TNGF operation in a wireless network, according to an embodiment;

FIG. 53 illustrates a fifth generation (5G) core network for a 5G residential gateway (5G-RG) with a wireline access gateway function (W-AGF) and a next generation radio access network (NG RAN), according to an embodiment;

FIG. 54 illustrates a 5G core network for a fixed network residential gateway (FN-RG) with a W-AGF and a NG RAN, according to an embodiment;

FIG. 55A and FIG. 55B illustrate a signalling for a user plane establishment, according to an embodiment;

FIG. 56 illustrates an E12 interface protocol structure, according to an embodiment;

FIG. 57A illustrates a control plane stack for a wireline 5G access network (W-5GAN-C) (W-AGF-C) for a 5G-RG, according to an embodiment;

FIG. 57B illustrates a control plane stack for a W-5GAN-C (W-AGF-C) for a FN-RG, according to an embodiment;

FIG. 58 illustrates a V-interface protocol stack for the FN-RG, according to an embodiment;

FIG. 59 illustrates a user plane stack for W-5GAN (W-AGF-U) for 5G-RG, according to an embodiment;

FIG. 60 illustrates a user plane stack for W-5GAN (W-AGF-U) for FG-RG, according to an embodiment;

FIG. 61 is a sequence diagram illustrating a reset procedure initiated from a W-AGF-C entity, according to an embodiment;

FIG. 62 is a sequence diagram illustrating a reset procedure initiated from a W-AGF-U entity, according to an embodiment;

FIG. 63 is a sequence diagram illustrating an error indication procedure originated at the W-AGF-C entity, according to an embodiment;

FIG. 64 is a sequence diagram illustrating an error indication procedure originated at the W-AGF-U entity, according to an embodiment;

FIG. 65 is a sequence diagram illustrating a W-AGF-U E12 setup procedure during a success scenario, according to an embodiment;

FIG. 66 is a sequence diagram illustrating a W-AGF-U E12 setup procedure during a failure scenario, according to an embodiment;

FIG. 67 is a sequence diagram illustrating a W-AGF-C E12 setup procedure during a success scenario, according to an embodiment;

FIG. 68 is a sequence diagram illustrating a W-AGF-C E12 setup procedure during a failure scenario, according to an embodiment;

FIG. 69 is a sequence diagram illustrating a W-AGF-U configuration update procedure during a success scenario, according to an embodiment;

FIG. 70 is a sequence diagram illustrating a W-AGF-U configuration update procedure during a failure scenario, according to an embodiment;

FIG. 71 is a sequence diagram illustrating a W-AGF-C configuration update procedure during a success scenario, according to an embodiment;

FIG. 72 is a sequence diagram illustrating a W-AGF-C configuration update procedure during a failure scenario, according to an embodiment;

FIG. 73 is a sequence diagram illustrating an E12 release procedure initiated from the W-AGF-C entity, according to an embodiment;

FIG. 74 is a sequence diagram illustrating a E12 release procedure initiated from the W-AGF-U entity, according to an embodiment;

FIG. 75 is a sequence diagram illustrating a W-AGF-U status indication procedure, according to an embodiment;

FIG. 76 is a sequence diagram illustrating a resource status reporting initiation during a success scenario, according to an embodiment;

FIG. 77 is a sequence diagram illustrating a resource status reporting initiation during a failure scenario, according to an embodiment;

FIG. 78 is a sequence diagram illustrating a resource status reporting during a success scenario, according to an embodiment;

FIG. 79 is a sequence diagram illustrating a bearer context setup procedure during a success scenario, according to an embodiment;

FIG. 80 is a sequence diagram illustrating a bearer context setup procedure during a failure scenario, according to an embodiment;

FIG. 81 is a sequence diagram illustrating a bearer context modification procedure during a success scenario, according to an embodiment;

FIG. 82 is a sequence diagram illustrating a bearer context modification procedure during a failure scenario, according to an embodiment;

FIG. 83 is a sequence diagram illustrating a bearer context modification required procedure during a success scenario, according to an embodiment;

FIG. 84 is a sequence diagram illustrating a bearer context release procedure, according to an embodiment;

FIG. 85 is a sequence diagram illustrating a bearer context release request procedure, according to an embodiment;

FIG. 86 is a sequence diagram illustrating a bearer context inactivity notification procedure, according to an embodiment;

FIG. 87 is a sequence diagram illustrating a downlink (DL) data notification procedure, according to an embodiment;

FIG. 88 is a sequence diagram illustrating a data usage report procedure, according to an embodiment;

FIG. 89 is a sequence diagram illustrating an uplink (UL) data notification procedure, according to an embodiment;

FIG. 90 is a sequence diagram illustrating a trace start procedure, according to an embodiment;

FIG. 91 is a sequence diagram illustrating a deactivate trace procedure, according to an embodiment;

FIG. 92 is a sequence diagram illustrating a W-AGF-C heartbeat procedure, according to an embodiment;

FIG. 93 is a sequence diagram illustrating a W-AGF-U heartbeat procedure, according to an embodiment;

FIG. 94 is a sequence diagram illustrating a performance statistics reporting initiation during a success scenario, according to an embodiment;

FIG. 95 is a sequence diagram illustrating a performance statistics reporting initiation during a failure scenario, according to an embodiment;

FIG. 96 is a sequence diagram illustrating a performance statistics reporting during a success scenario, according to an embodiment;

FIG. 97 is a sequence diagram illustrating a peer user plane feedback reporting initiation during a success scenario, according to an embodiment;

FIG. 98 is a sequence diagram illustrating a peer user plane feedback reporting initiation during a failure scenario, according to an embodiment;

FIG. 99 is a sequence diagram illustrating a peer user plane feedback reporting during a success scenario, according to an embodiment;

FIG. 100 shows various hardware components of an wireless network, according to an embodiment; and

FIG. 101 is a flowchart illustrating methods for managing a W-AGF operation in the wireless network, according to an embodiment.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. The description herein is intended merely to facilitate an understanding of ways in which the example embodiments herein may be practiced and to further enable those of skill in the art to practice the example embodiments herein. Accordingly, the present disclosure may not be construed as limiting the scope of the example embodiments herein.

For the purposes of interpreting the present disclosure, the descriptions (as used herein) may apply and whenever appropriate the terms used in singular may also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.”, is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

It may be noted that elements in the drawings are illustrated for the purposes of this description and for ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that may be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that may be readily apparent to those of ordinary skill in the art having the benefit of the description herein.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The accompanying drawings are used to help easily understand various technical features and it is to be understood that the embodiments presented herein are not limited by the accompanying drawings. As such, the present disclosure may be construed to extend to any modifications, equivalents, and substitutes in addition to those which are particularly set out in the accompanying drawings and the corresponding description. Usage of words such as first, second, third, and the like, to describe components/elements/steps is for the purposes of this description and may not be construed as sequential ordering/placement/occurrence unless specified otherwise.

The embodiments herein may provide methods for managing a Trusted Non-3rd Generation Partnership Project (Non-3GPP) Gateway Function (TNGF) operation in a wireless network. The method may include splitting a TNGF gateway function as a TNGF control plane (TNGF-C) entity and a TNGF user plane (TNGF-U) entity. Further, the method may include handling a control plane signalling by the TNGF-C entity and a user plane signalling by the TNGF-U entity.

Unlike related methods and systems, the proposed method may be used to introduce a control and user plane separation (CUPS) architecture on the TNGF by splitting the TNGF into the TNGF-C entity and the TNGF-U entity and by introducing an interface (e.g., E11 interface) between the TNGF-C entity and the TNGF-U entity.

The embodiments herein may provide methods for managing a wireline access gateway function (W-AGF) operation in a wireless network. The method includes configuring a W-AGF gateway function as a W-AGF control plane (W-AGF-C) entity and a W-AGF user plane (W-AGF-U) entity. Further, the method may include handling a control plane signalling by the W-AGF-C entity and a user plane signalling by the W-AGF-U entity.

Unlike related methods and systems, the proposed method may be used to introduce a CUPS architecture on the W-AGF by splitting the W-AGF into the W-AGF-C entity and the W-AGF-U entity and by introducing an interface (e.g., E12 interface) between the W-AGF-C entity and the W-AGF-U entity.

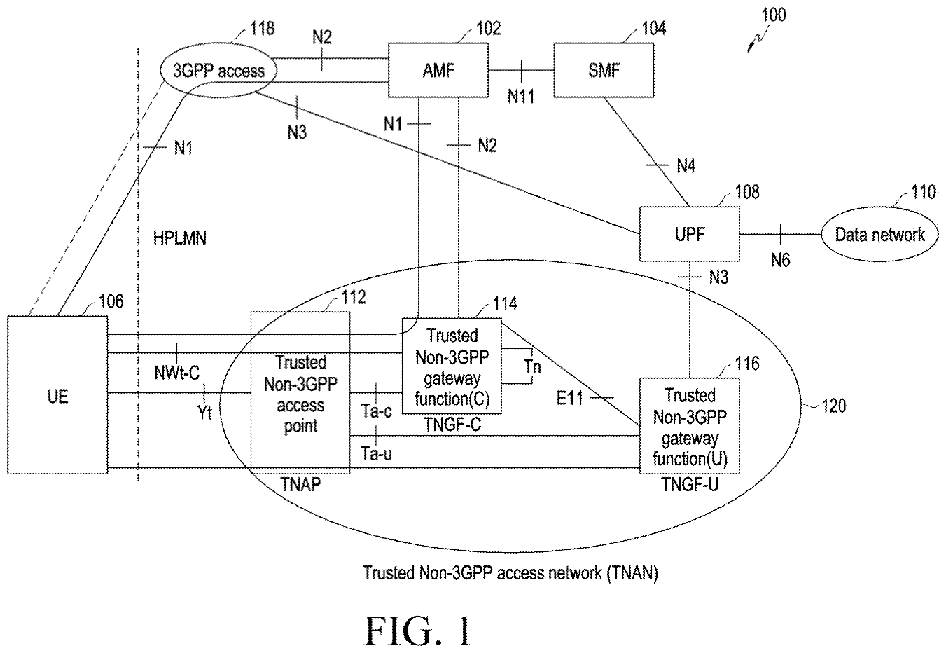

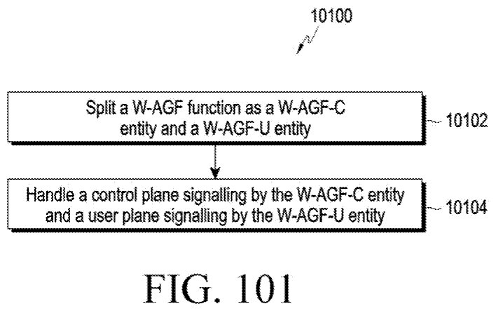

Referring now to the drawings, and more particularly to FIGS. 1 through 101, where similar reference characters denote corresponding features consistently throughout the figures, there are shown example embodiments.

FIG. 1 illustrates a control and user plane separation (CUPS) architecture in a wireless network (100), according to an embodiment. In an embodiment, the wireless network (100) may include an access and mobility management function (AMF) (102), a session management function (SMF) (104), a user equipment (UE) (106), a user plane function (108), a data network (110), a trusted wireless local-area network (WLAN) access point (112), a TNGF-C entity (114), a TNGF-U entity (116) and a 3GPP access network (118). The operations and functions of the AMF (102), the SMF (104), the UE (106), the UPF (108), the data network (110), the trusted WLAN access point (112), and the trusted non-3GPP access network (TNAN) (120) may be in accordance with one or more telecommunication standards, such as, but not limited to, 3GPP TS 23.501 and 3GPP TS 23.502. For the sake of brevity, repeated descriptions of these components may be omitted.

The trusted WLAN access point (112), the TNGF-C entity (114), the TNGF-U entity (116) may operate in the TNAN (120). The TNGF-C entity (114) may communicate with the AMF (102) through a N1 interface and a N2 interface. The TNGF-C entity (114) may communicate with the TNGF-U entity (116) through an E11 interface, where the TNGF-U entity (116) may communicate with the trusted WLAN access point (112) through an Y_{W}-U interface. The trusted WLAN access point (112) may communicate with the TNGF-C entity (114) through an Y_{W}-C interface. The trusted WLAN access point (112) may also be referred to as a trusted non-3GPP access point (TNAP).

In an embodiment, the TNGF may be divided into the TNGF-C entity (114) and the TNGF-U entity (116). In such an embodiment, the control plane signalling of the TNGF may be handled by the TNGF-C entity (114) and the user plane signalling may be handled by the TNGF-U entity (116). The E11 interface may be established between the TNGF-C entity (114) and the TNGF-U entity (116). An N2 interface may be used between the AMF (102) and the TNGF-C entity (114). An N3 interface may be used between the UPF (108) and the TNGF-U entity (116). The control plane signalling from the UE (106) towards a core network may be handled via the TNGF-C entity (114). The user plane data from the UE (106) towards the data network (110) may be handled via the TNGF-U entity (116).

The TNGF-C entity (114) may select the at least one TNGF-U entity (116) during a protocol data unit (PDU) session establishment procedure based on at least one of a local selection procedure, a hardware capacity of TNGF-U entity (116), a throughput capacity of the TNGF-U entity (116), a performance statistics of the TNGF-U entity (116), peer user plane (UPF) feedback of the TNGF-U entity (116), Internet Protocol Security (IPSec) performance statistics of the TNGF-U entity (116), a peer IPSec (UE) feedback of TNGF-U entity (116). The local selection procedure may be a round-robin procedure and/or may be based on the resource status received from one or more TNGF-Us (116).

Further, the TNGF-C entity (114) may move a UE context from one TNGF-U to another TNGF-U during at least one failure scenario. The failure scenario may be and/or may include, for example, but not be limited to, a TNGF-U E11 setup failure, a TNGF-C E11 setup failure, a TNGF-U configuration update failure, a TNGF-C configuration update failure, a bearer context setup failure, a bearer context modification failure, and a resource status reporting initiation failure.

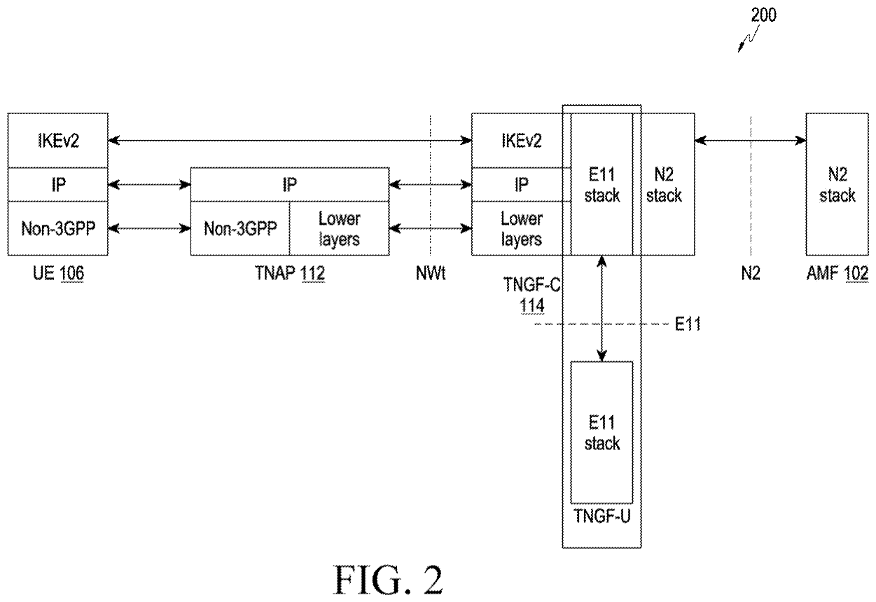

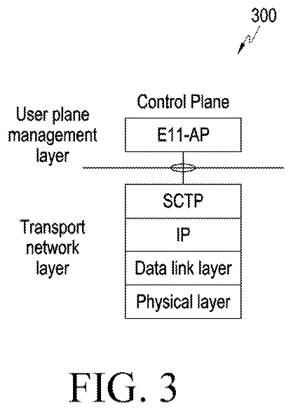

FIG. 2 illustrates a signalling (200) for a user plane establishment, according to an embodiment. FIG. 3 illustrates an E11 interface protocol structure (300), according to an embodiment. The TNGF-C entity (114) and the TNGF-U entity (116) may run (execute) on the E11 stack. The E11 interface may have an E11 application protocol (E11AP) that may run on top of a stream control transmission protocol (SCTP). In another embodiment, the E11 interface may have the E11AP that may run on other transport protocols such as, but not limited to, transmission control protocol (TCP), user datagram protocol (UDP) or the like. The E11AP may handle (process) UE-associated services and/or non-UE-associated services. The non-UE-associated services may be described in standard 3GPP procedures. The E11AP may support interface management, bearer management, and/or other features as needed.

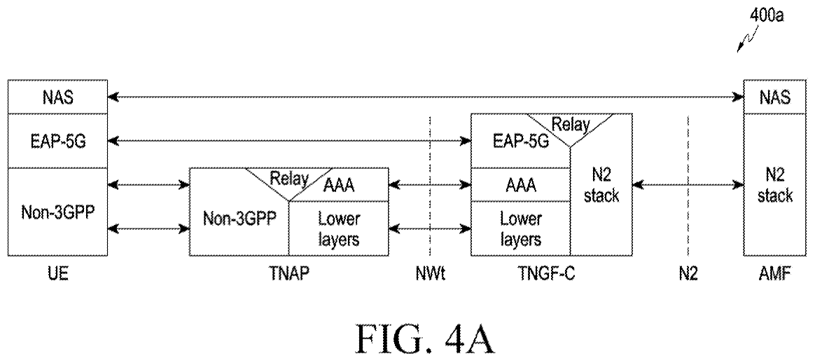

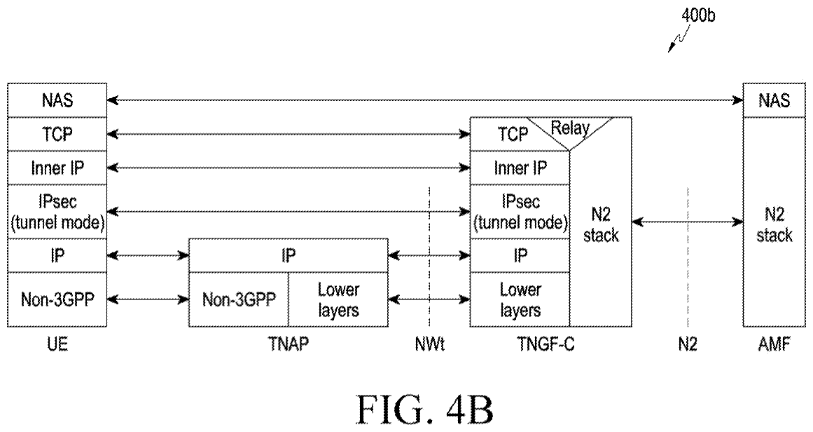

FIG. 4A illustrates a control plane connection (400a) before network connection, according to an embodiment. FIG. 4B illustrates a control plane connection (400b) after the network connection, according to an embodiment. In the proposed TNGF CUPS architecture, the control plane protocols may be moved to the TNGF-C entity (114). For example, the TNGF-C entity (114) may provide support for protocols such as, but not limited to, extensible authentication protocol (e.g., EAP-5G), Internet Key Exchange (e.g., IKEv2), TCP, IPSec, and the like, which may be protocols that may be supported by a standalone TNGF. In other words, the EAP-5G, the IKEv2, the TCP, and IPSec protocols may be used for control plane signalling in the TNGF. That is, the functionality for supporting and/or providing these control plane signalling protocols may be present in the TNGF-C entity after the CUPS separation.

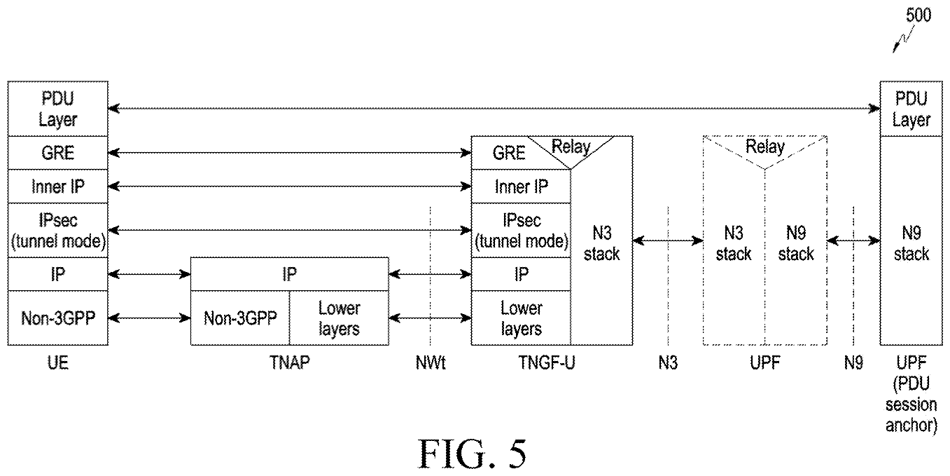

FIG. 5 illustrates a user plane connectivity (500) and a user plane terminating at a TNGF-U entity (116), according to an embodiment. In the proposed TNGF CUPS architecture, the user plane protocols may be moved to the TNGF-U entity (116). For example, the TNGF-U entity (116) may provide support for protocols such as, but not limited to, generic routing encapsulation (GRE), IPSec, and the like, which may be protocols that may be supported by a standalone TNGF (e.g., in a related 3GPP architecture). In other words, the GRE and IPSec protocols may be used for user data signalling in the TNGF. That is, the functionality for supporting and/or providing these user plane signalling protocols may be present in the TNGF-U entity after the CUPS separation.

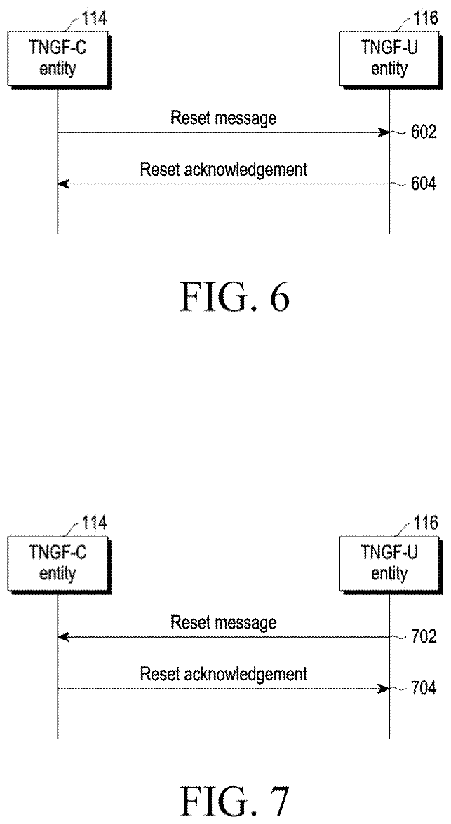

FIG. 6 is a sequence diagram illustrating a reset procedure initiated from the TNGF-C entity (114), according to an embodiment. As shown in FIG. 6, at operation 602, the TNGF-C entity (114) may send a reset message to the TNGF-U entity (116). Based on the reset message, at operation 604, the TNGF-U entity (116) may send a reset acknowledgement to the TNGF-C entity (114).

FIG. 7 is a sequence diagram illustrating a reset procedure initiated from the TNGF-U entity (116), according to an embodiment. As shown in FIG. 7, at operation 702, the TNGF-U entity (116) may send the reset message (e.g., E11AP:RESET message) to the TNGF-C entity (114). Based on the reset message, at operation 704, the TNGF-C entity (114) may send the reset acknowledgement (e.g., E11AP:RESET ACKNOWLEDGE message) to the TNGF-U entity (116).

As shown in FIG. 6 and FIG. 7, the reset message may be sent by both the TNGF-C entity (114) and the TNGF-U entity (116) and may be used to request that the E11 interface, and/or parts of the E11 interface, be reset. Information in the reset message is shown in the Table 1.

TABLE 1
E11 Reset Message

| Information Element (IE)/Group Name | Presence | Range |
|---|---|---|
| Message Type | M (Mandatory) | |
| Transaction ID | M | |
| Cause | M | |
| CHOICE Reset Type | M | |
| >E11 interface | | |
| >>Reset All | M | |
| >Part of E11 interface | | |
| >>UE-associated logical E11- | | |
| connection list | | |
| >>>UE-associated logical E11- | | 1..<maxnoofIndividualE11ConnectionsToReset> |
| connection Item | | |
| >>>>TNGF-C UE E11AP ID | O (optional) | |
| >>>>TNGF-U UE E11AP ID | O | |

Referring to Table 1, maxnoofIndividualE11ConnectionsToReset may refer to a maximum number of UE-associated logical E11-connections that may be allowed to be reset in one message. For example, the value of maxnoofIndividualE11ConnectionsToReset may be 65,536.

The reset acknowledge message may be sent by both the TNGF-C entity (114) and the TNGF-U entity (116) as a response to the reset message. Information in the reset acknowledge message is shown in the Table 2.

TABLE 2
E11 Reset Acknowledge Message

| IE/Group Name | Presence | Range |
|---|---|---|
| Message Type | M | |
| Transaction ID | M | |
| UE-associated logical E11-connection list | | 0..1 |
| >UE-associated logical E11-connection Item | | 1..<maxnoofIndividualE11ConnectionsToReset> |
| >>TNGF-C UE E11AP ID | O | |
| >>TNGF-U UE E11AP ID | O | |
| Criticality Diagnostics | O | |

Referring to Table 2, maxnoofIndividualE11ConnectionsToReset may refer to a maximum number of UE-associated logical E11-connections that may be allowed to be reset in one message. For example, the value of maxnoofIndividualE11ConnectionsToReset may be 65,536.

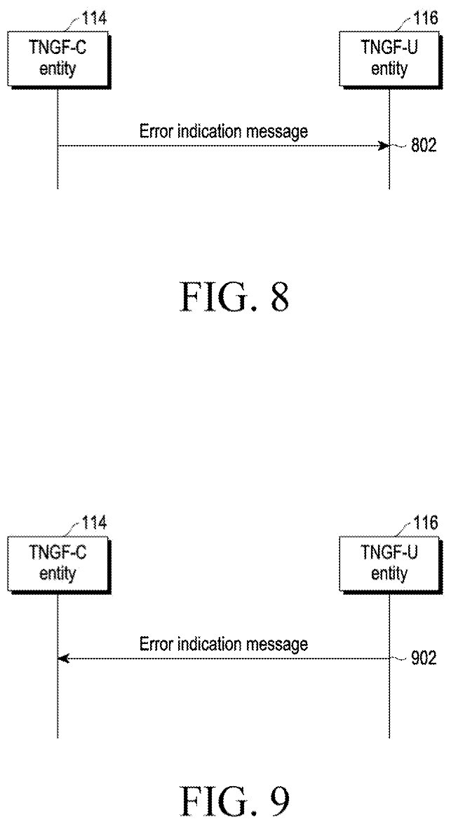

FIG. 8 is a sequence diagram illustrating an error indication procedure originated at the TNGF-C entity (114), according to an embodiment. As shown in FIG. 8, at operation 802, the TNGF-C entity (114) may send the error indication message (e.g., E11AP:ERROR INDICATION message) to the TNGF-U entity (116).

FIG. 9 is a sequence diagram illustrating an error indication procedure originated at the TNGF-U entity (116), according to an embodiment. As shown in FIG. 9, at operation 902, the TNGF-U entity (116) may send the error indication message to the TNGF-C entity (114).

The error indication message may be sent by both the TNGF-C entity (114) and the TNGF-U entity (116) and may be used to indicate that an error has been detected in the node. Information in the error indication message is shown in the Table 3.

TABLE 3
E11 Error Indication Message

| IE/Group Name | Presence |
|---|---|
| Message Type | M |
| Transaction ID | M |
| TNGF-C UE E11AP ID | O |
| TNGF-U UE E11AP ID | O |
| Cause | O |
| Criticality Diagnostics | O |

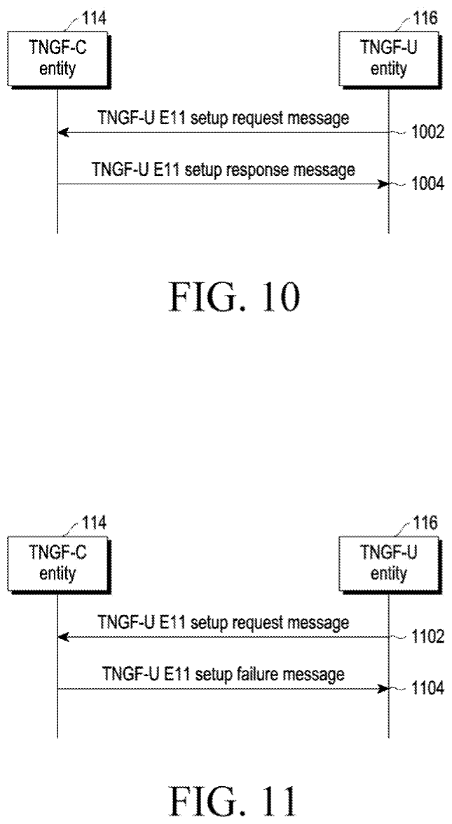

FIG. 10 is a sequence diagram illustrating a TNGF-U E11 setup procedure during a success scenario, according to an embodiment. As shown in FIG. 10, at operation 1002, the TNGF-U entity (116) may send the TNGF-U E11 setup request message (e.g., E11AP:TNGF-U E11 SETUP REQUEST message) to the TNGF-C entity (114). Based on the TNGF-U E11 setup request message, at operation 1004, the TNGF-C entity (114) may send the TNGF-U E11 setup response message (e.g., E11AP:TNGF-U E11 SETUP RESPONSE message) to the TNGF-U entity (116).

FIG. 11 is a sequence diagram illustrating a TNGF-U E11 setup procedure during a failure scenario, according to an embodiment. As shown in FIG. 11, at operation 1102, the TNGF-U entity (116) may send the TNGF-U E11 setup request message to the TNGF-C entity (114). Based on the TNGF-U E11 setup request message, at operation 1104, the TNGF-C entity (114) may send the TNGF-U E11 setup failure message (e.g., E11AP:TNGF-U E11 SETUP FAILURE message) to the TNGF-U entity (116).

The TNGF-U E11 setup request message may be sent by the TNGF-U entity (116) to transfer information for a transport network layer (TNL) association. Information in the TNGF-U E11 setup request message is shown in Table 4.

TABLE 4
TNGF-U E11 Setup Request Message

| IE/Group Name | Presence | Range |
|---|---|---|
| Message Type | M | |
| Transaction ID | M | |
| TNGF-U ID | M | |
| TNGF-U Name | O | |
| CN Support | M | |
| Supported PLMNs | | 1..<maxnoofSPLMNs> |
| >PLMN Identity | M | |
| >Slice Support List | O | |
| >Extended Slice Support List | O | |
| >QoS Parameters Support List | O | |
| TNGF-U Capacity | O | |
| Transport Network Layer | O | |
| Address Info | | |
| Extended TNGF-U Name | O | |

Referring to Table 4, the maxnoofSPLMNs may indicate the maximum number of supported public land mobile network (PLMN) identifications (IDs). For example, the value of maxnoofSPLMNs may be 12.

Continuing to refer to FIG. 10, the TNGF-U E11 setup response message may be sent by the TNGF-C entity (114) to transfer information for the TNL association. Information in the TNGF-U E11 setup response message is shown in Table 5.

TABLE 5
TNGF-U E11 Setup Response Message

| IE/Group Name | Presence |
|---|---|
| Message Type | M |
| Transaction ID | M |
| TNGF-C Name | O |
| Transport Network Layer Address Info | O |
| Extended TNGF-C Name | O |
| Criticality Diagnostics | O |

Referring to FIG. 11, the TNGF-U E11 setup failure message may be sent by the TNGF-C entity (114) to indicate an E11 setup failure. Information in the TNGF-U E11 setup failure message is shown in Table 6.

TABLE 6
TNGF-U E11 Setup Failure Message

| IE/Group Name | Presence |
|---|---|
| Message Type | M |
| Transaction ID | M |
| Cause | M |
| Time To Wait | O |
| Criticality Diagnostics | O |

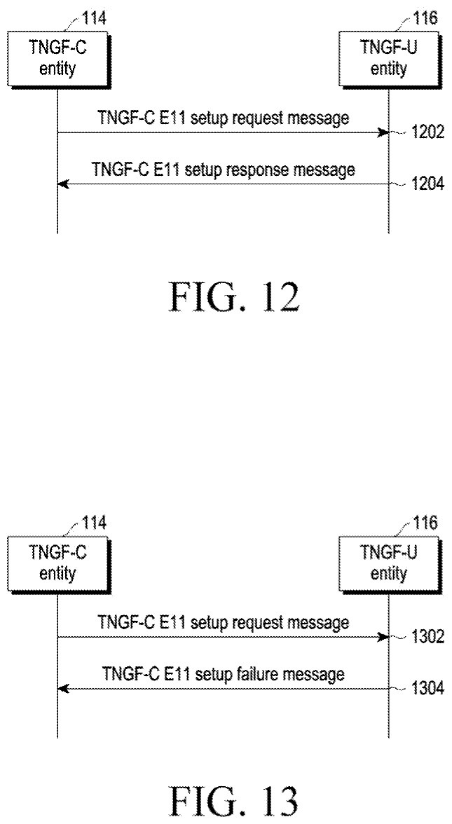

FIG. 12 is a sequence diagram illustrating a TNGF-C E11 setup procedure during a success scenario, according to an embodiment. As shown in FIG. 12, at operation 1202, the TNGF-C entity (114) may send a TNGF-C E11 setup request message (e.g., E11AP:TNGF-C E11 SETUP REQUEST message) to the TNGF-U entity (116). Based on the TNGF-C E11 setup request message, at operation 1204, the TNGF-U entity (116) may send the TNGF-C E11 setup response message (e.g., E11AP:TNGF-C E11 SETUP RESPONSE message) to the TNGF-C entity (114).

FIG. 13 is a sequence diagram illustrating a TNGF-C E11 setup procedure during a failure scenario, according to an embodiment. As shown in FIG. 13, at operation 1302, the TNGF-C entity (114) may send a TNGF-C E11 setup request message to the TNGF-U entity (116). Based on the TNGF-C E11 setup request message, at operation 1304, the TNGF-U entity (116) may send the TNGF-C E11 setup failure message (e.g., E11AP:TNGF-C E11 SETUP FAILURE message) to the TNGF-C entity (114).

The TNGF-C E11 setup request message may be sent by the TNGF-C to transfer information for a TNL association. Information in the TNGF-C E11 setup request message is shown in Table 7.

TABLE 7
TNGF-C E11 Setup Request Message

| IE/Group Name | Presence |
|---|---|
| Message Type | M |
| Transaction ID | M |
| TNGF-C Name | O |
| Transport Network Layer Address Info | O |
| Extended TNGF-C Name | O |

The TNGF-C E11 setup response message may be sent by the TNGF-U entity (116) to transfer information for a TNL association. Information in the TNGF-C E11 setup response message is shown in Table 8.

TABLE 8
TNGF-C E11 Setup Response Message

| IE/Group Name | Presence | Range |
|---|---|---|
| Message Type | M | |
| Transaction ID | M | |
| TNGF-U ID | M | |
| TNGF-U Name | O | |
| CN Support | M | |
| Supported PLMNs | | 1..<maxnoofSPLMNs> |
| >PLMN Identity | M | |
| >Slice Support List | O | |
| >Extended Slice Support List | O | |
| >QoS Parameters Support List | O | |
| TNGF-U Capacity | O | |
| Transport Network Layer | O | |
| Address Info | | |
| Extended TNGF-U Name | O | |
| Criticality Diagnostics | O | |

Referring to Table 8, maxnoofSPLMNs may indicate the maximum number of supported PLMN IDs. For example, the value of maxnoofSPLMNs may be 12.

The TNGF-C E11 setup failure message may be sent by the TNGF-U entity (116) to indicate an E11 setup failure. Information in the TNGF-C E11 setup failure message is shown in Table 9.

TABLE 9
TNGF-C E11 Setup Failure Message

| IE/Group Name | Presence |
|---|---|
| Message Type | M |
| Transaction ID | M |
| Cause | M |
| Time To Wait | O |
| Criticality Diagnostics | O |

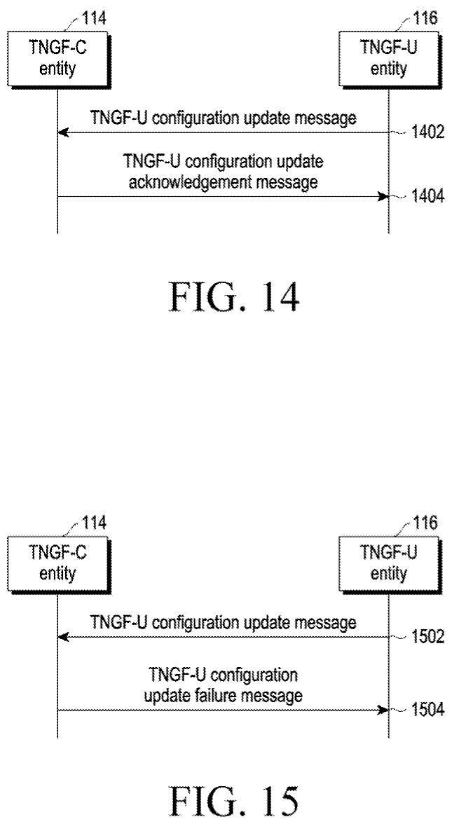

FIG. 14 is a sequence diagram illustrating a TNGF-U configuration update procedure during a success scenario, according to an embodiment. As shown in FIG. 14, at operation 1402, the TNGF-U entity (116) may send a TNGF-U configuration update message (e.g., E11AP:TNGF-U CONFIGURATION UPDATE message) to the TNGF-C entity (114). Based on the TNGF-U configuration update message, at operation 1404, the TNGF-C entity (114) may send the TNGF-U configuration update acknowledgement message (e.g., E11AP:TNGF-U CONFIGURATION UPDATE ACKNOWLEDGE message) to the TNGF-U entity (116).

FIG. 15 is a sequence diagram illustrating a TNGF-U configuration update procedure during a failure scenario, according to an embodiment. As shown in FIG. 15, at operation 1502, the TNGF-U entity (116) may send a TNGF-U configuration update message to the TNGF-C entity (114). Based on the TNGF-U configuration update message, at operation 1504, the TNGF-C entity (114) may send the TNGF-U configuration update failure message (e.g., E11AP:TNGF-U CONFIGURATION UPDATE FAILURE message) to the TNGF-U entity (116).

The TNGF-U configuration update message may be sent by the TNGF-U to transfer updated information for the TNL association. Information of the TNGF-U configuration update message is shown in Table 10.

TABLE 10
TNGF-U Configuration Update Message

| IE/Group Name | Presence | Range |
|---|---|---|
| Message Type | M | |
| Transaction ID | M | |
| TNGF-U ID | O | |
| TNGF-U Name | O | |
| Supported PLMNs | | 0..<maxnoofSPLMNS> |
| >PLMN Identity | M | |
| >Slice Support List | O | |
| >Extended Slice Support List | O | |
| >QoS Parameters Support List | O | |
| TNGF-U Capacity | O | |
| TNGF-U TNLA To Remove List | | 0..1 |
| >TNGF-U TNLA To Remove Item IEs | | 1..<maxnoofTNLAssociations> |
| >>TNLA Transport Layer Address | M | |
| >>TNLA Transport Layer Address | O | |
| TNGF-C | | |
| Transport Network Layer Address Info | O | |
| Extended TNGF-U Name | O | |

Referring to Table 10, maxnoofSPLMNs may indicate the maximum number of supported PLMN IDs, and maxnoofTNLAssociations may indicate the maximum number of TNL associations between the TNGF-U entity (116) and the TNGF-C entity (114). For example, the value of maxnoofSPLMNs may be 12. As another example, the value of maxnoofTNLAssociations may be 32.

The TNGF-U configuration update acknowledge message may be sent by the TNGF-C entity (114) to the TNGF-U entity (114) to acknowledge update of information for the TNL association. Information in the TNGF-U configuration update acknowledge message is shown in Table 11.

TABLE 11
TNGF-U Configuration Update Acknowledge Message

| IE/Group Name | Presence |
|---|---|
| Message Type | M |
| Transaction ID | M |
| Criticality Diagnostics | O |
| Transport Network Layer Address Info | O |

The TNGF-U configuration update failure message may be sent by the TNGF-C entity (114) to indicate TNGF-U configuration update failure. Information in the TNGF-U configuration update failure message is shown in Table 12.

TABLE 12
TNGF-U Configuration Update Failure Message

| IE/Group Name | Presence |
|---|---|
| Message Type | M |
| Transaction ID | M |
| Cause | M |
| Time To Wait | O |
| Criticality Diagnostics | O |

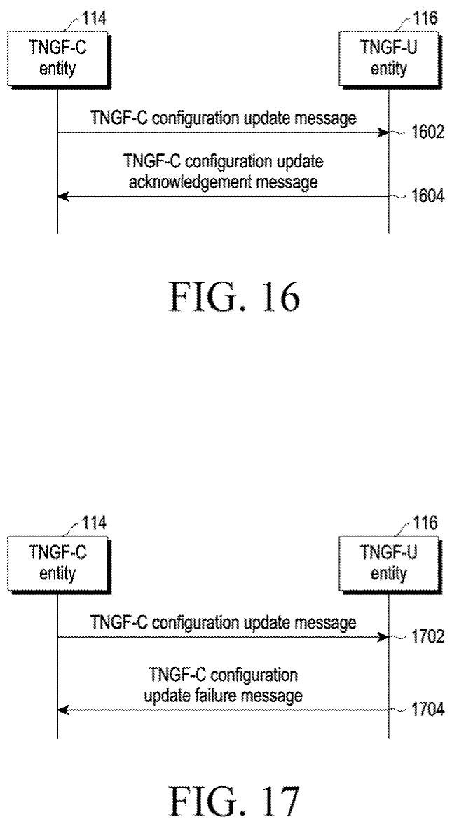

FIG. 16 is a sequence diagram illustrating a TNGF-C configuration update procedure during a success scenario, according to an embodiment. As shown in FIG. 16, at operation 1602, the TNGF-C entity (114) may send a TNGF-C configuration update message (e.g., E11AP:TNGF-C CONFIGURATION UPDATE message) to the TNGF-U entity (116). Based on the TNGF-C configuration update message, at operation 1604, the TNGF-U entity (116) may send the TNGF-C configuration update acknowledge message (e.g., E11AP:TNGF-C CONFIGURATION UPDATE ACKNOWLEDGE message) to the TNGF-C entity (114).

FIG. 17 is a sequence diagram illustrating a TNGF-C configuration update procedure during a failure scenario, according to an embodiment. As shown in FIG. 17, at operation 1702, the TNGF-C entity (114) may send the TNGF-C configuration update message to the TNGF-U entity (116). Based on the TNGF-C configuration update message, at operation 1604, the TNGF-U entity (116) may send the TNGF-C configuration update failure message (e.g., E11AP:TNGF-C CONFIGURATION UPDATE FAILURE message) to the TNGF-C entity (114).

The TNGF-C configuration update message may be sent by the TNGF-C entity (114) to transfer updated information for the TNL association. Information in the TNGF-C configuration update message is shown in Table 13.

TABLE 13
TNGF-C Configuration Update Message

| IE/Group Name | Presence | Range |
|---|---|---|
| Message Type | M | |
| Transaction ID | M | |
| TNGF-C Name | O | |
| TNGF-C TNLA To Add List | | 0..1 |
| >TNGF-C TNLA To Add Item IEs | | 1..<maxnoofTNLAssociations> |
| >>TNLA Transport Layer Information | M | |
| >>TNLA Usage | M | |
| TNGF-C TNLA To Remove List | | 0..1 |
| >TNGF-C TNLA To Remove Item IEs | | 1..<maxnoofTNLAssociations> |
| >>TNLA Transport Layer Address | M | |
| >>TNLA Transport Layer Address TNGF-U | O | |
| TNGF-C TNLA To Update List | | 0..1 |
| >TNGF-C TNLA To Update Item IEs | | 1..<maxnoofTNLAssociations> |
| >>TNLA Transport Layer Address | M | |
| >>TNLA Usage | O | |
| Transport Network Layer Address Info | O | |
| Extended TNGF-C Name | O | |

Referring to Table 13, maxnoofTNLAssociations may indicate the maximum number of TNL associations between the TNGF-C entity (114) and the TNGF-U entity (116). For example, the value of the maxnoofTNLAssociations may be 32.

The TNGF-C configuration update acknowledge message may be sent by the TNGF-U entity (116) to the TNGF-C entity (114) to acknowledge update of information for the TNL association. Information in the TNGF-C configuration update acknowledge message is shown in Table 14.

TABLE 14
TNGF-C Configuration Update Acknowledge Message

| IE/Group Name | Presence | Range |
|---|---|---|
| Message Type | M | |
| Transaction ID | M | |
| TNGF-C TNLA Setup List | | 0..1 |
| >TNGF-C TNLA Setup Item IEs | | 1..<maxnoofTNLAssociations> |
| >>TNLA Transport Layer Address | M | |
| TNGF-C TNLA Failed to Setup List | | 0..1 |
| >TNGF-C TNLA Failed To Setup Item IEs | | 1..<maxnoofTNLAssociations> |
| >>TNLA Transport Layer Address | M | |
| >>Cause | M | |
| Criticality Diagnostics | O | |
| Transport Network Layer Address Info | O | |

The TNGF-C configuration update failure message may be sent by the TNGF-U entity (116) to indicate a TNGF-C configuration update failure. Information in the TNGF-C configuration update failure message is shown in Table 15.

TABLE 15
TNGF-C Configuration Update Failure

| IE/Group Name | Presence |
|---|---|
| Message Type | M |
| Transaction ID | M |
| Cause | M |
| Time To Wait | O |
| Criticality Diagnostics | O |

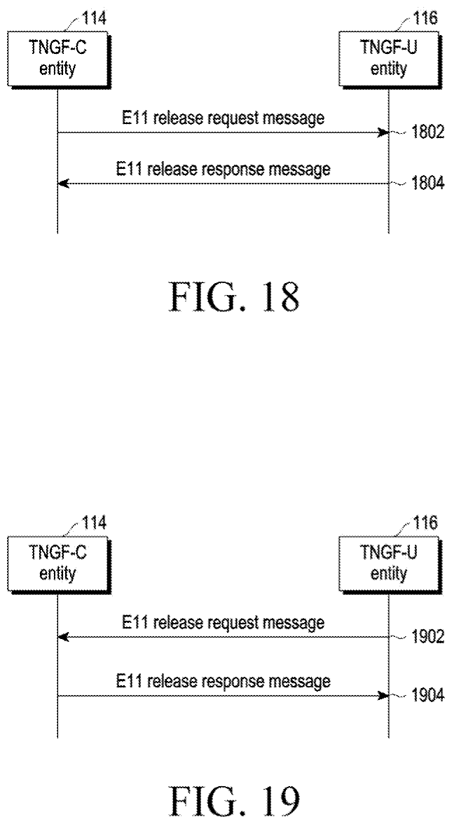

FIG. 18 is a sequence diagram illustrating an E11 release procedure initiated from the TNGF-C entity (114), according to an embodiment. As shown in FIG. 18, at operation 1802, the TNGF-C entity (114) may send an E11 release request message (e.g., E11AP:E11 RELEASE REQUEST message) to the TNGF-U entity (116). Based on the E11 release request message, at operation 1804, the TNGF-U entity (116) may send the E11 release response message (e.g., E11AP:E11 RELEASE RESPONSE message) to the TNGF-C entity (114).

FIG. 19 is a sequence diagram illustrating an E11 release procedure initiated from the TNGF-U entity (116), according to an embodiment. As shown in FIG. 19, at operation 1902, the TNGF-U entity (116) may send the E11 release request message to the TNGF-C entity (114). Based on the E11 release request message, at operation 1504, the TNGF-C entity (114) may send the E11 release response message to the TNGF-U entity (116).

The E11 release request message may be sent by both the TNGF-C entity (114) and the TNGF-U entity (116) and may be used to request the release of the E11 interface. Information in the E11 release request message is shown in Table 16.

TABLE 16
E11 Release Request Message

| IE/Group Name | Presence |
|---|---|
| Message Type | M |
| Transaction ID | M |
| Cause | M |

The E11 release response message may be sent by both the TNGF-C entity (114) and the TNGF-U entity (116) as a response to an E11 RELEASE REQUEST message. Information in the E11 release response message is shown in Table 17.

TABLE 17
E11 Release Response Message

| IE/Group Name | Presence |
|---|---|
| Message Type | M |
| Transaction ID | M |
| Criticality Diagnostics | O |

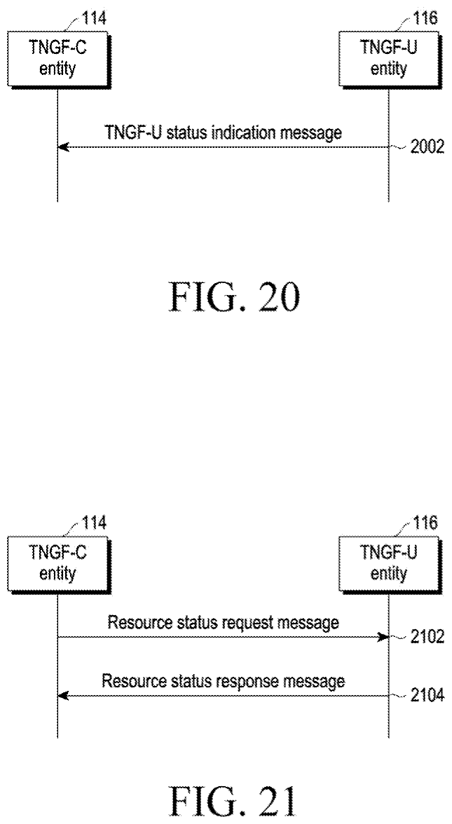

FIG. 20 is a sequence diagram illustrating a TNGF-U status indication, according to an embodiment. As shown in FIG. 20, at operation 2002, the TNGF-U entity (116) may send a TNGF-U status indication message (e.g., E11AP:TNGF-U STATUS INDICATION message) to the TNGF-C entity (114).

The TNGF-U status indication message may be sent by the TNGF-U entity (116) to provide overload information to the TNGF-C entity (114). Information in the TNGF-U status indication message is shown in Table 18.

TABLE 18
TNGF-U Status Indication Message

| IE/Group Name | Presence |
|---|---|
| Message Type | M |
| Transaction ID | M |
| TNGF-U Overload Information | M |

FIG. 21 is a sequence diagram illustrating a resource status reporting initiation during a success scenario, according to an embodiment. As shown in FIG. 21, at operation 2102, the TNGF-C entity (114) may send a resource status request message (e.g., E11AP:RESOURCE STATUS REQUEST message or the like) to the TNGF-U entity (116). Based on the resource status request message, at operation 2104, the TNGF-U entity (116) may send the resource status response message (e.g., E11AP:RESOURCE STATUS RESPONSE message) to the TNGF-C entity (114).

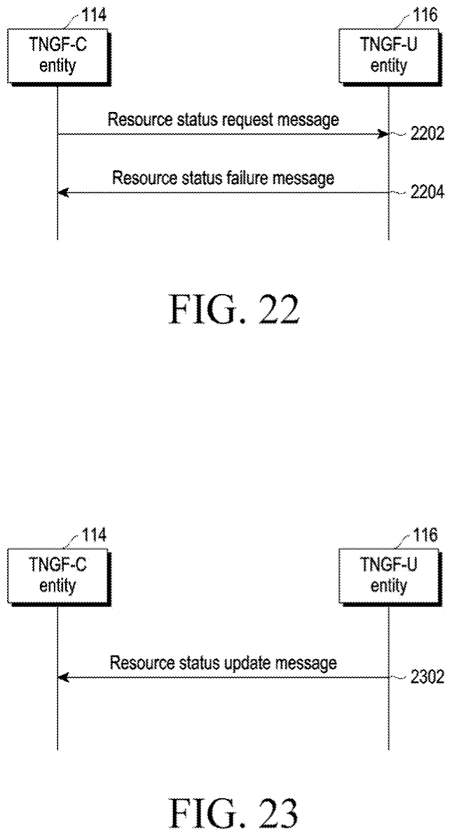

FIG. 22 is a sequence diagram illustrating a resource status reporting initiation during a failure scenario, according to an embodiment. As shown in FIG. 22, at operation 2202, the TNGF-C entity (114) may send the resource status request message to the TNGF-U entity (116). Based on the resource status request message, at operation 2204, the TNGF-U entity (116) may send the resource status failure message (e.g., E11AP:RESOURCE STATUS FAILURE message or the like) to the TNGF-C entity (114).

The resource status request message may be sent by a TNGF-C entity (114) to the TNGF-U entity (116) to initiate the requested measurement according to the parameters given in the resource status request message. Information in the resource status request message is shown in Tables 19 and 20.

TABLE 19
E11 Resource Status Request Message

| IE/Group Name | Presence |
|---|---|
| Message Type | M |
| Transaction ID | M |
| TNGF-C Measurement ID | M |
| TNGF-U Measurement ID | C-ifRegistrationRequestStop |
| Registration Request | M |
| Report Characteristics | C-ifRegistrationRequestStart |
| Reporting Periodicity | O |

TABLE 20
E11 Resource Status Request Message Conditions

| Condition | Explanation |
|---|---|
| ifRegistrationRequestStop | This IE may be present if the Registration Request IE is set |
| | to the value “stop” |
| ifRegistrationRequestStart | This IE may be present if the Registration Request IE is set |
| | to the value “start” |

The resource status response message may be sent by the TNGF-U entity (116) to indicate that the requested measurement may be successfully initiated for all the measurement objects included in the measurement. Information in the resource status response message is shown in Table 21.

TABLE 21
E11 Resource Status Response Message

| IE/Group Name | Presence |
|---|---|
| Message Type | M |
| Transaction ID | M |
| TNGF-C Measurement ID | M |
| TNGF-U Measurement ID | M |
| Criticality Diagnostics | O |

The resource status failure message may be sent by the TNGF-U entity (116) to indicate that for any of the requested measurement objects the measurement may not be initiated. Information in the resource status failure message is shown in Tables 22 and 23.

TABLE 22
E11 Resource Status Failure Message

| IE/Group Name | Presence |
|---|---|
| Message Type | M |
| Transaction ID | M |
| TNGF-C Measurement ID | M |
| TNGF-U Measurement ID | C-ifRegistrationRequestStop |
| Cause | M |
| Criticality Diagnostics | O |

TABLE 23
E11 Resource Status Failure Message Conditions

| Condition | Explanation |
|---|---|
| ifRegistrationRequestStop | This IE may be present if the Registration Request IE is set |
| | to the value “stop” |

FIG. 23 is a sequence diagram illustrating a resource status reporting during a success scenario, according to an embodiment. As shown in FIG. 23, at operation 2302, the TNGF-U entity (116) may send a resource status update message (e.g., E11AP:RESOURCE STATUS UPDATE message or the like) to the TNGF-C entity (114).

The resource status update message may be sent by TNGF-U entity (116) to the TNGF-C entity (114) to report the results of the requested measurements. Information in the resource status update message is shown in Tables 24 and 25.

TABLE 24
E11 Resource Status Update Message

| IE/Group Name | Presence |
|---|---|
| Message Type | M |
| Transaction ID | M |
| TNGF-C Measurement ID | M |
| TNGF-U Measurement ID | M |
| TNL Available Capacity Indicator | O |
| HW Capacity Indicator | O |

TABLE 25
E11 Resource Status Update Message Ranges

| Range Bound | Explanation |
|---|---|
| maxnoofSPLMNs | Maximum number of supported |
| | PLMN IDs. Value is 12. |
| maxnoofSliceItems | Maximum number of signalled slice |
| | support items. Value is 1024. |

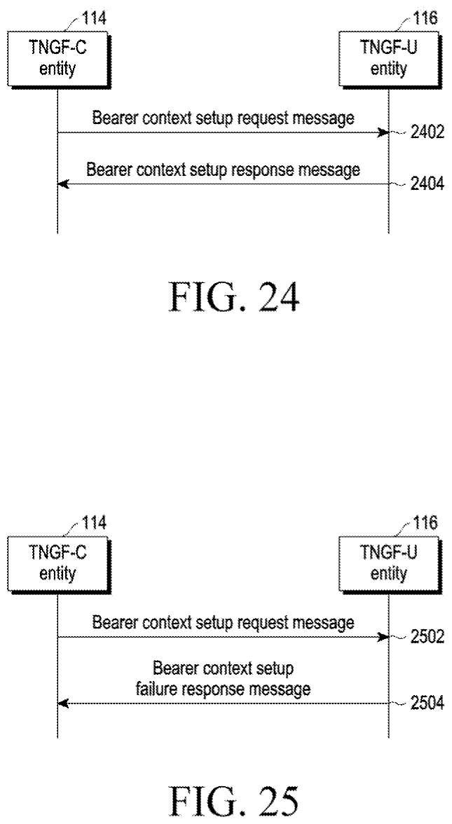

FIG. 24 is a sequence diagram illustrating a bearer context setup procedure during a success scenario, according to an embodiment. As shown in FIG. 24, at operation 2402, the TNGF-C entity (114) may send a bearer context setup request message (e.g., E11AP:BEARER CONTEXT SETUP REQUEST message or the like) to the TNGF-U entity (116). Based on the bearer context setup request message, at operation 2404, the TNGF-U entity (116) may send the bearer context setup response message (e.g., E11AP:BEARER CONTEXT SETUP RESPONSE message) to the TNGF-C entity (114).

FIG. 25 is a sequence diagram illustrating a bearer context setup procedure during a failure scenario, according to an embodiment. As shown in FIG. 25, at operation 2502, the TNGF-C entity (114) may send the bearer context setup request message to the TNGF-U entity (116). Based on the bearer context setup request message, at operation 2504, the TNGF-U entity (116) may send the bearer context setup failure response message (e.g., E11AP:BEARER CONTEXT SETUP FAILURE RESPONSE message or the like) to the TNGF-C entity (114).

The bearer context setup request message may be sent by the TNGF-C entity (114) to request the TNGF-U entity (116) to setup a bearer context. Information in the bearer context setup request message is shown in Table 26.

TABLE 26
E11 Bearer Context Setup Request Message

| IE/Group Name | Presence |
|---|---|
| Message Type | M |
| TNGF-C UE E11AP ID | M |
| Security Information | M |
| Serving PLMN | M |
| Activity Notification Level | M |
| UE Inactivity Timer | O |
| Bearer Context Status Change | O |
| TNGF assigned UE IP address | M |
| TNGF | |
| >PDU Session Resource To Setup List | M |
| >>PDU Session Resource To Setup | M |
| Item | |
| >>>PDU Session ID | M |
| >>>PDU Session Type | M |
| >>>Security Indication | O |
| >>>S-NSSAI | M |
| >>>NG UL UP Transport Layer | M |
| Information | |
| >>>PDU Session Inactivity Timer | O |
| TNGF UE ID | O |
| Trace Activation | O |

The bearer context setup response message may be sent by the TNGF-U entity (116) to confirm the setup of the requested bearer context. Information in the bearer context setup response message is shown in Table 27.

TABLE 27
E11 Bearer Context Setup Response Message

| IE/Group Name | Presence |
|---|---|
| TNGF-C UE E11AP ID | M |
| TNGF-U UE E11AP ID | M |
| TNGF | M |
| >PDU Session Resource Setup List | M |
| >>PDU Session Resource Setup Item | M |
| >>>PDU Session ID | M |
| >>>Security Result | O |
| >>>NG DL UP Transport Layer | M |
| Information | |
| . . . | |
| >PDU Session Resource Failed List | O |
| >>PDU Session Resource Failed Item | M |
| >>>PDU Session ID | M |
| >>>Cause | M |

The bearer context setup failure message may be sent by the TNGF-U entity (116) to indicate that the setup of the bearer context was unsuccessful (e.g., a failure occurred). Information in the bearer context setup failure message is shown in Table 28.

TABLE 28
E11 Bearer Context Setup Failure Message

| IE/Group Name | Presence |
|---|---|
| Message Type | M |
| TNGF-C UE E11AP ID | M |
| TNGF-U UE E11AP ID | O |
| Cause | M |
| Criticality Diagnostics | O |

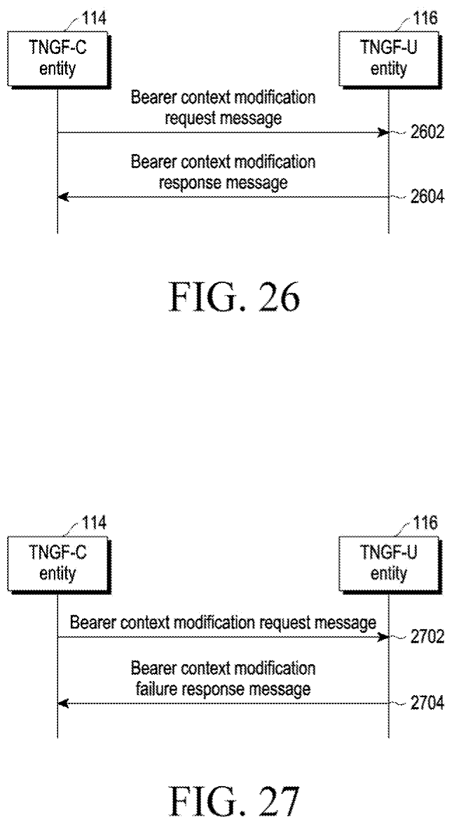

FIG. 26 is a sequence diagram illustrating a bearer context modification procedure during a success scenario, according to an embodiment. As shown in FIG. 26, at operation 2602, the TNGF-C entity (114) may send the bearer context modification request message (e.g., E11AP:BEARER CONTEXT MODIFICATION REQUEST message or the like) to the TNGF-U entity (116). Based on the bearer context modification request message, at operation 2604, the TNGF-U entity (116) may send the bearer context modification response message (e.g., E11AP:BEARER CONTEXT MODIFICATION RESPONSE message) to the TNGF-C entity (114).

FIG. 27 is a sequence diagram illustrating a bearer context modification procedure during a failure scenario, according to an embodiment. As shown in FIG. 27, at operation 2702, the TNGF-C entity (114) may send the bearer context modification request message to the TNGF-U entity (116). Based on the bearer context modification request message, at operation 2704, the TNGF-U entity (116) may send the bearer context modification failure response message (e.g., E11AP:BEARER CONTEXT MODIFICATION FAILURE message) to the TNGF-C entity (114).

The bearer context modification request message may be sent by the TNGF-C entity (114) to request the TNGF-U entity (116) to modify a bearer context. Information in the bearer context modification request message is shown in Table 29 and Table 30.

TABLE 29
E11 Bearer Context Modification Request Message

| IE/Group Name | Presence |
|---|---|
| Message Type | M |
| TNGF-C UE E11AP ID | M |
| TNGF-U UE E11AP ID | M |
| Security Information | O |
| UE DL Aggregate Maximum Bit Rate | O |
| UE DL Maximum Integrity Protected | O |
| Data Rate | |
| Bearer Context Status Change | O |
| New UL TNL Information Required | O |
| UE Inactivity Timer | O |
| Data Discard Required | O |
| TNGF | |
| >PDU Session Resource To Setup List | O |
| >>PDU Session Resource To Setup | M |
| Item | |
| >>>PDU Session ID | M |
| >>>NG UL UP Transport Layer | M |
| Information | |
| >>>SPI To Setup List | M |
| >>>>SPI To Setup Item | M |
| >>>>>SPI | M |
| >>>>>SA payload | M |
| >>>>>QFIs | M |

TABLE 30
E11 Bearer Context Modification Request Message

| IE/Group Name | Presence |
|---|---|
| >PDU Session Resource To Modify | O |
| List | |
| >>PDU Session Resource To Modify | M |
| Item | |
| >>>PDU Session ID | M |
| >>>NG UL UP Transport Layer | M |
| Information | |
| >>>SPI To Setup List | M |
| >>>SPI To Modify List | M |
| >>>SPI To Remove List | M |
| >PDU Session Resource To Remove | O |
| List | |
| >>PDU Session Resource To | |
| Remove Item | |
| >>>PDU Session ID | M |
| >>>Cause | O |
| TNGF UE ID | O |
| Activity Notification Level | O |

Referring to Tables 29 and 30, the security parameter index (SPI) may refer to an identification tag added to the header while using IPsec for tunnelling the IP traffic. For example, the identification tag may help to discern between two traffic streams where different encryption rules and algorithms may be in use. In an embodiment, the SPI (e.g., as described in “Security Architecture for the Internet Protocol”, RFC 4301, December 2005) may be a required part of an IPsec Security Association (SA) because the SPI may be needed to enable the receiving system to select the SA under which a received packet may be processed.

The bearer context modification response message may be sent by the TNGF-C entity (114) to confirm the modification of the requested bearer context. Information in the bearer context modification response message is shown in Table 31.

TABLE 31
E11 Bearer Context Modification Response Message

| IE/Group Name | Presence |
|---|---|
| Message Type | M |
| TNGF-C UE E11AP ID | M |
| TNGF-U UE E11AP ID | M |
| TNGF | |
| >PDU Session Resource Setup List | O |
| >PDU Session Resource Failed List | O |
| >PDU Session Resource Modified List | O |
| >PDU Session Resource Failed To | O |
| Modify List | |
| >Retainability Measurements | O |
| Information | |

Table 32 shows the PDU session resource failed list IE.

TABLE 32
E11 PDU Session Resource Failed List IE

| IE/Group Name | Presence | Range |
|---|---|---|
| PDU Session | | 1 . . . <maxnoofPDUSessionResource> |
| Resource Failed | | |
| Modification Item | | |
| >PDU Session ID | M | |
| >Cause | M | |

Table 33 shows the PDU session resource setup list IE.

TABLE 33
E11 PDU Session Resource Setup List IE

| | Pres- | |
|---|---|---|
| IE/Group Name | ence | Range |
| PDU Session Resource | | 1 . . . <maxnoofPDUSessionResource> |
| Setup Modification | | |
| Item | | |
| >PDU Session ID | M | |
| >Security Result | O | |
| >NG DL UP Transport | M | |
| Layer Information | | |
| >SPI Setup List | | 1 |
| >>SPI Setup Item | | 1 . . . <maxnoofSPIs> |
| >>>SPI | M | |
| >>>QFIs | M | |
| >SPI Failed List | | 0 . . . 1 |
| >>SPI Failed Item | | 1 . . . <maxnoofSPIs> |
| >>>SPI | M | |
| >>>Cause | M | |
| >Redundant NG DL UP | O | |
| Transport Layer | | |
| Information | | |

Referring to Table 33, maxnoofPDUSessionResource may indicate a maximum number of PDU sessions for a UE and maxnoofSPIs may indicate the maximum number of SPIs for a UE. For example, the value of maxnoofPDUSessionResource may be 256. As another example, the value of maxnoofSPIs may be 64.

Table 34 shows the PDU session resource modified list IE.

TABLE 34
E11 PDU Session Resource Modified List IE

| | Pres- | |
|---|---|---|
| IE/Group Name | ence | Range |
| PDU Session Resource | | 1 . . . <maxnoofSPISessionResource> |
| Modified Item | | |
| >PDU Session ID | M | |
| >NG DL UP Transport | O | |
| Layer Information | | |
| >Security Result | O | |
| >PDU Session Data | O | |
| Forwarding | | |
| Information Response | | |
| >SPI Setup List | | 0 . . . 1 |
| >>SPI Setup Item | | 1 . . . <maxnoofSPIs> |
| >>>SPI | M | |
| >>>QFIs | M | |
| >SPI Modified List | | 0 . . . 1 |
| >>SPI Modified Item | | 1 . . . <maxnoofSPIs> |
| >>>SPI | M | |
| >>>QFIs | M | |
| >SPI Failed To Modify List | | 0 . . . 1 |
| >>SPI Failed To Modify | | 1 . . . <maxnoofSPIs> |
| Item | | |
| >>>SPI | M | |
| >>>Cause | M | |
| >Redundant NG DL UP | O | |
| Transport Layer | | |
| Information | | |

Table 35 and Table 36 shows PDU session resource failed to modify list IE.

TABLE 35
E11 PDU Session Resource Failed To Modify List IE

| | Pres- | |
|---|---|---|
| IE/Group Name | ence | Range |
| PDU Session Resource | | 1 . . . <maxnoofPDUSessionResource> |
| Failed To Modify Item | | |
| >PDU Session ID | M | |
| >Cause | M | |

TABLE 36
E11 PDU Session Resource Failed To Modify List IE Ranges

| Range Bound | Explanation |
|---|---|
| maxnoofPDUSessionResource | Maximum number of PDU sessions for a |
| | UE. Value is 256. |

The bearer context modification failure message may be sent by the TNGF-U entity (116) to indicate that the modification of the bearer context was unsuccessful. Information in the bearer context modification failure message is shown in Table 37.

TABLE 37
E11 Bearer Context Modification Failure Message

| IE/Group Name | Presence |
|---|---|
| Message Type | M |
| TNGF-C UE E11AP ID | M |
| TNGF-U UE E11AP ID | M |
| Cause | M |
| Criticality Diagnostics | O |

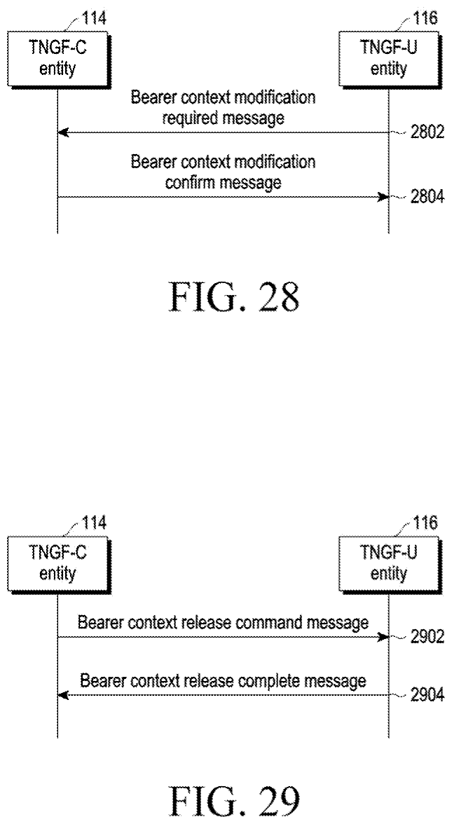

FIG. 28 is a sequence diagram illustrating a bearer context modification required procedure during a success scenario, according to an embodiment. As shown in FIG. 28, at operation 2802, the TNGF-U entity (116) may send a bearer context modification required message (e.g., E11AP:BEARER CONTEXT MODIFICATION REQUIRED message or the like) to the TNGF-C entity (114). Based on the bearer context modification required message, at operation 2804, the TNGF-C entity (114) may send the bearer context modification confirm message (e.g., E11AP:BEARER CONTEXT MODIFICATION CONFIRM message or the like) to the TNGF-U entity (116).

The bearer context modification required message may be sent by the TNGF-U entity (116) to inform the TNGF-C entity (114) that a modification of a bearer context may be required (e.g., due to local problems at the TNGF-U entity (116)). Information in the bearer context modification required message is shown in Tables 38 and 39.

TABLE 38
E11 Bearer Context Modification Required Message

| IE/Group Name | Presence |
|---|---|
| Message Type | M |
| TNGF-C UE E11AP ID | M |
| TNGF-U UE E11AP ID | M |
| TNGF | |
| >PDU Session Resource To Modify | O |
| List | |
| >PDU Session Resource To Remove | O |
| List | |

TABLE 39
E11 Bearer Context Modification Required Message Ranges

| Range Bound | Explanation |
|---|---|
| maxnoofPDUSessionResource | Maximum number of PDU sessions for a |
| | UE. Value is 256. |

Table 40 shows the PDU session resource to modify list IE.

TABLE 40
E11 PDU Session Resource To Modify List IE

| | Pres- | |
|---|---|---|
| IE/Group Name | ence | Range |
| PDU Session Resource | | 1 . . . <maxnoofPDUSessionResource> |
| Required To Modify | | |
| Item | | |
| >PDU Session ID | M | |
| >NG DL UP Transport | O | |
| Layer Information | | |
| >SPI To Modify List | | 0 . . . 1 |
| >>SPI To Modify Item | | 1 . . . <maxnoofSPIs> |
| >>>SPI | M | |
| >>>SA payload | M | |
| >>>QFIs | O | |
| >>>Cause | O | |
| >SPI To Remove List | | 0 . . . 1 |
| >>SPI To Remove Item | | 1 . . . <maxnoofSPIs> |
| >>>SPI | M | |
| >>>Cause | M | |
| >Redundant NG DL UP | O | |
| Transport Layer | | |
| Information | | |

Table 41 shows the PDU session resource to remove list IE.

TABLE 41
E11 PDU Session Resource To Remove List IE

| | Pres- | |
|---|---|---|
| IE/Group Name | ence | Range |
| PDU Session Resource | | 1 . . . <maxnoofPDUSessionResource> |
| To Remove Item | | |
| >PDU Session ID | M | |
| >Cause | O | |

The bearer context modification confirm message may be sent by the TNGF-C entity (114) to confirm the modification of the requested bearer context. The Information in the bearer context modification confirm message is shown in Table 42.

TABLE 42
E11 Bearer Context Modification Confirm Message

| IE/Group Name | Presence |
|---|---|
| Message Type | M |
| TNGF-C UE E11AP ID | M |
| TNGF-U UE E11AP ID | M |
| TNGF | |
| >PDU Session Resource Modified List | O |

FIG. 29 is a sequence diagram illustrating a bearer context release procedure, according to an embodiment. As shown in FIG. 29, at operation 2902, the TNGF-C entity (114) may send a bearer context release command message (e.g., E11AP:BEARER CONTEXT RELEASE COMMAND message or the like) to the TNGF-U entity (116). Based on the bearer context release command message, at operation 2904, the TNGF-U entity (116) may send the bearer context release complete message (e.g., E11AP:BEARER CONTEXT RELEASE COMPLETE message or the like) to the TNGF-C entity (114).

The bearer context release command message may be sent by the TNGF-C entity (114) to command the TNGF-U entity (116) to release an UE-associated logical E11 connection. Information in the bearer context release command message is shown in Table 43.

TABLE 43
E11 Bearer Context Release Command Message

| IE/Group Name | Presence |
|---|---|
| Message Type | M |
| TNGF-C UE E11AP ID | M |
| TNGF-U UE E11AP ID | M |
| Cause | M |

The bearer context release complete message may be sent by the TNGF-U entity (116) to confirm the release of the UE-associated logical E11 connection. Information in the bearer context release complete message is shown in Table 44.

TABLE 44
E11 Bearer Context Release Complete Message

| IE/Group Name | Presence |
|---|---|
| Message Type | M |
| TNGF-C UE E11AP ID | M |
| TNGF-U UE E11AP ID | M |
| Criticality Diagnostics | O |
| Retainability Measurements Information | O |

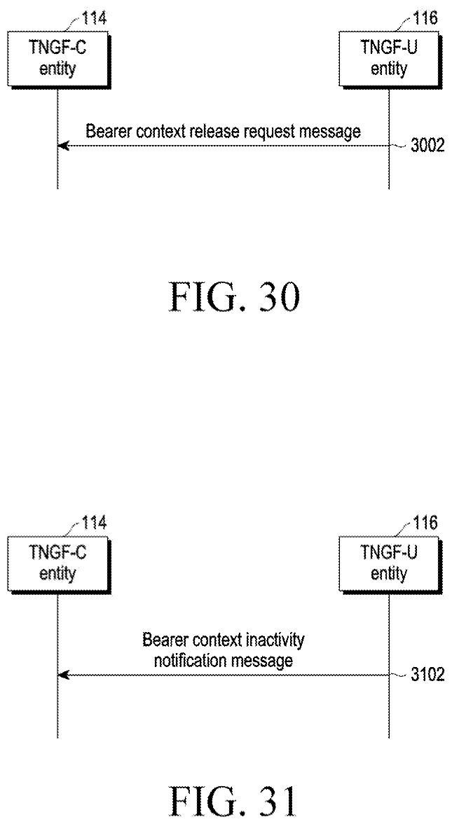

FIG. 30 is a sequence diagram illustrating a bearer context release request procedure, according to an embodiment. As shown in FIG. 30, at operation 3002, the TNGF-U entity (116) may send a bearer context release request message (e.g., E11AP:BEARER CONTEXT RELEASE REQUEST message) to the TNGF-C entity (114). The bearer context release request message may be sent by the TNGF-U entity (116) to request the release of an UE-associated logical E11 connection. Information in the bearer context release request message is shown in Table 45.

TABLE 45
E11 Bearer Context Release Request Message

| IE/Group Name | Presence | Range |
|---|---|---|
| Message Type | M | |
| TNGF-C UE E11AP ID | M | |
| TNGF-U UE E11AP ID | M | |
| SPI Status List | | 0 . . . 1 |
| >SPI Status Item | | 1 . . . <maxnoofSPIs> |
| >>SPI | M | |
| Cause | M | |

| Range Bound | Explanation |
|---|---|
| maxnoofSPIs | Maximum number of SPIs for a UE. Value is 64. |

FIG. 31 is a sequence diagram illustrating a bearer context inactivity notification procedure, according to an embodiment. As shown in FIG. 31, at operation 3102, the TNGF-U entity (116) may send a bearer context inactivity notification message (e.g., E11AP:BEARER CONTEXT INACTIVITY NOTIFICATION message or the like) to the TNGF-C entity (114). The bearer context inactivity notification message (as shown in Table 46) may be sent by the TNGF-U entity (116) to provide information about the UE activity to the TNGF-C entity (114).

TABLE 46
E11 Bearer Context Inactivity Notification Message

| IE/Group Name | Presence | Range |
|---|---|---|
| Message Type | M | |
| TNGF-C UE E11AP ID | M | |
| TNGF-U UE E11AP ID | M | |
| CHOICE Activity Information | M | |
| >SPI Activity List | | 1 |
| >>SPI Activity Item | | 1 . . . <maxnoofSPIs> |
| >>>SPI | M | |
| >>>SPI Activity | M | |
| >PDU Session Resource | | 1 |
| Activity List | | |
| >>PDU Session | | 1 . . . <maxnoofPDUSession |
| Resource Activity | | Resource> |
| Item | | |
| >>>PDU Session ID | M | |
| >>>PDU Session | M | |
| Resource Activity | | |
| >UE Activity | M | |

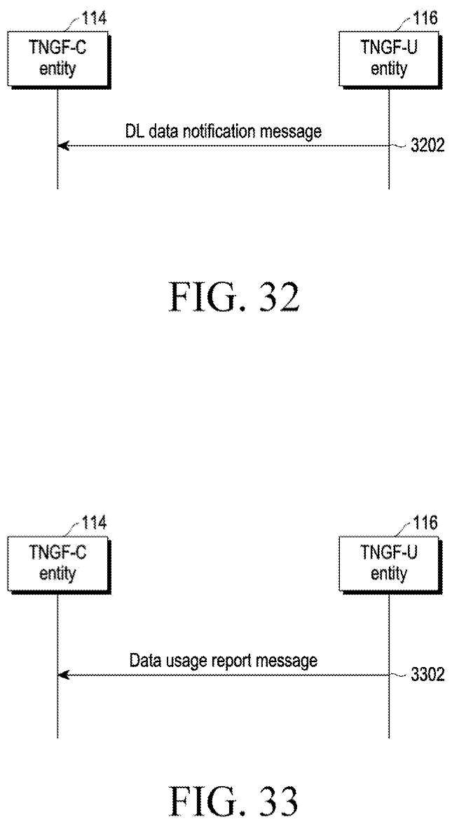

FIG. 32 is a sequence diagram illustrating a DL data notification procedure, according to an embodiment. As shown in FIG. 32, at operation 3202, the TNGF-U entity (116) may send a DL data notification message to the TNGF-C entity (114). The DL data notification message (e.g., E11AP:DL DATA NOTIFICATION message or the like) may be sent by the TNGF-U entity (116) to report data volumes. Information in the DL data notification message is shown in Table 47.

TABLE 47
E11 DL Data Notification Message

| IE/Group Name | Presence | Range |
|---|---|---|
| Message Type | M | |
| TNGF-C UE E11AP ID | M | |
| TNGF-U UE E11AP ID | M | |
| PDU Session To Notify List | | 1 |
| >PDU Session To Notify Item | | 1 . . . <maxnoofPDUSession |
| | | Resource> |
| >>PDU Session ID | M | |
| >>>SPI Notify List | | 0 . . . 1 |
| >>>>SPI Notify Item | M | 1 . . . <maxnoofSPIs> |
| >>>>>SPI | M | |

FIG. 33 is a sequence diagram illustrating a data usage report procedure, according to an embodiment. As shown in FIG. 33, at operation 3302, the TNGF-U entity (116) may send a data usage report message (e.g., E11AP:DATA USAGE REPORT message or the like) to the TNGF-C entity (114). The data usage report message may be sent by the TNGF-U entity (116) to report data volumes. Information in the data usage report message is shown in Table 48.

TABLE 48
E11 Data Usage Report Message

| IE/Group Name | Presence |
|---|---|
| Message Type | M |
| TNGF-C UE E11AP ID | M |
| TNGF-U UE E11AP ID | M |
| Data Usage Report List | M |

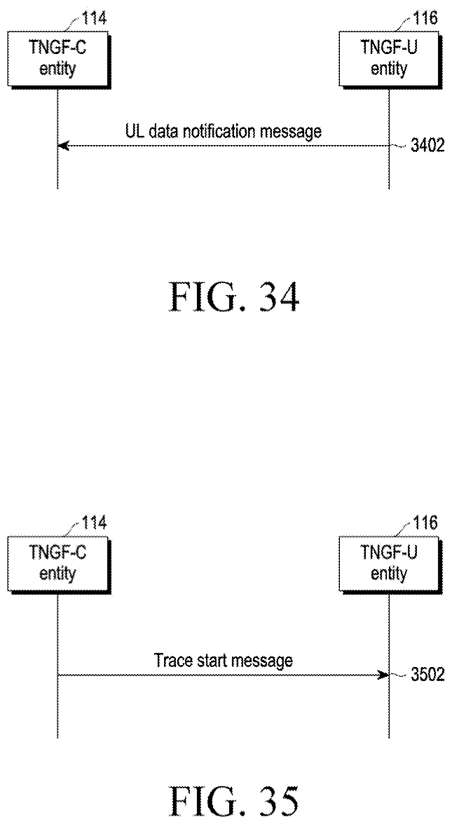

FIG. 34 is a sequence diagram illustrating a UL data notification procedure, according to an embodiment. As shown in FIG. 34, at operation 3402, the TNGF-U entity (116) may send a UL data notification message (e.g., E11AP:UL DATA NOTIFICATION message or the like) to the TNGF-C entity (114). The UL data notification message may be sent by the TNGF-U entity (116) to report data volumes. Information in the UL data notification message is shown in Table 49.

TABLE 49
E11 UL data notification message

| IE/Group Name | Presence | Range |
|---|---|---|
| Message Type | M | |
| TNGF-C UE E11AP ID | M | |
| TNGF-U UE E11AP ID | M | |
| PDU Session To Notify List | | 1 |
| >PDU Session To Notify Item | | 1 . . . <maxnoofPDUSession |
| | | Resource> |
| >>PDU Session ID | M | |
| >>>SPI Notify List | | 0 . . . 1 |
| >>>>SPI Notify Item | M | 1 . . . <maxnoofSPIs> |
| >>>>>SPI | M | |

FIG. 35 is a sequence diagram illustrating a trace start procedure, according to an embodiment. As shown in FIG. 35, at operation 3502, the TNGF-C entity (114) may send a trace start message (e.g., E11AP:TRACE START message) to the TNGF-U entity (116). The trace start message may be sent by the TNGF-C entity (114) to initiate a trace session for the UE. Information in the trace start message is shown in Table 50.

TABLE 50
E11 Trace Start Message

| IE/Group Name | Presence |
|---|---|
| Message Type | M |
| TNGF-C UE E11AP ID | M |
| TNGF-U UE E11AP ID | M |
| Trace Activation | M |

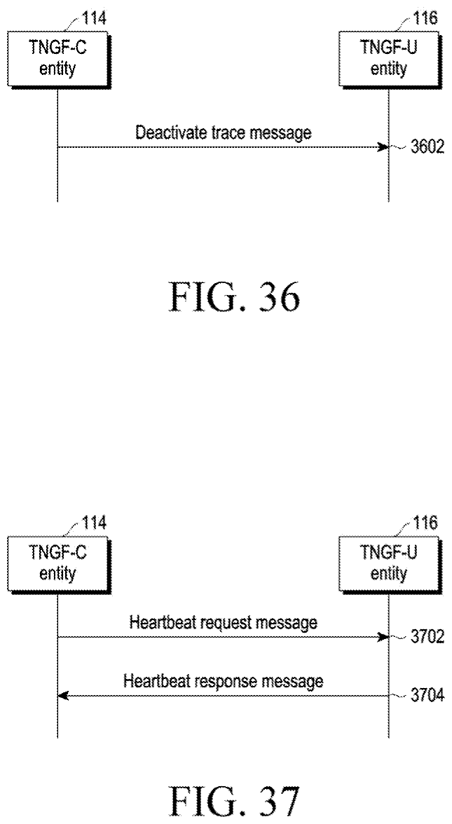

FIG. 36 is a sequence diagram illustrating a deactivate trace procedure, according to an embodiment. As shown in FIG. 36, at operation 3602, the TNGF-C entity (114) may send a deactivate trace message (e.g., E11AP:DEACTIVATE TRACE message or the like) to the TNGF-U entity (116). The deactivate trace message may be sent by the TNGF-C entity (114) to deactivate a trace session. Information in the deactivate trace message is shown in Table 51.

TABLE 51
E11 Deactivate Trace Message

| IE/Group Name | Presence |
|---|---|
| Message Type | M |
| TNGF-C UE E11AP ID | M |
| TNGF-U UE E11AP ID | M |
| Trace ID | M |

FIG. 37 is a sequence diagram illustrating a TNGF-C heartbeat procedure, according to an embodiment. As shown in FIG. 37, at operation 3702, the TNGF-C entity (114) may send a heartbeat request message (e.g., E11AP:heartbeat request message or the like) to the TNGF-U entity (116). Based on the heartbeat request message, at operation 3704, the TNGF-C entity (114) may receive the heartbeat response message (e.g., E11AP:heartbeat response message or the like) from the TNGF-U entity (116).

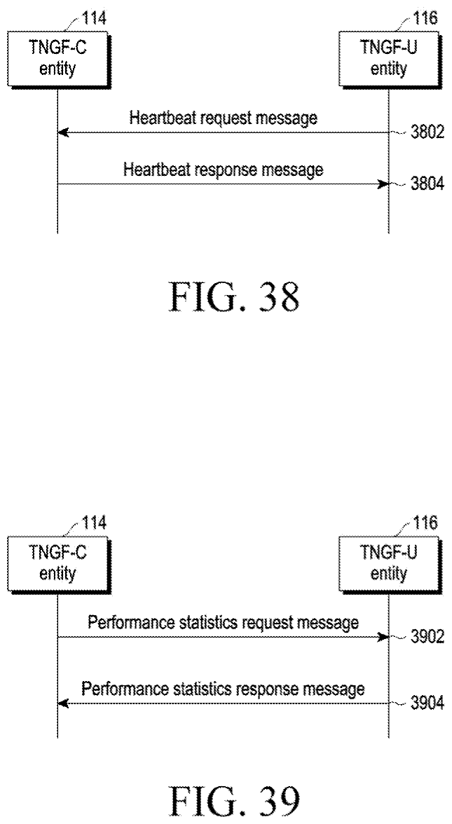

FIG. 38 is a sequence diagram illustrating a TNGF-U heartbeat procedure, according to an embodiment. As shown in FIG. 38, at operation 3802, the TNGF-U entity (116) may send a heartbeat request message to the TNGF-C entity (114). Based on the heartbeat request message, at operation 3804, the TNGF-U entity (116) may receive the heartbeat response message from the TNGF-C entity (114).

The heartbeat request message may be sent by the TNGF-C entity (114) or the TNGF-U entity (116) to determine if the peer entity is alive. Information in the heartbeat request message is shown in Table 52.

TABLE 52
E11 Heartbeat Request Message

| IE/Group Name | Presence | Condition/Comment |
|---|---|---|
| Recovery Time Stamp | M | This IE may contain the |
| | | time stamp when the |
| | | E11AP entity was started. |
| Source IP Address | O | This IE may be included |
| | | when a Network |
| | | Address Translation device is |
| | | deployed in the network. |

The heartbeat response message may be sent as a response to a received heartbeat request message by the TNGF-C entity (114) or TNGF-U entity (116). Information in the heartbeat response message is shown in Table 53.

TABLE 53
E11 Heartbeat Response Message

| IE/Group Name | Presence | Condition/Comment |
|---|---|---|
| Recovery Time Stamp | M | This IE may contain the |
| | | time stamp when the |
| | | E11AP entity was started. |

FIG. 39 is a sequence diagram illustrating a performance statistics reporting initiation during a success scenario, according to an embodiment. As shown in FIG. 39, at operation 3902, the TNGF-C entity (114) may send a performance statistics request message (e.g., E11AP:performance statistics request message or the like) to the TNGF-U entity (116). Based on the performance statistics request message, at operation 3904, the TNGF-C entity (114) may receive the performance statistics response message from the TNGF-U entity (116).

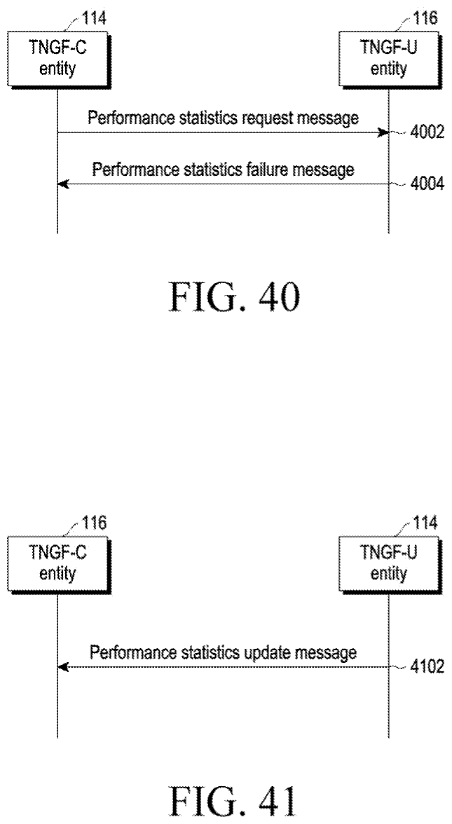

FIG. 40 is a sequence diagram illustrating a performance statistics reporting initiation during a failure scenario, according to an embodiment. As shown in FIG. 40, at operation 4002, the TNGF-C entity (114) may send the performance statistics request message (e.g., E11AP:performance statistics request message or the like) to the TNGF-U entity (116). Based on the performance statistics request message, at operation 4004, the TNGF-C entity (114) may receive the performance statistics failure message (e.g., E11AP:performance statistics failure message or the like) to from the TNGF-U entity (116).

The performance statistics request message may be sent by the TNGF-C entity (114) to the TNGF-U entity (116) to initiate the requested key performance indicators (KPIs) according to parameters given in the performance statistics request message. Information in the performance statistics request message is shown in Tables 54 and 55.

TABLE 54
E11 Performance Statistics Request Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C KPI | M | INTEGER (1 . . . 4095, . . . ) | Allocated by TNGF-C |
| ID | | | |
| TNGF-U KPI | C-ifKPI | INTEGER (1 . . . 4095, . . . ) | Allocated by TNGF-U |
| ID | Registration | | |
| | RequestStop | | |
| KPI | M | ENUMERATED (start, | Type of request for which |
| Registration | | stop, . . . ) | the performance statistics is |
| Request | | | required. |
| KPI Report | C-ifKPI | BITSTRING | Each position in the bitmap |
| Characteristics | Registration | (SIZE(32)) | indicates KPI object the |
| | RequestStart | | TNGF-U is requested to |
| | | | report. |
| | | | 1st Bit = Error Indication |
| | | | Ind Periodic, |
| | | | 2nd Bit = TNGF-C E11 |
| | | | Setup Failure Ind Periodic, |
| | | | 3rd Bit = TNGF-C |
| | | | Configuration Update |
| | | | Failure Ind Periodic, |
| | | | 4th Bit = Resource Status |
| | | | Failure Ind Periodic, |
| | | | 5th Bit = Bearer Context |
| | | | Setup Failure Ind Periodic, |
| | | | 6th Bit = Bearer Context |
| | | | Modification Failure Ind |
| | | | Periodic. |
| | | | 7th Bit = Performance |
| | | | Statistics Failure Ind |
| | | | Periodic. |
| | | | 8th Bit = Peer User Plane |
| | | | Feedback Failure Ind |
| | | | Periodic. |
| | | | Other bits may be ignored |
| | | | by the TNGF-U. |
| KPI Reporting | O | ENUMERATED | Periodicity that may be used |
| Periodicity | | (500 ms, 1000 ms, | for reporting KPIs. Also |
| | | 2000 ms, 5000 ms, | used as the averaging |
| | | 10000 ms, 20000 ms, | window length for all |
| | | 30000 ms, 40000 ms, | performance statistics object |
| | | 50000 ms, 60000 ms, | if supported. |
| | | 70000 ms, 80000 ms, | |
| | | 90000 ms, 100000 ms, | |
| | | 110000 ms, 120000 ms, . . . ) | |

TABLE 55
E11 Performance Statistics Request Message Conditions

| Condition | Explanation |
|---|---|
| ifKPIRegistrationRequestStop | This IE may be present if the KPI Registration Request |
| | IE is set to the value “stop” |
| ifKPIRegistrationRequestStart | This IE may be present if the KPI Registration Request |
| | IE is set to the value “start”. |

The performance statistics response message may be sent by the TNGF-U entity (116) to indicate that the requested performance statistics (e.g., KPIs), for all the performance statistics objects included in the performance statistics request message, may be successfully initiated. Information in the performance statistics response message is shown in Table 56.

TABLE 56
E11 Performance Statistics Response Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C KPI | M | INTEGER (1 . . . 4095, . . . ) | Allocated by TNGF-C |
| ID | | | |
| TNGF-U KPI | M | INTEGER (1 . . . 4095, . . . ) | Allocated by TNGF-U |
| ID | | | |
| Criticality | O | | |
| Diagnostics | | | |

The performance statistics failure message may be sent by the TNGF-U entity (116) to indicate that for any of the requested performance statistics objects the performance statistics may not be initiated. Information in the performance statistics failure message is shown in Tables 57 and 58.

TABLE 57
E11 Performance Statistics Failure Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C KPI | M | INTEGER (1 . . . 4095, . . . ) | Allocated by TNGF-C |
| ID | | | |
| TNGF-U KPI | C-ifKPI | INTEGER (1 . . . 4095, . . . ) | Allocated by TNGF-U |
| ID | Registration | | |
| | RequestStop | | |
| Cause | M | | Ignored by the receiver |
| | | | when the Complete Failure |
| | | | Cause Information IE is |
| | | | included |

TABLE 58
E11 Performance Statistics Failure Message Conditions

| Condition | Explanation |
|---|---|
| ifKPIRegistrationRequestStop | This IE may be present if the KPI Registration Request |
| | IE is set to the value “stop” |

FIG. 41 is a sequence diagram illustrating a performance statistics reporting during a success scenario, according to an embodiment. The TNGF-C entity (114) may receive the performance statistics update message from the TNGF-U entity (116). The performance statistics update message may be sent by the TNGF-U entity (116) to the TNGF-C entity (114) to report the results of the requested performance statistics. Information in the performance statistics update message is shown in Table 59.

TABLE 59
E11 Performance Statistics Update Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C KPI | M | INTEGER (1 . . . 4095, . . . ) | Allocated by TNGF-C |
| ID | | | |
| TNGF-U KPI | M | INTEGER (1 . . . 4095, . . . ) | Allocated by TNGF-U |
| ID | | | |
| Error | O | INTEGER | |
| Indication | | (0 . . . 16777216, . . . ) | |
| Indicator | | | |
| TNGF-C E11 | O | TNGF-C E11 Setup | |
| Setup Failure | | Failure KPI | |
| Indicator | | | |
| TNGF-C | O | TNGF-C Configuration | |
| Configuration | | Update Failure KPI | |
| Update Failure | | | |
| Indicator | | | |
| Resource | O | Resource Status Failure | |
| Status Failure | | KPI | |
| Indicator | | | |
| Bearer Context | O | Bearer Context Setup | |
| Setup Failure | | Failure KPI | |
| Indicator | | | |
| Bearer Context | O | Bearer Context | |
| Modification | | Modification Failure | |
| Failure | | KPI | |
| Indicator | | | |
| Performance | O | Performance Statistics | |
| Statistics | | Failure KPI | |
| Failure | | | |
| Indicator | | | |
| Peer User | O | Peer User Plane | |
| Plane | | Feedback Failure KPI | |
| Feedback | | | |
| Failure | | | |
| Indicator | | | |

The TNGF-C E11 setup failure message may indicate a total number of TNGF-C E11 setup messages received from the TNGF-C entity 116 and a total number of TNGF-C E11 setup failure messages sent to the TNGF-C entity 116. Information in the TNGF-C E11 setup failure message is shown in Table 60.

TABLE 60
TNGF-C E11 Setup Failure message

| | | IE Type and | |
|---|---|---|---|
| IE/Group Name | Presence | Reference | Semantics Description |
| Total TNGF-C E11 Setup | M | INTEGER | Total TNGF-C E11 setup |
| Messages Received | | (0 . . . 16777216, . . . ) | messages received from |
| | | | TNGF-C |
| Total TNGF-C E11 Setup | M | INTEGER | Total TNGF-C E11 setup |
| Failure Messages Sent | | (0 . . . 16777216, . . . ) | failure messages sent to |
| | | | TNGF-C |

The TNGF-C configuration update failure KPI IE may indicate a total number of TNGF-C configuration update messages received from the TNGF-C entity (114) and a total number of TNGF-C configuration update failure messages sent to the TNGF-C entity (114). Information in the configuration update failure KPI IE is shown in Table 61.

TABLE 61
E11 Configuration Update Failure KPI IE

| | | IE Type and | |
|---|---|---|---|
| IE/Group Name | Presence | Reference | Semantics Description |
| Total TNGF-C Configuration | M | INTEGER | Total TNGF-C |
| Update Messages Received | | (0 . . . 16777216, . . . ) | configuration update |
| | | | messages received from |
| | | | TNGF-C |
| Total TNGF-C Configuration | M | INTEGER | Total TNGF-C |
| Update Failure Messages | | (0 . . . 16777216, . . . ) | configuration update |
| Sent | | | failure messages sent to |
| | | | TNGF-C |

The resource status failure KPI IE may indicate a total number of resource status messages received from the TNGF-C entity (114) and a total number of resource status failure messages sent to the TNGF-C entity (114). Information in the resource status failure KPI is shown in Table 62.

TABLE 62
E11 Resource Status Failure KPI

| | | IE Type and | |
|---|---|---|---|
| IE/Group Name | Presence | Reference | Semantics Description |
| Total Resource Status | M | INTEGER | Total resource status |
| Messages Received | | (0 . . . 16777216, . . . ) | messages received from |
| | | | TNGF-C |
| Total Resource Status Failure | M | INTEGER | Total resource status |
| Messages Sent | | (0 . . . 16777216, . . . ) | failure messages sent to |
| | | | TNGF-C |

The bearer context setup failure KPI IE may indicate a total number of bearer context setup messages received from the TNGF-C entity (114) and a total number of bearer context setup failure messages sent to the TNGF-C entity (114). Information in the bearer context setup failure KPI is shown in Table 63.

TABLE 63
E11 Bearer Context Setup Failure KPI

| | | IE Type and | |
|---|---|---|---|
| IE/Group Name | Presence | Reference | Semantics Description |
| Total Bearer Context Setup | M | INTEGER | Total bearer context setup |
| messages Received | | (0 . . . 16777216, . . . ) | messages received from |
| | | | TNGF-C |
| Total Bearer Context Setup | M | INTEGER | Total bearer context setup |
| Failure messages Sent | | (0 . . . 16777216, . . . ) | failure messages sent to |
| | | | TNGF-C |

The bearer context modification failure KPI IE may indicate a total number of bearer context modification messages received from the TNGF-C entity (114) and a total number of bearer context modification failure messages sent to the TNGF-C entity (114). Information in the bearer context modification failure KPI IE is shown in Table 64.

TABLE 64
E11 Bearer Context Modification Failure KPI IE

| | | IE Type and | |
|---|---|---|---|
| IE/Group Name | Presence | Reference | Semantics Description |
| Total Bearer Context | M | INTEGER | Total bearer context |
| Modification messages | | (0 . . . 16777216, . . . ) | modification messages |
| Received | | | received from TNGF-C |
| Total Bearer Context | M | INTEGER | Total bearer context |
| Modification Failure | | (0 . . . 16777216, . . . ) | modification failure |
| messages Sent | | | messages sent to TNGF-C |

The performance statistics failure KPI IE may indicate a total number of performance statistics messages received from the TNGF-C entity (114) and a total number of performance statistics failure messages sent to the TNGF-C entity (114). Information in the performance statistics failure KPI IE is shown in Table 65.

TABLE 65
E11 Performance Statistics Failure KPI IE

| | | IE Type and | |
|---|---|---|---|
| IE/Group Name | Presence | Reference | Semantics Description |
| Total Performance Statistics | M | INTEGER | Total performance |
| messages Received | | (0 . . . 16777216, . . . ) | statistics messages |
| | | | received from TNGF-C |
| Total Performance Statistics | M | INTEGER | Total performance |
| Failure messages Sent | | (0 . . . 16777216, . . . ) | statistics failure messages |
| | | | sent to TNGF-C |

The peer user plane feedback failure KPI IE may indicate a total number of peer user plane feedback messages received from the TNGF-C entity (114) and a total number of peer user plane feedback failure messages sent to the TNGF-C entity (114). Information in the peer user plane feedback failure KPI IE is shown in Table 66.

TABLE 66
E11 Peer User Plane Feedback Failure KPI IE

| | | IE Type and | |
|---|---|---|---|
| IE/Group Name | Presence | Reference | Semantics Description |
| Total Peer User Plane | M | INTEGER | Total peer user plane |
| Feedback Messages Received | | (0 . . . 16777216, . . . ) | feedback messages |
| | | | received from TNGF-C |
| Total Peer User Plane | M | INTEGER | Total peer user plane |
| Feedback Failure Messages | | (0 . . . 16777216, . . . ) | feedback failure |
| Sent | | | messages sent to TNGF-C |

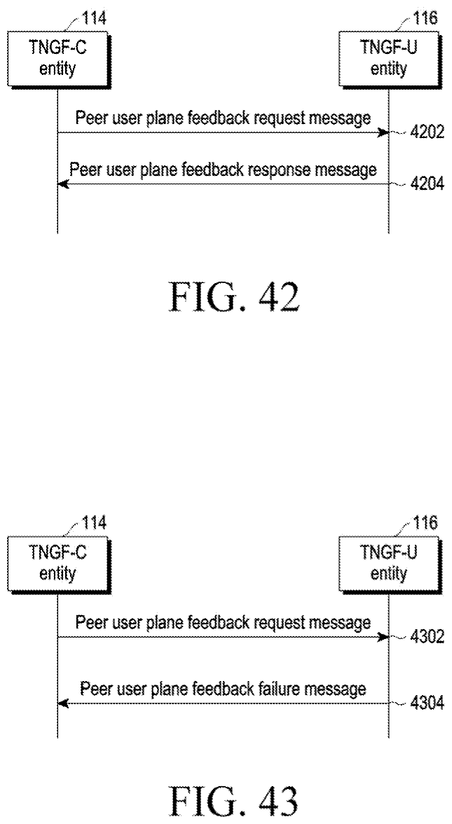

FIG. 42 is a sequence diagram illustrating a peer user plane feedback reporting initiation during a success scenario, according to an embodiment. As shown in FIG. 42, at operation 4202, the TNGF-C entity (114) may send a peer user plane feedback request message to the TNGF-U entity (116). Based on the peer user plane feedback request message, at operation 4204, the TNGF-C entity (114) may receive the peer user plane feedback response message from the TNGF-U entity (116).

FIG. 43 is a sequence diagram illustrating a peer user plane feedback reporting initiation during a failure scenario, according to an embodiment. As shown in FIG. 43, at operation 4302, the TNGF-C entity (114) may send a peer user plane feedback request message to the TNGF-U entity (116). Based on the peer user plane feedback request message, at operation 4304, the TNGF-C entity (114) may receive the peer user plane feedback failure message from the TNGF-U entity (116).

The peer user plane feedback request message may be sent by a TNGF-C entity (114) to the TNGF-U entity (116) to initiate the requested peer user plane feedback according to the parameters given in the peer user plane feedback request message. The UPF may be considered as a user plane peer of the TNGF-U entity (116). Information in the peer user plane feedback request message is shown in Table 67.

TABLE 67
E11 Peer User Plane Feedback Request Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C Peer | M | INTEGER (1 . . . 4095, . . . ) | Allocated by TNGF-C |
| UP Feedback | | | |
| ID | | | |
| TNGF-U Peer | C-ifPeerUP | INTEGER (1 . . . 4095, . . . ) | Allocated by TNGF-U |
| UP Feedback | Feedback | | |
| ID | Registration | | |
| | RequestStop | | |
| Peer UP | M | ENUMERATED(start, | Type of request for which |
| Feedback | | stop, . . . ) | the peer user plane feedback |
| Registration | | | is required. |
| Request | | | |
| Peer UP | C-ifPeerUP | BITSTRING(SIZE(32)) | Each position in the bitmap |
| Feedback | Feedback | | indicates Peer UP Feedback |
| Report | Registration | | object the TNGF-U is |
| Characteristics | RequestStart | | requested to report. |
| | | | 1st Bit = Peer UP Feedback |
| | | | Ind Periodic, |
| | | | Other bits may be ignored |
| | | | by the TNGF-U. |
| Peer UP | O | ENUMERATED | Periodicity that may be used |
| Feedback | | (500 ms, 1000 ms, | for reporting Peer UP |
| Reporting | | 2000 ms, 5000 ms, | Feedback. Also used as the |
| Periodicity | | 10000 ms, 20000 ms, | averaging window length |
| | | 30000 ms, 40000 ms, | for all peer user plane |
| | | 50000 ms, 60000 ms, | feedback object if |
| | | 70000 ms, 80000 ms, | supported. |
| | | 90000 ms, 100000 ms, | |
| | | 110000 ms, 120000 ms, . . . ) | |

The peer user plane feedback response message may be sent by the TNGF-U entity (116) to indicate that the requested peer user plane feedback, for all the peer user plane feedback objects included in the peer user plane feedback, may be successfully initiated. Information in the peer user plane feedback response message is shown in Table 68.

TABLE 68
E11 Peer User Plane Feedback Response Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C Peer | M | INTEGER (1 . . . 4095, . . . ) | Allocated by TNGF-C |
| UP Feedback | | | |
| ID | | | |
| TNGF-U Peer | M | INTEGER (1 . . . 4095, . . . ) | Allocated by TNGF-U |
| UP Feedback | | | |
| ID | | | |
| Criticality | O | | |
| Diagnostics | | | |

The peer user plane feedback failure message may be sent by the TNGF-U entity (116) to indicate that, for any of the requested peer user plane feedback objects, the peer user plane feedback may not be initiated. Information in the peer user plane feedback failure message is shown in Table 69.

TABLE 69
E11 Peer User Plane Feedback Failure Message

| | | IE Type and | |
|---|---|---|---|
| IE/Group Name | Presence | Reference | Semantics Description |
| Message Type | M | | |
| Transaction ID | M | INTEGER (0 . . . 255, . . . ) | |
| TNGF-C Peer | M | INTEGER (1 . . . 4095, . . . ) | Allocated by TNGF-C |
| UP Feedback | | | |
| ID | | | |
| TNGF-U Peer | C-ifPeerUP | INTEGER (1 . . . 4095, . . . ) | Allocated by TNGF-U |
| UP Feedback | Feedback | | |
| ID | Registration | | |
| | RequestStop | | |
| Cause | M | | Ignored by the receiver |
| | | | when the Complete Failure |
| | | | Cause Information IE is |
| | | | included |
| Criticality | O | | |
| Diagnostics | | | |

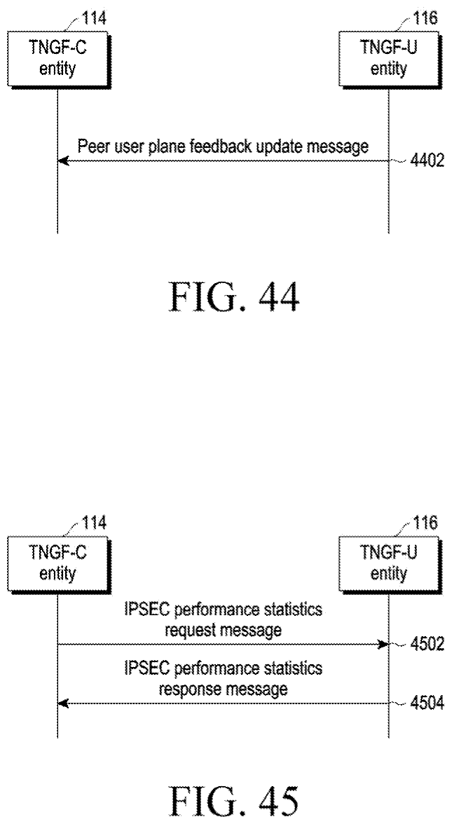

FIG. 44 is a sequence diagram illustrating a peer user plane feedback reporting during a success scenario, according to an embodiment. At operation 4402, the TNGF-C entity (114) may receive the peer user plane feedback update message from the TNGF-U entity (116).

The peer user plane feedback update message may report the results of the requested peer user plane feedback. Information in the peer user plane feedback update message is shown in Tables 70 and 71.

TABLE 70
E11 Peer User Plane Feedback Update Message

| | | IE Type and | |
|---|---|---|---|
| IE/Group Name | Presence | Reference | Semantics Description |
| Message Type | M | | |
| Transaction ID | M | INTEGER | |
| | | (0 . . . 255, . . . ) | |
| TNGF-C Peer UP Feedback | M | INTEGER | Allocated by TNGF-C |
| ID | | (1 . . . 4095, . . . ) | |
| TNGF-U Peer UP Feedback | M | INTEGER | Allocated by TNGF-U |
| ID | | (1 . . . 4095, . . . ) | |
| Peer UP Feedback Indicator | O | 1 . . . <maxnoofPeer | |
| | | UPs> | |
| >Transport Layer Address | M | BITSTRING | Peer user plane interface |
| | | (SIZE(1 . . . 160, . . . )) | IP address. IP address of |
| | | | UPF is considered. |
| >>Peer User Plane | M | INTEGER (1 . . . 10) | Feedback of peer user |
| Feedback | | | plane interface. Value 1 |
| | | | corresponds to the lowest |
| | | | performance and 10 |
| | | | corresponds to the |
| | | | highest performance. |

TABLE 71
Peer User Plane Feedback Update Message Ranges

| Range Bound | Explanation |
|---|---|
| maxnoofPeerUPs | Maximum number of peer user plane |
| | interfaces. Value is 256. |

FIG. 45 is a sequence diagram illustrating an IPSec performance statistics reporting initiation during a success scenario, according to an embodiment. As shown in FIG. 45, at operation 4502, the TNGF-C entity (114) may send an IPSec performance statistics request message to the TNGF-U entity (116). Based on the IPSec performance statistics request message, at operation 4504, the TNGF-C entity (114) may receive an IPSec performance statistics response message from the TNGF-U entity (116).

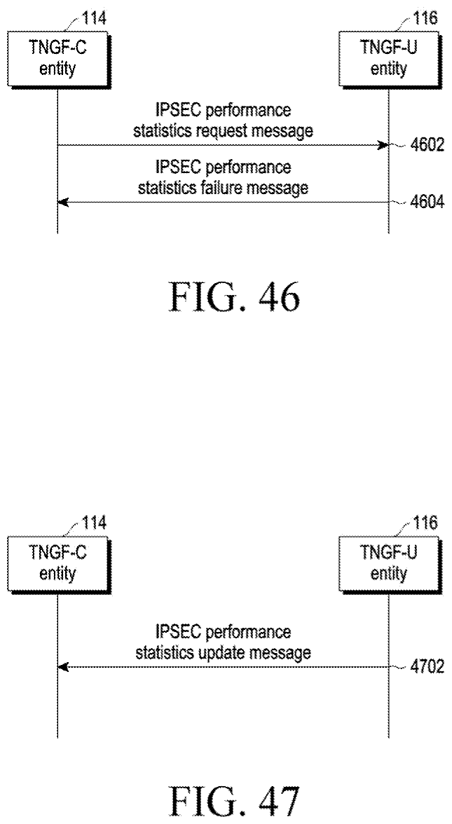

FIG. 46 is a sequence diagram illustrating an IPSec performance statistics reporting initiation during a failure scenario, according to an embodiment. As shown in FIG. 46, at operation 4602, the TNGF-C entity (114) may send an IPSec performance statistics request message to the TNGF-U entity (116). Based on the IPSec performance statistics request message, at operation 4604, the TNGF-C entity (114) may receive an IPSec performance statistics failure message from the TNGF-U entity (116).

The IPSec performance statistics request message may be sent by a TNGF-C to TNGF-U to initiate the requested IPSec KPIs according to the parameters given in the IPSec performance statistics request message. Information in the IPSec performance statistics request message is shown in Table 72.

TABLE 72
E11 IPSec Performance Statistics Request Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C IPSec | M | INTEGER (1 . . . 4095, . . . ) | Allocated by TNGF-C |
| KPI ID | | | |
| TNGF-U | C-ifIPSecKPI | INTEGER (1 . . . 4095, . . . ) | Allocated by TNGF-U |
| IPSec KPI ID | Registration | | |
| | RequestStop | | |
| IPSec KPI | M | ENUMERATED (start, | Type of request for which |
| Registration | | stop, . . . ) | the IPSec performance |
| Request | | | statistics is required. |
| IE/Group | Presence | IE Type and | Semantics Description |
| Name | | Reference | |
| IPSec KPI | C-ifIPSecKPI | BITSTRING | Each position in the bitmap |
| Report | Registration | (SIZE(32)) | indicates IPSec KPI object |
| Characteristics | RequestStart | | the TNGF-U is requested to |
| | | | report. |
| | | | 1st Bit = |
| | | | INVALID IKE SPI Failure |
| | | | Ind Periodic. |
| | | | 2nd Bit = IKE SA |
| | | | Establishment Failure Ind |
| | | | Periodic, |
| | | | 3rd Bit = IKEv2 SA |
| | | | Deletion Failure Ind |
| | | | Periodic, |
| | | | 4th Bit = IPSec SA Creation |
| | | | Failure Ind Periodic, |
| | | | 5th Bit = IPSec SA |
| | | | Modification Failure Ind |
| | | | Periodic, |
| | | | 6th Bit = IPSec SA Deletion |
| | | | Failure Ind Periodic, |
| | | | 7th Bit = Liveness Check |
| | | | Failure Ind Periodic. |
| | | | 8th Bit = IKE SA Rekeying |
| | | | Failure Ind Periodic. |
| | | | 9th Bit = IPSec SA |
| | | | Rekeying Failure Ind |
| | | | Periodic. |
| | | | 10th Bit = IPSec |
| | | | Performance Statistics |
| | | | Failure Ind Periodic |
| | | | 11th Bit = Peer IPSec |
| | | | Feedback Failure Ind |
| | | | Periodic |
| | | | Other bits may be ignored |
| | | | by the TNGF-U. |
| IPSec KPI | O | ENUMERATED | Periodicity that may be used |
| Reporting | | (500 ms, 1000 ms, | for reporting IPSec KPIs. |
| Periodicity | | 2000 ms, 5000 ms, | Also used as the averaging |
| | | 10000 ms, 20000 ms, | window length for all IPSec |
| | | 30000 ms, 40000 ms, | performance statistics object |
| | | 50000 ms, 60000 ms, | if supported. |
| | | 70000 ms, 80000 ms, | |
| | | 90000 ms, 100000 ms, | |
| | | 110000 ms, 120000 ms, . . . ) | |

The IPSec performance statistics response message may be sent by the TNGF-U entity (116) to indicate that the requested IPSec performance statistics (e.g., KPIs), for all the IPSec performance statistics objects included in the IPSec performance statistics request message, may be successfully initiated. Information in the IPSec performance statistics response message is shown in Table 73.

TABLE 73
E11 IPSec Performance Statistics Response Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| TNGF-C IPSec KPI ID | M | INTEGER | Allocated by TNGF-C |
| | | (1 . . . 4095, . . . ) | |
| TNGF-U IPSec KPI ID | M | INTEGER | Allocated by TNGF-U |
| | | (1 . . . 4095, . . . ) | |
| Criticality Diagnostics | O | | |

The IPSec performance statistics failure message may be sent by the TNGF-U entity (116) to indicate that, for any of the requested IPSec performance statistics objects, the IPSec performance statistics may not be initiated. Information in the IPSec performance statistics failure message is shown in Table 74.

TABLE 74
E11 IPSec Performance Statistics Failure Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C IPSec | M | INTEGER (1 . . . 4095, . . . ) | Allocated by TNGF-C |
| KPI ID | | | |
| TNGF-U | C-ifIPSecKPI | INTEGER (1 . . . 4095, . . . ) | Allocated by TNGF-U |
| IPSec KPI ID | Registration | | |
| | RequestStop | | |
| Cause | M | | Ignored by the receiver |
| | | | when the Complete Failure |
| | | | Cause Information IE is |
| | | | included |
| Criticality | O | | |
| Diagnostics | | | |

FIG. 47 is a sequence diagram illustrating an IPSec performance statistics reporting during a success scenario, according to an embodiment. At operation 4702, the TNGF-C entity (114) may receive an IPSec performance statistics update message from the TNGF-U entity (116). The IPSec performance statistics update message may be sent by the TNGF-U entity (116) to the TNGF-C entity (114) to report the results of the requested IPSec performance statistics. Information in the IPSec performance statistics update message is shown in Table 75.

TABLE 75
E11 IPSec Performance Statistics Update Message

| | | IE Type and | |
|---|---|---|---|
| IE/Group Name | Presence | Reference | Semantics Description |
| Message Type | M | | |
| Transaction ID | M | INTEGER | |
| | | (0..255, . . . ) | |
| TNGF-C IPSec KPI ID | M | INTEGER | Allocated by TNGF-C |
| | | (1..4095, . . . ) | |
| TNGF-U IPSec KPI ID | M | INTEGER | Allocated by TNGF-U |
| | | (1..4095, . . . ) | |
| INVALID_IKE_SPI Failure | O | INTEGER | |
| Indicator Periodic | | (0..16777216, . . . ) | |
| IKE SA Establishment | O | IKE SA | |
| Failure Indicator Periodic | | Establishment | |
| | | Failure KPI | |
| IKEv2 SA Deletion Failure | O | IKEv2 SA | |
| Indicator | | Deletion Failure | |
| | | KPI | |
| IPSec SA Creation Failure | O | IPSec SA | |
| Indicator | | Creation Failure | |
| | | KPI | |
| IPSec SA Modification | O | IPSec SA | |
| Failure Indicator | | Modification | |
| | | Failure KPI | |
| IPSec SA Deletion Failure | O | IPSec SA | |
| Indicator | | Deletion Failure | |
| | | KPI | |
| Liveness Check Failure | O | Liveness Check | |
| Indicator | | Failure KPI | |
| IKE SA Rekeying Failure | O | IKE SA Rekeying | |
| Indicator | | Failure KPI | |
| IPSec SA Rekeying Failure | O | IPSec SA | |
| Indicator | | Rekeying Failure | |
| | | KPI | |
| IPSec Performance Statistics | O | IPSec | |
| Failure Indicator | | Performance | |
| | | Statistics Failure | |
| | | KPI | |
| Peer IPSec Feedback Failure | O | Peer IPSec | |
| Indicator | | Feedback Failure | |
| | | KPI | |

The IKE SA establishment failure KPI IE may indicate a total number of IKE SA establishment (e.g. IKE_SA_INIT, IKE_AUTH) messages received from the UE (106) by TNGF-U entity (116) and a total number of IKE SA establishment failure messages sent to the UE (106) by TNGF-U entity (116). Information in the IKE SA establishment failure KPI IE is shown in Tables 76 and 77.

TABLE 76
E11 IKE_SA_INIT Failure KPI IE

| | | IE Type and | |
|---|---|---|---|
| IE/Group Name | Presence | Reference | Semantics Description |
| IKE_SA_INIT Failure KPI | M | | |
| >Total IKE_SA_INIT | M | INTEGER | Total IKE_SA_INIT |
| messages Received | | (0..16777216, . . . ) | messages received from |
| | | | UE by TNGF-U |
| >Failed IKE_SA_INIT | M | | |
| Sent KPI | | | |
| >>Number of ERROR | M | INTEGER | Number of ERROR |
| COOKIE | | (0..16777216, . . . ) | COOKIE sent to UE |
| >>Number of | M | INTEGER | Number of |
| INVALID_KE_{—} | | (0..16777216, . . . ) | INVALID_KE_PAYLOAD |
| PAYLOAD | | | sent to UE |
| >>Number of | M | INTEGER | Number of |
| INVALID_MAJOR_{—} | | (0..16777216, . . . ) | INVALID_MAJOR_VERSION |
| VERSION | | | sent to UE |
| >>Number of | M | INTEGER | Number of |
| TEMPORARY_{—} | | (0..16777216, . . . ) | TEMPORARY_FAILURE |
| FAILURE | | | sent to UE |

TABLE 77
E11 IKE_AUTH Failure KPI IE

| | | IE Type and | |
|---|---|---|---|
| IE/Group Name | Presence | Reference | Semantics Description |
| IKE_AUTH Failure KPI | M | | |
| >Total IKE_AUTH | M | INTEGER | Total IKE_AUTH |
| Messages Received | | (0..16777216, . . . ) | messages received from |
| | | | UE |
| >Failed IKE_AUTH Sent | M | | |
| KPI | | | |
| >>Number of | M | INTEGER | Number of |
| AUTHENTICATION_{—} | | (0..16777216, . . . ) | AUTHENTICATION_{—} |
| FAILED | | | FAILED sent to UE |
| >>Number of | M | INTEGER | Number of |
| UNSUPPORTED_{—} | | (0..16777216, . . . ) | UNSUPPORTED_CRITICAL_{—} |
| CRITICAL_PAYLOAD | | | PAYLOAD sent to |
| | | | UE |
| >>Number of | M | INTEGER | Number of |
| INVALID_SYNTAX | | (0..16777216, . . . ) | INVALID_SYNTAX |
| | | | sent to UE |
| >>Number of | M | INTEGER | Number of |
| FAILED_CP_{—} | | (0..16777216, . . . ) | FAILED_CP_REQUIRED |
| REQUIRED | | | sent to UE |
| >>Number of | M | INTEGER | Number of |
| NO_PROPOSAL_{—} | | (0..16777216, . . . ) | NO_PROPOSAL_CHOSEN |
| CHOSEN | | | sent to UE |

The IKEv2 SA deletion failure KPI IE may indicate a total number of TNGF-U/UE initiated IKEv2 SA deletion messages and a total number of TNGF-U/UE IKEv2 SA deletion failure messages. Information in the IKEv2 SA deletion failure KPI IE is shown in Table 78.

TABLE 78
E11 IKEv2 SA Deletion Failure KPI IE

| | | IE Type and | |
|---|---|---|---|
| IE/Group Name | Presence | Reference | Semantics Description |
| TNGF-U Initiated IKEv2 SA | M | | |
| Deletion Failure KPI | | | |
| >Total IKEv2 SA Deletion | M | INTEGER | Total TNGF-U initiated |
| Messages Sent | | (0..16777216, . . . ) | IKEv2 SA deletion |
| | | | messages sent to UE |
| >Total KEv2 SA Deletion | M | INTEGER | Total IKEv2 SA Deletion |
| Failure Messages | | (0..16777216, . . . ) | failure messages received |
| Received | | | from UE |
| UE Initiated IKEv2 SA | M | | |
| Deletion Failure KPI | | | |
| >Total IKEv2 SA Deletion | M | INTEGER | Total UE initiated IKEv2 |
| Messages Sent | | (0..16777216, . . . ) | SA deletion messages |
| | | | sent to TNGF-U |
| >Total KEv2 SA Deletion | M | INTEGER | Total IKEv2 SA Deletion |
| Failure Messages | | (0..16777216, . . . ) | failure messages received |
| Received | | | from TNGF-U |

The IPSec SA Creation Failure KPI IE may indicate a total number of IPSec SA Creation messages sent to UE (106) by the TNGF-U entity (116) and a total number of IPSec SA Creation Failure messages received from the UE (106). Information in the IPSec SA Creation Failure KPI IE is shown in Table 79.

TABLE 79
E11 IPSec SA Creation Failure KPI IE

| | | IE Type and | |
|---|---|---|---|
| IE/Group Name | Presence | Reference | Semantics Description |
| Total IPSec SA Creation | M | INTEGER | Total IPSec SA Creation |
| messages Sent | | (0..16777216, . . . ) | messages sent to UE by |
| | | | TNGF-U |
| Total IPSec SA Creation | M | INTEGER | Total IPSec SA Creation |
| Failure messages Received | | (0..16777216, . . . ) | Failure messages |
| | | | received from UE |

The IPSec SA Modification Failure KPI IE may indicate a total number of TNGF-U/UE initiated IPSec SA Modification messages and a total number of TNGF-U/UE IPSec SA Modification Failure messages. Information in the IPSec SA Modification Failure KPI IE is shown in Table 80.

TABLE 80
E11 IPSec SA Modification Failure KPI IE

| | | IE Type and | |
|---|---|---|---|
| IE/Group Name | Presence | Reference | Semantics Description |
| TNGF-U Initiated IPSec SA | M | | |
| Modification Failure KPI | | | |
| >Total IPSec SA | M | INTEGER | Total TNGF-U initiated |
| Modification Messages | | (0..16777216, . . . ) | IPSec SA Modification |
| Sent | | | messages sent to UE |
| >Total IPSec SA | M | INTEGER | Total IPSec SA |
| Modification Failure | | (0..16777216, . . . ) | Modification Failure |
| Messages Received | | | messages received from |
| | | | UE |
| UE Initiated IPSec SA | M | | |
| Modification Failure KPI | | | |
| >Total IPSec SA | M | INTEGER | Total UE initiated IPSec |
| Modification Messages | | (0..16777216, . . . ) | SA Modification |
| Sent | | | messages sent to TNGF- |
| | | | U |
| >Total IPSec SA | M | INTEGER | Total IPSec SA |
| Modification Failure | | (0..16777216, . . . ) | Modification Failure |
| Messages Received | | | messages received from |
| | | | TNGF-U |

The IPSec SA deletion failure KPI IE may indicate a total number of TNGF-U/UE initiated IPSec SA Deletion messages and a total number of TNGF-U/UE IPSec SA Deletion Failure messages. Information in the IPSec SA Deletion Failure KPI IE is shown in Table 81.

TABLE 81
E11 IPSec SA Deletion Failure KPI IE

| | | IE Type and | |
|---|---|---|---|
| IE/Group Name | Presence | Reference | Semantics Description |
| TNGF-U Initiated IPSec SA | M | | |
| Deletion Failure KPI | | | |
| >Total IPSec SA Deletion | M | INTEGER | Total TNGF-U initiated |
| Messages Sent | | (0..16777216, . . . ) | IPSec SA Deletion |
| | | | messages sent to UE |
| >Total IPSec SA Deletion | M | INTEGER | Total IPSec SA Deletion |
| Failure Messages | | (0..16777216, . . . ) | Failure messages |
| Received | | | received from UE |
| UE Initiated IPSec SA | M | | |
| Deletion Failure KPI | | | |
| >Total IPSec SA Deletion | M | INTEGER | Total UE initiated IPSec |
| Messages Sent | | (0..16777216, . . . ) | SA Deletion messages |
| | | | sent to TNGF-U |
| >Total IPSec SA Deletion | M | INTEGER | Total IPSec SA Deletion |
| Failure Messages | | (0..16777216, . . . ) | Failure messages |
| Received | | | received from TNGF-U |

The liveness check failure KPI IE may indicate a total number of TNGF-U/UE initiated liveness check messages and a total number of TNGF-U/UE liveness check failure messages. Information in the liveness check failure KPI IE is shown in Table 82.

TABLE 82
E11 Liveness Check Failure KPI IE

| | | IE Type and | |
|---|---|---|---|
| IE/Group Name | Presence | Reference | Semantics Description |
| TNGF-U Initiated Liveness | M | | |
| Check Failure KPI | | | |
| >Total Liveness Check | M | INTEGER | Total TNGF-U initiated |
| Messages Sent | | (0..16777216, . . . ) | Liveness Check messages |
| | | | sent to UE |
| >Total Liveness Check | M | INTEGER | Total Liveness Check |
| Failure Messages | | (0..16777216, . . . ) | Failure messages |
| Received | | | received from UE |
| UE Initiated Liveness Check | M | | |
| Failure KPI | | | |
| >Total Liveness Check | M | INTEGER | Total UE initiated |
| Messages Sent | | (0..16777216, . . . ) | Liveness Check messages |
| | | | sent to TNGF-U |
| >Total Liveness Check | M | INTEGER | Total Liveness Check |
| Failure Messages | | (0..16777216, . . . ) | Failure messages |
| Received | | | received from TNGF-U |

The IKE SA rekeying failure KPI IE may indicate a total number of TNGF-U/UE initiated IKE SA Rekeying messages and a total number of TNGF-U/UE IKE SA Rekeying Failure (TEMPORARY_FAILURE) messages. Information in the IKE SA Rekeying Failure KPI IE is shown in Table 83.

TABLE 83
E11 IKE SA Rekeying Failure KPI IE

| | | IE Type and | |
|---|---|---|---|
| IE/Group Name | Presence | Reference | Semantics Description |
| TNGF-U Initiated IKE SA | M | | |
| Rekeying Failure KPI | | | |
| >Total IKE SA Rekeying | M | INTEGER | Total TNGF-U initiated |
| messages Sent | | (0..16777216, . . . ) | IKE SA Rekeying |
| | | | messages sent to UE |
| >Total IKE SA Rekeying | M | INTEGER | Total IKE SA Rekeying |
| Failure messages | | (0..16777216, . . . ) | Failure messages |
| Received | | | received from UE |
| UE Initiated IKE SA | M | | |
| Rekeying Failure KPI | | | |
| >Total IKE SA Rekeying | M | INTEGER | Total UE initiated IKE |
| messages Sent | | (0..16777216, . . . ) | SA Rekeying messages |
| | | | sent to TNGF-U |
| >Total IKE SA Rekeying | M | INTEGER | Total IKE SA Rekeying |
| Failure messages | | (0..16777216, . . . ) | Failure messages |
| Received | | | received from TNGF-U |

The IPSec SA rekeying failure KPI IE may indicate a total number of TNGF-U/UE initiated IPSec SA Rekeying messages and a total number of TNGF-U/UE IPSec SA Rekeying Failure messages. Information in the IPSec SA Rekeying Failure KPI IE is shown in Table 84.

TABLE 84
E11 IPSec SA Rekeying Failure KPI IE

| | | IE Type and | |
|---|---|---|---|
| IE/Group Name | Presence | Reference | Semantics Description |
| TNGF-U Initiated IPSec SA | M | | |
| Rekeying Failure KPI | | | |
| >Total IPSec SA Rekeying | M | INTEGER | Total TNGF-U initiated |
| Messages Sent | | (0..16777216, . . . ) | IPSec SA Rekeying |
| | | | messages sent to UE |
| >Failed IPSec SA | M | | |
| Rekeying Received KPI | | | |
| >>Number of | M | INTEGER | Number of |
| TEMPORARY_{—} | | (0..16777216, . . . ) | TEMPORARY_FAILURE |
| FAILURE | | | received from UE |
| >>Number of | M | INTEGER | Number of |
| UNSUPPORTED_{—} | | (0..16777216, . . . ) | UNSUPPORTED_CRITICAL_{—} |
| CRITICAL_PAYLOAD | | | PAYLOAD |
| | | | received from UE |
| UE Initiated IPSec SA | M | | |
| Rekeying Failure KPI | | | |
| >Total IPSec SA Rekeying | M | INTEGER | Total UE initiated IPSec |
| Messages Sent | | (0..16777216, . . . ) | SA Rekeying messages |
| | | | sent to TNGF-U |
| >Failed IPSec SA | M | | |
| Rekeying Received KPI | | | |
| >>Number of | M | INTEGER | Number of |
| TEMPORARY_{—} | | (0..16777216, . . . ) | TEMPORARY_FAILURE |
| FAILURE | | | received from TNGF-U |
| >>Number of | M | INTEGER | Number of |
| CHILD_SA_NOT_{—} | | (0..16777216, . . . ) | CHILD_SA_NOT_FOUND |
| FOUND | | | received from |
| | | | TNGF-U |

The IPSec performance statistics failure KPI IE may indicate a total number of IPSec Performance Statistics messages received from the TNGF-C entity (114) and a total number of IPSec performance statistics failure messages sent to the TNGF-C entity (114). Information in the IPSec performance statistics failure KPI IE is shown in Table 85.

TABLE 85
E11 IPSec Performance Statistics Failure KPI IE

| | | IE Type and | |
|---|---|---|---|
| IE/Group Name | Presence | Reference | Semantics Description |
| Total IPSec Performance | M | INTEGER | Total IPSec performance |
| Statistics Messages Received | | (0..16777216, . . . ) | statistics messages |
| | | | received from TNGF-C |
| Total IPSec Performance | M | INTEGER | Total IPSec performance |
| Statistics Failure Messages | | (0..16777216, . . . ) | statistics failure messages |
| Sent | | | sent to TNGF-C |

The peer IPSec feedback failure KPI IE may indicate a total number of Peer IPSec Feedback messages received from the TNGF-C entity (114) and a total number of Peer IPSec feedback failure messages sent to the TNGF-C entity (114). Information in the peer IPSec feedback failure KPI IE is shown in Table 86.

TABLE 86
E11 Peer IPSec Feedback Failure KPI IE

| | | IE Type and | |
|---|---|---|---|
| IE/Group Name | Presence | Reference | Semantics Description |
| Total Peer IPSec Feedback | M | INTEGER | Total Peer IPSec |
| Messages Received | | (0..16777216, . . . ) | feedback messages |
| | | | received from TNGF-C |
| Total Peer IPSec Feedback | M | INTEGER | Total Peer IPSec |
| Failure Messages Sent | | (0..16777216, . . . ) | feedback failure |
| | | | messages sent to TNGF- |
| | | | C |

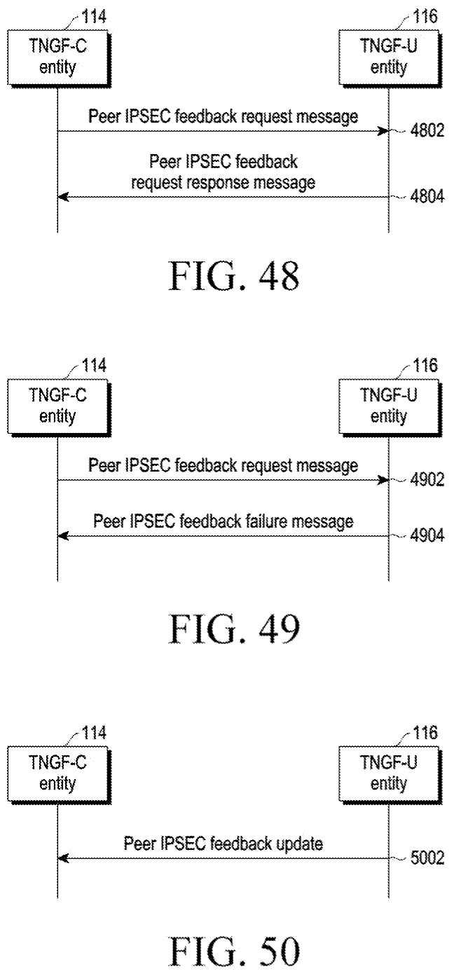

FIG. 48 is a sequence diagram illustrating a Peer IPSec feedback reporting initiation during a success scenario, according to an embodiment. As shown in FIG. 48, at operation 4802, the TNGF-C entity (114) may send a peer IPSec feedback request message to the TNGF-U entity (116). Based on the peer IPSec feedback request message, at operation 4804, the TNGF-C entity (114) may receive a peer IPSec feedback response message from the TNGF-U entity (116).

FIG. 49 is a sequence diagram illustrating a peer IPSec feedback reporting initiation during a failure scenario, according to an embodiment. As shown in FIG. 49, at operation 4902, the TNGF-C entity (114) may send a peer IPSec feedback request message to the TNGF-U entity (116). Based on the peer IPSec feedback request message, at operation 4904, the TNGF-C entity (114) may receive a peer IPSec feedback failure message from the TNGF-U entity (116).

The peer IPSec feedback request message may be sent by the TNGF-C entity (114) to the TNGF-U entity (116) to initiate the requested peer IPSec feedback according to the parameters given in the peer IPSec feedback request message. The UE (106) may be considered as an IPSec peer of the TNGF-U entity (116). Information in the peer IPSec feedback request message is shown in Tables 87 and 88.

TABLE 87
E11 Peer IPSec Feedback Request Message

| IE/Group | | IE Type and | |
|---|---|---|---|
| Name | Presence | Reference | Semantics Description |
| Message Type | M | | |
| Transaction ID | M | INTEGER (0..255, . . . ) | |
| TNGF-C Peer | M | INTEGER (1..4095, . . . ) | Allocated by TNGF-C |
| IPSec | | | |
| Feedback ID | | | |
| TNGF-U Peer | C-ifPeerIPSec | INTEGER (1..4095, . . . ) | Allocated by TNGF-U |
| IPSec | Feedback | | |
| Feedback ID | Registration | | |
| | RequestStop | | |
| Peer IPSec | M | ENUMERATED (start, | Type of request for which |
| Feedback | | stop, . . . ) | the peer IPSec feedback is |
| Registration | | | required. |
| Request | | | |
| Peer IPSec | C-ifPeerIPSec | BITSTRING | Each position in the bitmap |
| Feedback | Feedback | (SIZE(32)) | indicates Peer IPSec |
| Report | Registration | | Feedback object the TNGF- |
| Characteristics | RequestStart | | U is requested to report. |
| | | | 1st Bit = Peer IPSec |
| | | | Feedback Ind Periodic, |
| | | | Other bits may be ignored |
| | | | by the TNGF-U. |
| Peer IPSec | O | ENUMERATED | Periodicity that may be used |
| Feedback | | (500 ms, 1000 ms, | for reporting Peer IPSec |
| Reporting | | 2000 ms, 5000 ms, | Feedback. Also used as the |
| Periodicity | | 10000 ms, 20000 ms, | averaging window length |
| | | 30000 ms, 40000 ms, | for all peer user plane |
| | | 50000 ms, 60000 ms, | feedback object if |
| | | 70000 ms, 80000 ms, | supported. |
| | | 90000 ms, 100000 ms, | |
| | | 110000 ms, 120000 ms, | |
| | | . . . ) | |

TABLE 88
E11 Peer IPSec Feedback Request Message Conditions

| Condition | Explanation |
|---|---|
| ifPeerIPSecFeedbackRegistrationRequestStop | This IE may be present if the Peer IPSec Feedback |
| | Registration Request IE is set to the value “stop” |
| ifPeerIPSecFeedbackRegistrationRequestStart | This IE may be present if the Peer IPSec Feedback |
| | Registration Request IE is set to the value “start”. |

The peer IPSec feedback response message may be sent by the TNGF-U entity (116) to indicate that the requested peer IPSec feedback, for all the peer IPSec feedback objects included in the peer IPSec feedback may be successfully initiated. Information in the peer IPSec feedback response message is shown in Table 89

TABLE 89
E11 Peer IPSec Feedback Response Message

| | | IE Type and | |
|---|---|---|---|
| IE/Group Name | Presence | Reference | Semantics Description |
| Message Type | M | | |
| Transaction ID | M | INTEGER | |
| | | (0..255, . . . ) | |
| TNGF-C Peer IPSec | M | INTEGER | Allocated by TNGF-C |
| Feedback ID | | (1..4095, . . . ) | |
| TNGF-U Peer IPSec | M | INTEGER | Allocated by TNGF-U |
| Feedback ID | | (1..4095, . . . ) | |
| Criticality Diagnostics | O | | |

The peer IPSec feedback failure message may be sent by the TNGF-U entity (116) to indicate that, for any of the requested peer IPSec feedback objects, the peer IPSec feedback may not be initiated. Information in the peer IPSec feedback failure message is shown in Tables 90 and 91.

TABLE 90
E11 Peer IPSec Feedback Failure Message

| IE/Group | | IE Type and | |
|---|---|---|---|
| Name | Presence | Reference | Semantics Description |
| Message Type | M | | |
| Transaction ID | M | INTEGER (0 . . . 255, . . . ) | |
| TNGF-C Peer | M | INTEGER (1 . . . 4095, . . . ) | Allocated by TNGF-C |
| IPSec | | | |
| Feedback ID | | | |
| TNGF-U Peer | C-ifPeerIPSec | INTEGER (1 . . . 4095, . . . ) | Allocated by TNGF-U |
| IPSec | Feedback | | |
| Feedback ID | Registration | | |
| | RequestStop | | |
| Cause | M | | Ignored by the receiver |
| | | | when the Complete Failure |
| | | | Cause Information IE is |
| | | | included |
| Criticality | O | | |
| Diagnostics | | | |

TABLE 91
E11 Peer IPSec Feedback Failure Message Conditions

| Condition | Explanation |
|---|---|
| ifPeerIPSecFeedbackRegistrationRequestStop | This IE may be present if the Peer IPSec Feedback |
| | Registration Request IE is set to the value “stop” |

FIG. 50 is a sequence diagram illustrating a peer IPSec feedback reporting during a success scenario, according to an embodiment. At operation 5002, the TNGF-C entity (114) may receive a peer IPSec feedback update message from the TNGF-U entity (116). The peer IPSec feedback update message may be sent by the TNGF-U entity (116) to the TNGF-C entity (114) to report the results of the requested peer IPSec feedback. Information in the IPSec feedback update message is shown in Tables 92 and 93.

TABLE 92
E11 IPSec Feedback Update Message

| | | IE Type and | |
|---|---|---|---|
| IE/Group Name | Presence | Reference | Semantics Description |
| Message Type | M | | |
| Transaction ID | M | INTEGER | |
| | | (0 . . . 255, . . . ) | |
| TNGF-C Peer IPSec | M | INTEGER | Allocated by TNGF-C |
| Feedback ID | | (1 . . . 4095, . . . ) | |
| TNGF-U Peer IPSec | M | INTEGER | Allocated by TNGF-U |
| Feedback ID | | (1 . . . 4095, . . . ) | |
| Peer IPSec Feedback | O | 1 . . . <maxnoofPeerIPSecs> | |
| Indicator | | | |
| >Transport Layer Address | M | BIT STRING | Peer IPSec interface IP |
| | | (SIZE(1 . . . 160, | address (UE IPSec IP |
| | | . . . )) | Address). |
| >>Peer IPSec Feedback | M | INTEGER (1 . . . 10) | Feedback of peer IPSec |
| | | | interface (UE is the peer |
| | | | IPSec of TNGF-U). |
| | | | Value 1 corresponds to |
| | | | the lowest performance |
| | | | and 10 corresponds to the |
| | | | highest performance. |

TABLE 93
E11 IPSec Feedback Update Message Ranges

| Condition | Explanation |
|---|---|
| maxnoofPeerIPSecs | Maximum number of peer IPSec interfaces. Value is |
| | 65536. |

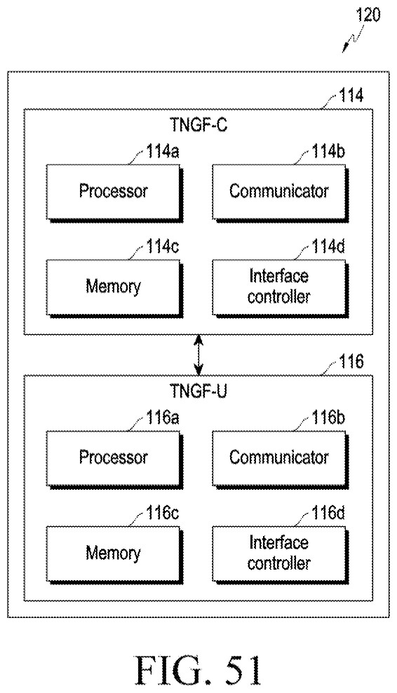

FIG. 51 shows various hardware components of the TNAN (120), according to an embodiment. In an embodiment, the TNAN (120) includes the TNGF-C entity (114) and the TNGF-U entity (116).

In an embodiment, the TNGF-C entity (114) includes a processor (114a), a communicator (114b), a memory (114c), and an interface controller (114d). The processor (114a) may be communicatively coupled with the communicator (114b), the memory (5114c), and the interface controller (114d).

The interface controller (114d) may split the functionality of the TNGF into the control plane functionality, where the control plane functionality may be handled by the TNGF-C entity (114). Further, the interface controller (114d) may add the interface between the TNGF-C entity (114) and the TNGF-U entity (116). Further, the interface controller (114d) may monitor at least one of the operations associated with the interface and the services associated with the interface.

The interface controller (114d) may be physically implemented by analog and/or digital circuits such as, but not limited to, logic gates, integrated circuits, microprocessors, microcontrollers, memory circuits, passive electronic components, active electronic components, optical components, hardwired circuits, or the like, and may optionally be driven by firmware. The interface controller (114d) may be a part of the processor (114a) or may be integrally referred to as at least one processor with the processor (114a).

Further, the processor (114a) may be configured to execute instructions stored in the memory (114c) and to perform various processes of the TNGF-C entity (114). The communicator (114b) may be configured for communicating internally between internal hardware components and with external devices via one or more networks. The memory (114c) may also store instructions to be executed by the processor (114a). The memory (114c) may include non-volatile storage elements. Examples of such non-volatile storage elements may include, but not be limited to, magnetic hard discs, optical discs, floppy discs, flash memories, and/or forms of electrically programmable memories (EPROM) and/or electrically erasable and programmable (EEPROM) memories. The memory (114a) may, in some examples, be considered a non-transitory storage medium. The term “non-transitory” may indicate that the storage medium may not be embodied in a carrier wave or a propagated signal. However, the term “non-transitory” may not be interpreted that the memory (114c) may be non-movable. In certain examples, a non-transitory storage medium may store data that may, over time, change (e.g., in random access memory (RAM) or cache).

In an embodiment, the TNGF-U entity (116) may include a processor (116a), a communicator (116b), a memory (116c), and an interface controller (116d). The processor (116a) may be communicatively coupled with the communicator (116b), the memory (116c), and the interface controller (116d).

The interface controller (116d) may split the functionality of the TNGF into the user plane functionality, where the user plane functionality may be handled by the TNGF-U entity (116). Further, the interface controller (116d) may add an interface between the TNGF-C entity (114) and the TNGF-U entity (116). Further, the interface controller (116d) may monitor at least one of the operations associated with the interface and the services associated with the interface.

The interface controller (116d) may be physically implemented by analog and/or digital circuits such as, but not limited to, logic gates, integrated circuits, microprocessors, microcontrollers, memory circuits, passive electronic components, active electronic components, optical components, hardwired circuits, or the like, and may optionally be driven by firmware. The interface controller (116d) may be a part of the processor (116a) or may be integrally referred to as at least one processor with the processor (116a).

The interface controller (e.g., 114d or 116d) may monitor an operation associated with the interface and a service associated with the interface. The operation may be, for example, but not be limited to, the user plane traffic procedure, the interface management procedure, the bearer management procedure, the trace start procedure, the deactivate trace procedure, and/or the load management procedure. The service may be, for example, but not be limited to, a UE-associated service and/or a non UE-associated service.

The interface management procedure may be, for example, but not be limited to, the reset procedure initiated from the TNGF-C entity (114), the reset procedure initiated from the at least one TNGF-U entity (116), the error indication procedure originated at the TNGF-C entity (114), the error indication procedure originated at the at least one TNGF-U entity (116), the TNGF-U E11 setup procedure, the TNGF-C E11 setup procedure, the TNGF-U configuration update procedure, the TNGF-C configuration update procedure, the E11 release procedure, and/or the TNGF-U status indication procedure.

The bearer management procedure may be, for example, but not be limited to, the bearer context setup procedure, the bearer context release request procedure initiated by the at least one TNGF-U entity (116), the bearer context release procedure initiated by the TNGF-C entity (114), the bearer context modification procedure initiated by the TNGF-C entity (114), the bearer context modification required procedure initiated by the at least one TNGF-U entity (116), the bearer context inactivity notification procedure, the data usage report procedure, the DL data notification procedure, and/or the UL data notification procedure. The load management procedure may be, for example, but not be limited to, a resource status reporting initiation procedure and/or a resource status reporting procedure.

Further, the processor (116a) may be configured to execute instructions stored in the memory (116c) and to perform various processes of the TNGF-U entity (116). The processor (114a), the processor (116a), the interface controller (114d) and the interface controller (116d) may be integrally referred to as at least one processor of the TNGF (120).

The communicator (116b) may be configured to communicate internally between internal hardware components and with external devices via one or more networks. The memory (116c) may also store instructions to be executed by the processor (116a). The memory (116c) may include non-volatile storage elements. Examples of such non-volatile storage elements may include, but not be limited to, magnetic hard discs, optical discs, floppy discs, flash memories, and/or forms of EPROM and/or EEPROM. The memory (116c) may, in some examples, be considered a non-transitory storage medium. The term “non-transitory” may indicate that the storage medium may not be embodied in a carrier wave or a propagated signal. However, the term “non-transitory” may not be interpreted that the memory (116c) may be non-movable. In some examples, a non-transitory storage medium may store data that may, over time, change (e.g., in (RAM or cache).

Although FIG. 51 shows various hardware components of the TNAN (120), it is to be understood that other embodiments are not limited thereon. In other embodiments, the TNAN (120) may include less or more components. Further, the labels or names of the components are used only for illustrative purpose and may not limit the scope of the present disclosure. One or more components may be combined together to perform the same and/or a substantially similar function in the TNAN (120).

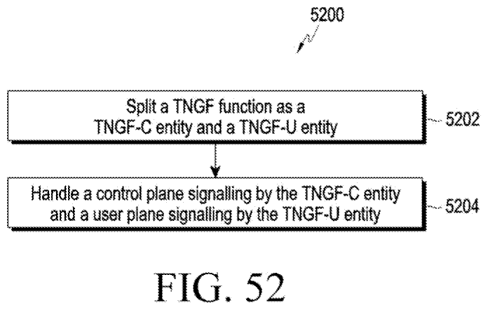

FIG. 52 is a flowchart (5200) illustrating methods for managing the TNGF operation in a TNAN (120), according to an embodiment.

At operation 5202, the method may include configuring (or splitting) the TNGF function as the TNGF-C entity (114) and the TNGF-U entity (116). At operation 5204, the method may include handling the control plane signalling by the TNGF-C entity (114) and the user plane signalling by the TNGF-U entity (116).

The method may be implemented in the CUPS on TNGF by splitting TNGF into the TNGF-C entity (114) and the TNGF-U entity (116) and by introducing the interface (e.g., E11 interface) between the TNGF-C entity (114) and the TNGF-U entity (116).

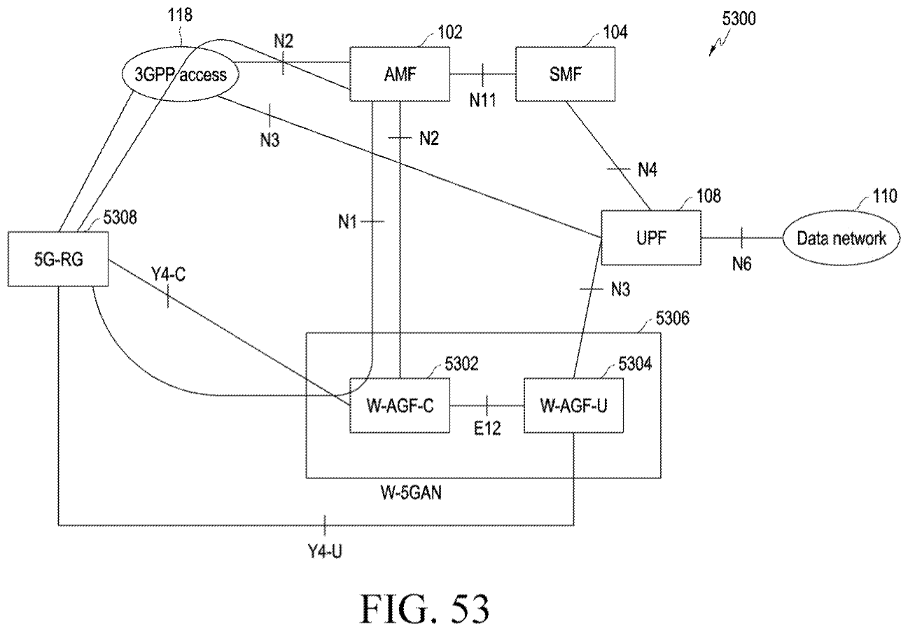

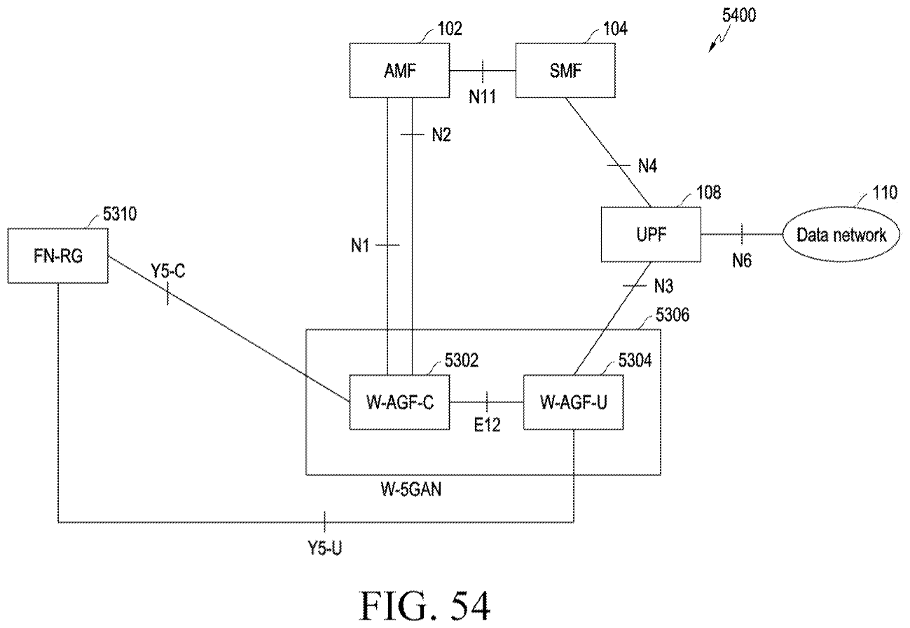

FIG. 53 illustrates a 5G core network (5300) for a 5G residential gateway (5G-RG) with W-AGF and a next generation radio access network (NG RAN) function, according to an embodiment. FIG. 54 illustrates a 5G core network (5400) for fixed network residential gateway (FN-RG) with W-AGF and NG RAN, according to an embodiment.

The 5G core network (5300) may include and/or may be similar in many respects to the wireless network (100) described above with reference to FIGS. 1 to 5, and may include additional features not mentioned above. Furthermore, many of the components, entities, and/or functions of 5G core network (5300) may include and/or may be similar in many respects to the components, entities, and/or functions described above with reference to wireless network (100), which may be denoted with the same and/or similar reference characters and may include additional features not mentioned above. Consequently, repeated descriptions of the 5G core network (5300) described above with reference to FIGS. 1 to 5 may be omitted for the sake of brevity.

In an embodiment, the 5G core network (5300) may include the AMF (102), the SMF (104), the UPF (108), the data network (110), a W-AGF-C entity (5302), a W-AGF-U entity (5304) and a wireline 5G access network (W-5GAN) function (5306), and 5G-RG (5308). The operations and functions of the AMF (102), the SMF (104), the UE (106), the UPF (108), the data network (110), and the 3GPP access network (118) may be in accordance with one or more telecommunication standards, such as, but not limited to, 3GPP TS 23.501 and 3GPP TS 23.502. For the sake of brevity, repeated descriptions of these components may be omitted.

The W-AGF-C entity (5302) and the W-AGF-U entity (5304) may be operated in the W-5GAN (5306). The W-AGF-C entity (5302) may communicate with the AMF (102) through a N1 interface and a N2 interface. The W-AGF-C entity (5302) may communicate with the W-AGF-U entity (5304) through an E12 interface.

In an embodiment, the W-AGF may be divided into the W-AGF-C entity (5302) and the W-AGF-U entity (5304). That is, the control plane signalling of the W-5GAN (5306) may be handled by the W-AGF-C entity (5302) and the user plane signalling of the W-5GAN (5306) may be handled by the W-AGF-U entity (5304). The E12 interface may be established between the W-AGF-C entity (5302) and the W-AGF-U entity (5304). An N2 interface may be used between the AMF (102) and the W-AGF-C entity (5302). An N3 interface may be used between the UPF (108) and the W-AGF-U entity (5304). The control plane signalling from the UE (106) towards a core network may be handled via the W-AGF-C entity (5302). The user plane data from the UE (106) towards the data network (110) may be handled via the W-AGF-U entity (5304).

The W-AGF-C entity (5302) may select the at least one W-AGF-U entity (5304) during the PDU session establishment procedure based on at least one of a local selection procedure, a hardware capacity of W-AGF-U entity (5304), a throughput capacity of the W-AGF-U entity (5304), a performance statistics of the W-AGF-U entity (5304), and a peer user plane (UPF) feedback of the W-AGF-U entity (5304). The local selection procedure may be and/or may include a round-robin procedure and/or may be based on the resource status received from one or more W-AGF-Us (5304).

The W-AGF-C (5302) may move the UE context from one W-AGF-U entity (5304) to another W-AGF-U entity (5304) during at least one failure scenario. The failure scenario may be, for example, but not limited to, a W-AGF-U E12 setup failure, a W-AGF-C E12 setup failure, a W-AGF-U configuration update failure, a W-AGF-C configuration update failure, a bearer context setup failure, a bearer context modification failure, and/or a resource status reporting initiation failure.

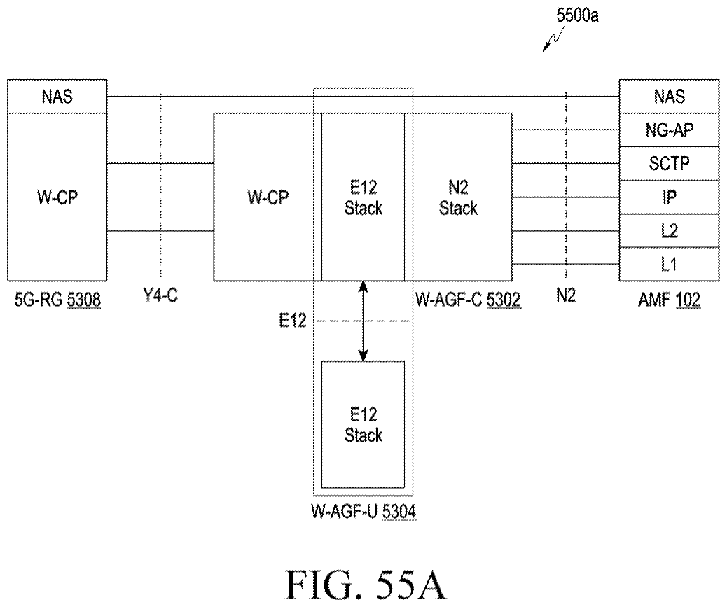

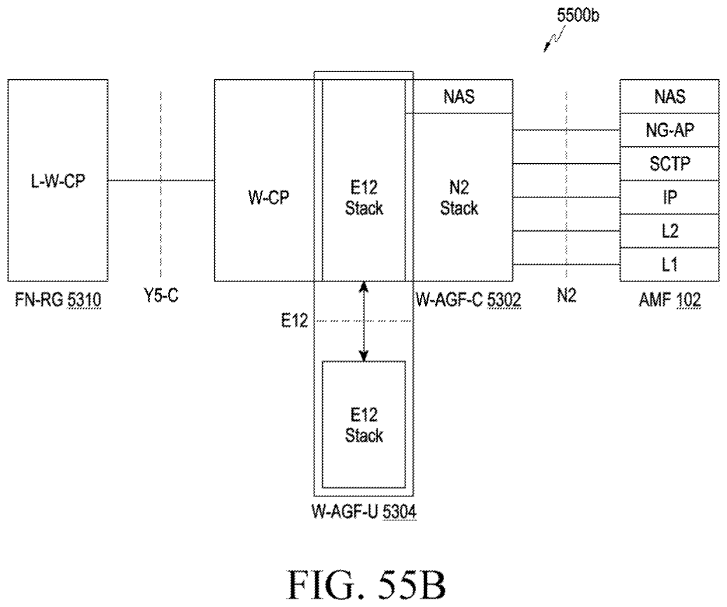

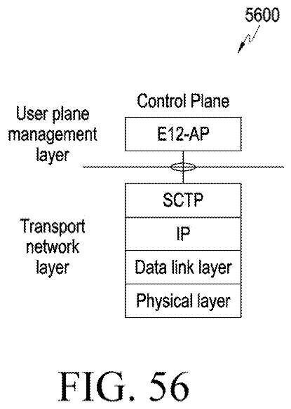

FIGS. 55A and 55B illustrate signalling (5500a and 5500b) for a user plane establishment, according to an embodiment. FIG. 56 illustrates an E12 interface protocol structure (5600), according to an embodiment.

The W-AGF-C entity (5302) and the W-AGF-U entity (5304) may run (execute) on the E12 stack. The E12 interface may have an E12 application protocol (E12AP) that may run on top of a SCTP. In another embodiment, the E12 interface may have an E12AP that may run on other transport protocols such as, but not limited to, TCP, UDP, or the like. The E12AP may handle UE-associated services and/or non UE-associated services. The non UE-associated services may be described in standard 3GPP procedures. The E12AP may support interface management, bearer management, and/or other features, as needed.

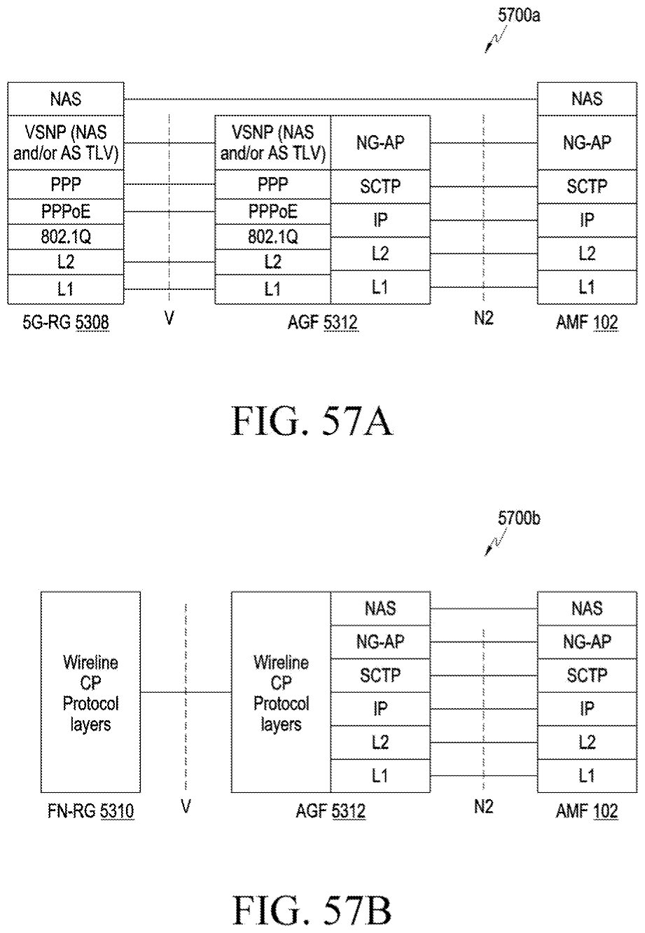

FIG. 57A illustrates a control plane stack (5700a) for a wireline 5G access network (W-5GAN-C) (W-AGF-C) for a 5G-RG, according to an embodiment. FIG. 57B illustrates a control plane stack (5700b) for a W-5GAN-C (W-AGF-C) for a FN-RG, according to an embodiment.

The PDU session ID generated by the 5G-RG may communicate to the AMF (102) by the non-access-stratum (NAS) message which may be transparent to the W-AGF-C (5302). The W-AGF-C entity (5302) may assign a 5G wireless wireline convergence user plane encapsulation (5WE) session ID and may bind the 5WE session ID to the PDU session ID. The 5WE session ID and the PDU session ID binding may be communicated (e.g., transmitted) to the 5G-RG. In the proposed W-AGF CUPS architecture, the control plane protocols may be moved to the W-AGF-C entity (5302). For example, the W-AGF-C entity (5302) may provide support for protocols such as, but not limited to, NAS (FN-RG), NG application protocol (NGAP), general packet radio service (GPRS) tunnelling protocol user plane (GTPU), and the like, which may be existing protocols that may be supported by a standalone W-AGF.

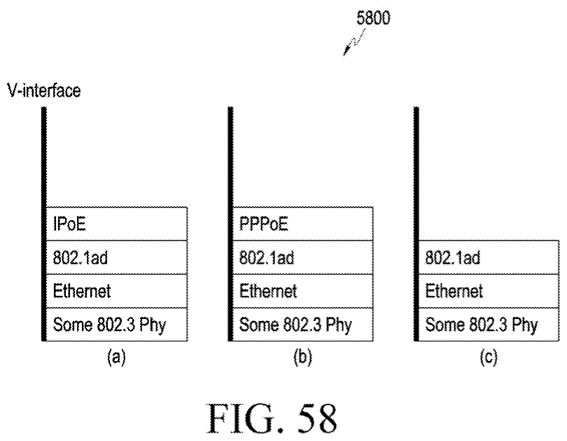

FIG. 58 illustrates a V-interface protocol stack (5800) for the FN-RG, according to an embodiment. For FN-RG, the W-AGF-C (5302) may treat the IP session initiation as a trigger to perform a proxy registration for the FN-RG and may establish the NAS connection with the AMF (102) where the NAS message may overlay the N2 interface as described for 5G-RG. In an embodiment, the FN-RG may trigger an IP over Ethernet (IpoE)/point-to-point protocol over Ethernet (PPPoE) based IP session.

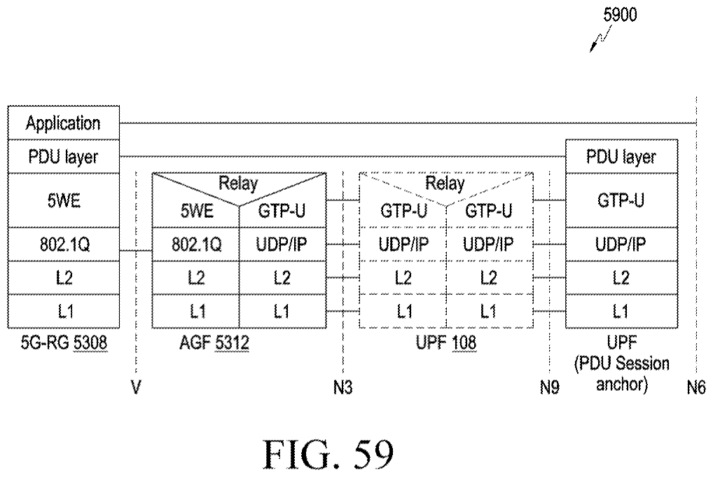

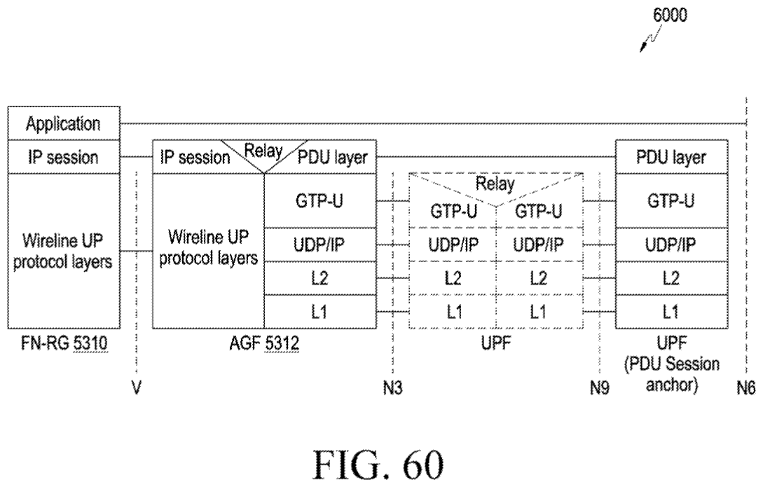

FIG. 59 illustrates a user plane stack (5900) for W-5GAN (W-AGF-U) for 5G-RG, according to an embodiment. FIG. 60 illustrates a user plane stack (6000) for W-5GAN (W-AGF-U) for FG-RG, according to an embodiment.

As shown in FIG. 59, the user plane encoding employed for PDU exchange between an W-AGF and a 5G-RG may be the IP packet or Ethernet frame appropriate to the PDU session type encapsulated in the 5WE, which may have been adapted into Ethernet transport. The W-AGF-C entity (5302) may assign a 5WE session ID and may binds the 5WE session ID to the PDU session ID. The 5WE session ID and the PDU session ID binding may be communicated to the 5G-RG. The 5G-RG may use the 5WE session ID to identify the UP packets of the PDU session.

As shown in FIG. 60, the user plane encoding employed for PDU exchange between an W-AGF and an FN-RG may be based on wireline protocols such as, but not limited to, IPoverPPP and IPoE as described in ETSI TR 101 178, and may follow IP-session lifecycle management.

In the proposed W-AGF CUPS architecture, the user plane protocols may be moved to the W-AGF-U entity (5304).

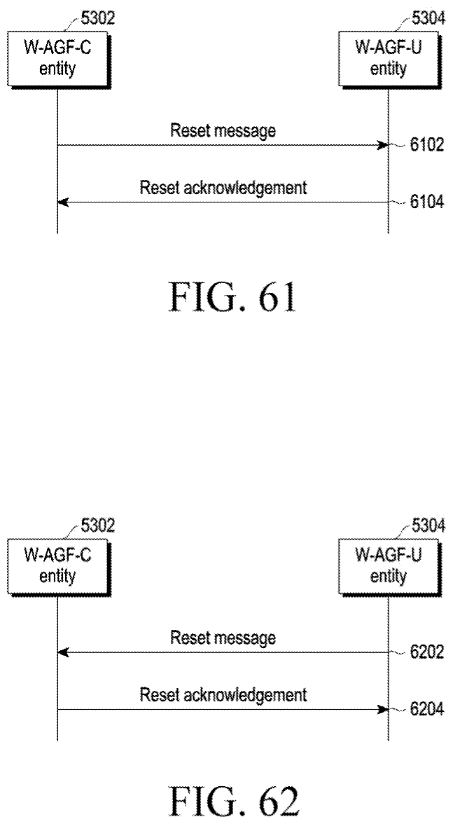

FIG. 61 is a sequence diagram illustrating a reset procedure initiated from the W-AGF-C entity (5302), according to an embodiment. As shown in FIG. 61, at operation 6102, the W-AGF-C entity (5302) may send a reset message (e.g., E12AP:RESET message or the like) to the W-AGF-U entity (5304). Based on the reset message, at operation 6104, the W-AGF-U entity (5304) may send a reset acknowledgement (e.g., E12AP:RESET acknowledgement message or the like) to the W-AGF-C entity (5302).

FIG. 62 is a sequence diagram illustrating a reset procedure initiated from the W-AGF-U entity (5304), according to an embodiment. As shown in FIG. 62, at operation 6202, the W-AGF-U entity (5304) may send the reset message to the W-AGF-C entity (5302). Based on the reset message, at operation 6204, the W-AGF-C entity (5302) may send the reset acknowledgement to the W-AGF-U entity (5304).

As shown in FIG. 61 and FIG. 62, the reset message may be sent by both the W-AGF-C entity (5302) and the W-AGF-U entity (5304) and may be used to request that the E12 interface, and/or parts of the E12 interface, be reset. Information in the reset message is shown in the Table 94.

TABLE 94
E12 Reset Message

| IE/Group Name | Presence | Range |
|---|---|---|
| Message Type | M (Mandatory) | |
| Transaction ID | M | |
| Cause | M | |
| CHOICE Reset Type | M | |
| >E12 interface | | |
| >>Reset All | M | |
| >Part of E12 interface | | |
| >>UE-associated logical E12- | | 1 |
| connection list | | |
| >>>UE-associated logical E12- | | 1 . . . <maxnoofIndividualE12ConnectionsToReset> |
| connection Item | | |
| >>>>W-AGF-C UE E12AP ID | O (optional) | |
| >>>>W-AGF-U UE E12AP ID | O | |

Referring to Table 94, maxnoofIndividualE12ConnectionsToReset may refer to a maximum number of UE-associated logical E12-connections that may be allowed to be reset in one message. For example, the value of maxnoofIndividualE12ConnectionsToReset may be 65536.

The reset acknowledge message may be sent by both the W-AGF-C entity (5302) and the W-AGF-U entity (5304) as a response to the reset message. Information in the reset acknowledge message is shown in the Table 95.

TABLE 95
E12 Reset Acknowledge Message

| IE/Group Name | Presence | Range |
|---|---|---|
| Message Type | M | |
| Transaction ID | M | |
| UE-associated logical E12-connection list | | 0 . . . 1 |
| >UE-associated logical E12-connection | | 1 . . . <maxnoofIndividualE12ConnectionsToReset> |
| Item | | |
| >>W-AGF-C UE E12AP ID | O | |
| >>W-AGF-U UE E12AP ID | O | |
| Criticality Diagnostics | O | |

Referring to Table 95, maxnoofIndividualE12ConnectionsToReset may indicate a maximum number of UE-associated logical E12-connections that may be allowed to be reset in one message. For example, the value of maxnoofIndividualE12ConnectionsToReset may be 65536.

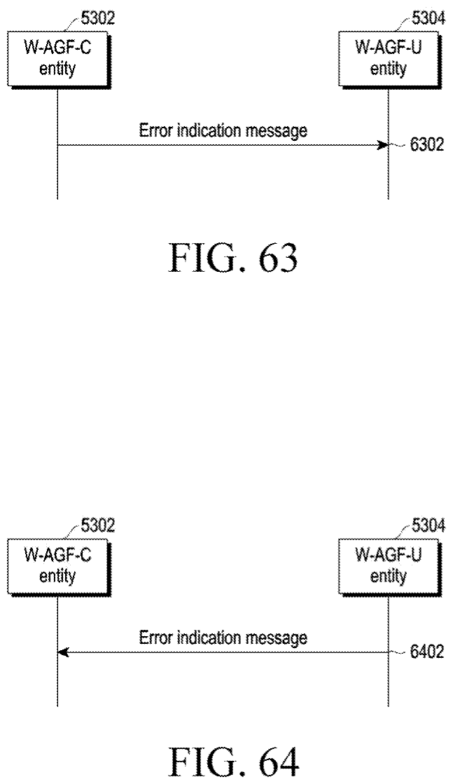

FIG. 63 is a sequence diagram illustrating an error indication procedure originated at the W-AGF-C entity (5302), according to an embodiment. At operation 6302, the W-AGF-C entity (5302) may send the error indication message (e.g., E12AP:ERROR INDICATION message or the like) to the W-AGF-U entity (5304).

FIG. 64 is a sequence diagram illustrating an error indication procedure originated at the W-AGF-U entity (5304), according to an embodiment. At operation 6402, the W-AGF-U entity (5304) may send the error indication message to the W-AGF-C entity (5302).

The error indication message may be sent by both the W-AGF-C entity (5302) and the W-AGF-U entity (5304) and may be used to indicate that some error has been detected in the node. Information in the error indication message is shown in the Table 96.

TABLE 96
E12 Error Indication Message

| IE/Group Name | Presence |
|---|---|
| Message Type | M |
| Transaction ID | M |
| W-AGF-C UE E12AP ID | O |
| W-AGF-U UE E12AP ID | O |
| Cause | O |
| Criticality Diagnostics | O |

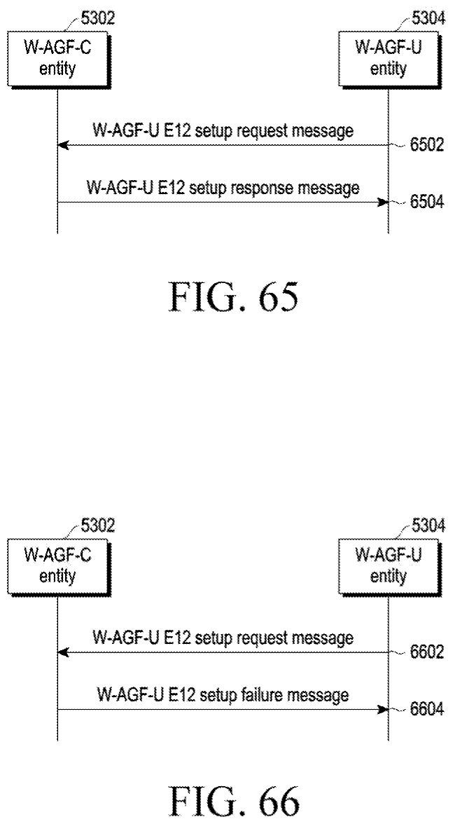

FIG. 65 is a sequence diagram illustrating a W-AGF-U E12 setup procedure during a success scenario, according to an embodiment. At operation 6502, the W-AGF-U entity (5304) may send the W-AGF-U E12 setup request message (e.g., E12AP:W-AGF-U E12 SETUP REQUEST message or the like) to the W-AGF-C entity (5302). Based on the W-AGF-U E12 setup request message, at operation 6504, the W-AGF-C entity (5302) may send the W-AGF-U E12 setup response message (e.g., E12AP:W-AGF-U E12 SETUP RESPONSE message or the like) to the W-AGF-U entity (5304).

FIG. 66 is a sequence diagram illustrating a W-AGF-U E12 setup procedure during a failure scenario, according to an embodiment. As shown in FIG. 66, at operation 6602, the W-AGF-U entity (5304) may send the W-AGF-U E12 setup request message to the W-AGF-C entity (5302). Based on the W-AGF-U E12 setup request message, at operation 6604, the W-AGF-C entity (5302) may send the W-AGF-U E12 setup failure message (e.g., E12AP:W-AGF-U E12 SETUP FAILURE message or the like) to the W-AGF-U entity (5304).

The W-AGF-U E12 setup request message may be sent by the W-AGF-U entity (5304) to transfer information for a Transport Network Layer (TNL) association. Information in the W-AGF-U E12 setup request message is shown in Table 97.

TABLE 97
W-AGF-U E12 Setup Request Message

| IE/Group Name | Presence | Range |
|---|---|---|
| Message Type | M | |
| Transaction ID | M | |
| W-AGF-U ID | M | |
| W-AGF-U Name | O | |
| CN Support | M | |
| Supported PLMNs | | 1 . . . <maxnoofSPLMNs> |
| >PLMN Identity | M | |
| >Slice Support List | O | |
| >Extended Slice Support List | O | |
| >QoS Parameters Support List | O | |
| W-AGF-U Capacity | O | |
| Transport Network Layer Address Info | O | |
| Extended W-AGF-U Name | O | |

Referring to Table 97, maxnoofSPLMNs may indicate the maximum number of supported PLMN IDs. For example, the value of maxnoofSPLMNs may be 12.

The W-AGF-U E12 setup response message may be sent by the W-AGF-C entity (5302) to transfer information for the TNL association. Information in the W-AGF-U E12 setup response message is shown in Table 98.

TABLE 98
W-AGF-U E12 Setup Response Message

| IE/Group Name | Presence |
|---|---|
| Message Type | M |
| Transaction ID | M |
| W-AGF-C Name | O |
| Transport Network Layer Address Info | O |
| Extended W-AGF-C Name | O |
| Criticality Diagnostics | O |

The W-AGF-U E12 setup failure message may be sent by the W-AGF-C entity (5302) to indicate an E12 setup failure. Information in the W-AGF-U E12 setup failure message is shown in Table 99.

TABLE 99
W-AGF-U E12 Setup Failure Message

| IE/Group Name | Presence |
|---|---|
| Message Type | M |
| Transaction ID | M |
| Cause | M |
| Time To Wait | O |
| Criticality Diagnostics | O |

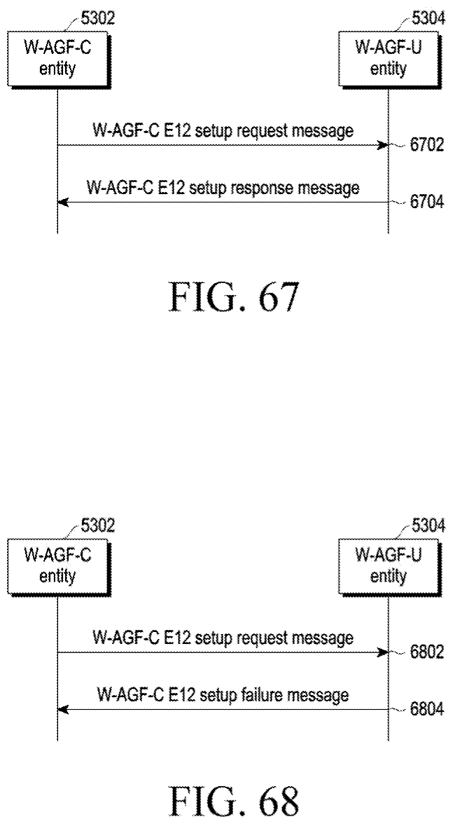

FIG. 67 is a sequence diagram illustrating a W-AGF-C E12 setup procedure during a success scenario, according to an embodiment. As shown in FIG. 67, at operation 6702, the W-AGF-C entity (5302) may send a W-AGF-C E12 setup request message (e.g., E12AP:W-AGF-C E12 SETUP REQUEST message or the like) to the W-AGF-U entity (5304). Based on the W-AGF-C E12 setup request message, at operation 6704, the W-AGF-U entity (5304) may send the W-AGF-C E12 setup response message (e.g., E12AP:W-AGF-C E12 SETUP RESPONSE message or the like) to the W-AGF-C entity (5302).

FIG. 68 is a sequence diagram illustrating a W-AGF-C E12 setup procedure during a failure scenario, according to an embodiment. As shown in FIG. 68, at operation 6802, the W-AGF-C entity (5302) may send a W-AGF-C E12 setup request message to the W-AGF-U entity (5304). Based on the W-AGF-C E12 setup request message, at operation 6804, the W-AGF-U entity (5304) may send the W-AGF-C E12 setup failure message (e.g., E12AP:W-AGF-C E12 SETUP FAILURE message or the like) to the W-AGF-C entity (5302).

The W-AGF-C E12 setup request message may be sent by the W-AGF-C to transfer information for a TNL association. Information in the W-AGF-C E12 setup request message is shown in Table 100.

TABLE 100
W-AGF-C E12 Setup Request Message

| IE/Group Name | Presence |
|---|---|
| Message Type | M |
| Transaction ID | M |
| W-AGF-C Name | O |
| Transport Network Layer Address Info | O |
| Extended W-AGF-C Name | O |

The W-AGF-C E12 setup response message may be sent by the W-AGF-U entity (5304) to transfer information for a TNL association. Information in the W-AGF-C E12 setup response message is shown in Table 101.

TABLE 101
W-AGF-C E12 Setup Response

| IE/Group Name | Presence | Range |
|---|---|---|
| Message Type | M | |
| Transaction ID | M | |
| W-AGF-U ID | M | |
| W-AGF-U Name | O | |
| CN Support | M | |
| Supported PLMNs | | 1 . . . <maxnoofSPLMNs> |
| >PLMN Identity | M | |
| >Slice Support List | O | |
| >Extended Slice Support List | O | |
| >QoS Parameters Support List | O | |
| W-AGF-U Capacity | O | |
| Transport Network Layer Address Info | O | |
| Extended W-AGF-U Name | O | |

Referring to Table 101, maxnoofSPLMNs may indicate the maximum number of supported PLMN IDs. For example, the value of maxnoofSPLMNs may be 12.

The W-AGF-C E12 setup failure message may be sent by the W-AGF-U entity (5304) to indicate an E12 setup failure. Information in the W-AGF-C E12 setup failure message is shown in Table 102.

TABLE 102
W-AGF-C E12 Setup Failure Message

| IE/Group Name | Presence |
|---|---|
| Message Type | M |
| Transaction ID | M |
| Cause | M |
| Time To Wait | O |
| Criticality Diagnostics | O |

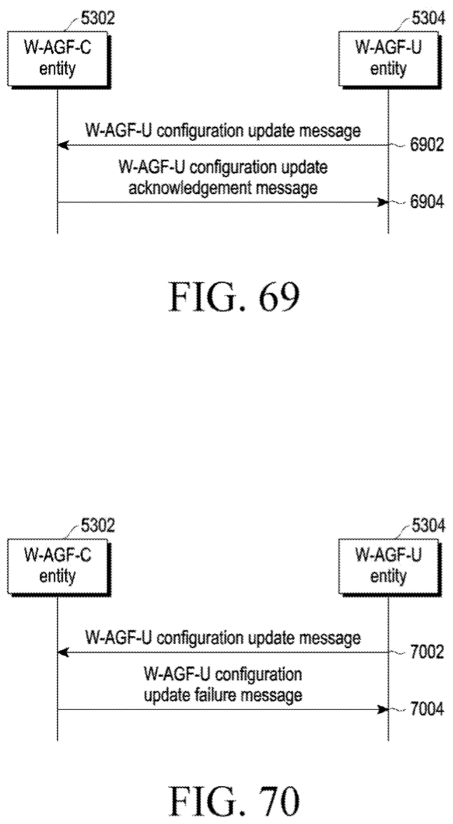

FIG. 69 is a sequence diagram illustrating a W-AGF-U configuration update procedure during a success scenario, according to an embodiment. As shown in FIG. 69, at operation 6902, the W-AGF-U entity (5304) may send a W-AGF-U configuration update message (e.g., E12AP:W-AGF-U CONFIGURATION UPDATE message) to the W-AGF-C entity (5302). Based on the W-AGF-U configuration update message, at operation 6904, the W-AGF-C entity (5302) may send a W-AGF-U configuration update acknowledgement message (e.g., E12AP:W-AGF-U CONFIGURATION UPDATE ACKNOWLEDGE message or the like) to the W-AGF-U entity (5304).

FIG. 70 is a sequence diagram illustrating a W-AGF-U configuration update procedure during a failure scenario, according to an embodiment. As shown in FIG. 70, at operation 7002, the W-AGF-U entity (5304) may send a W-AGF-U configuration update message to the W-AGF-C entity (5302). Based on the W-AGF-U configuration update message, at operation 7004, the W-AGF-C entity (5302) may send the W-AGF-U configuration update failure message (e.g., E12AP:W-AGF-U CONFIGURATION UPDATE FAILURE message or the like) to the W-AGF-U entity (5304).

The W-AGF-U configuration update message may be sent by the W-AGF-U to transfer updated information for the TNL association. Information of the W-AGF-U configuration update message is shown in Table 103.

TABLE 103
W-AGF-U Configuration Update Message

| IE/Group Name | Presence | Range |
|---|---|---|
| Message Type | M | |
| Transaction ID | M | |
| W-AGF-U ID | O | |
| W-AGF-U Name | O | |
| Supported PLMNs | | 0 . . . <maxnoofSPLMNs> |
| >PLMN Identity | M | |
| >Slice Support List | O | |
| >Extended Slice Support List | O | |
| >QoS Parameters Support List | O | |
| W-AGF-U Capacity | O | |
| W-AGF-U TNLA To Remove List | | 0 . . . 1 |
| >W-AGF-U TNLA To Remove Item | | 1 . . . <maxnoofTNLAssociations> |
| IEs | | |
| >>TNLA Transport Layer Address | M | |
| >>TNLA Transport Layer Address | O | |
| W-AGF-C | | |
| Transport Network Layer Address Info | O | |
| Extended W-AGF-U Name | O | |

Referring to Table 103, maxnoofSPLMNs may represent the maximum number of supported PLMN IDs, and maxnoofTNLAssociations may represent the maximum number of TNL associations between the W-AGF-U (5304) and the W-AGF-C (5302). For example, the value of maxnoofSPLMNs may be 12. As another example, the value of maxnoofTNLAssociations may be 32.

The W-AGF-U configuration update acknowledge message may be sent by the W-AGF-C entity (5302) to the W-AGF-U entity (5302) to acknowledge update of information for the TNL association. Information in the W-AGF-U configuration update acknowledge message is shown in Table 104.

TABLE 104
W-AGF-U Configuration Update Acknowledge Message

| IE/Group Name | Presence |
|---|---|
| Message Type | M |
| Transaction ID | M |
| Criticality Diagnostics | O |
| Transport Network Layer Address Info | O |

The W-AGF-U configuration update failure message may be sent by the W-AGF-C entity (5302) to indicate W-AGF-U configuration update failure. Information in the W-AGF-U configuration update failure message is shown in Table 105.

TABLE 105
W-AGF-U Configuration Update Failure Message

| IE/Group Name | Presence |
|---|---|
| Message Type | M |
| Transaction ID | M |
| Cause | M |
| Time To Wait | O |
| Criticality Diagnostics | O |

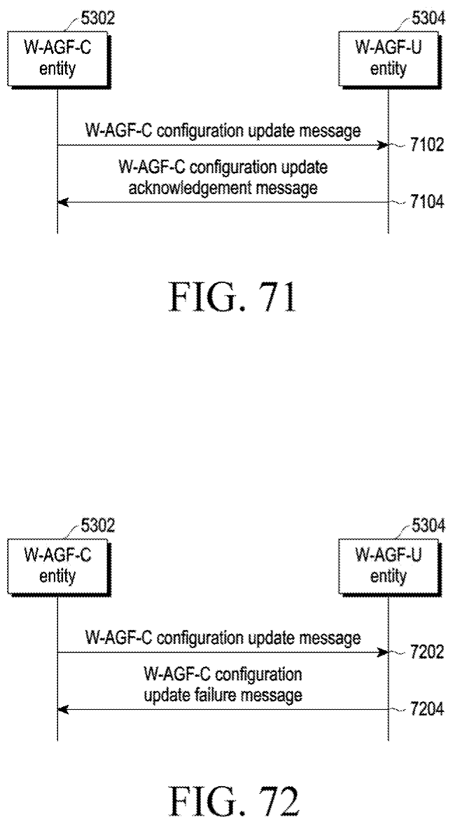

FIG. 71 is a sequence diagram illustrating a W-AGF-C configuration update procedure during a success scenario, according to an embodiment. As shown in FIG. 71, at operation 7102, the W-AGF-C entity (5302) may send a W-AGF-C configuration update message (e.g., E12AP:W-AGF-C CONFIGURATION UPDATE message or the like) to the W-AGF-U entity (5304). Based on the W-AGF-C configuration update message, at operation 7104, the W-AGF-U entity (5304) may send the W-AGF-C configuration update acknowledge message (e.g., E12AP:W-AGF-C CONFIGURATION UPDATE ACKNOWLEDGE message or the like) to the W-AGF-C entity (5302).

FIG. 72 is a sequence diagram illustrating a W-AGF-C configuration update procedure during a failure scenario, according to an embodiment. As shown in FIG. 72, at operation 7202, the W-AGF-C entity (5302) may send the W-AGF-C configuration update message to the W-AGF-U entity (5304). Based on the W-AGF-C configuration update message, at operation 7204, the W-AGF-U entity (5304) may send the W-AGF-C configuration update failure message (e.g., E12AP:W-AGF-C CONFIGURATION UPDATE FAILURE message or the like) to the W-AGF-C entity (5302).

The W-AGF-C configuration update message may be sent by the W-AGF-C entity (5302) to transfer updated information for the TNL association. Information in the W-AGF-C configuration update message is shown in Table 106.

TABLE 106
W-AGF-C Configuration Update Message

| IE/Group Name | Presence | Range |
|---|---|---|
| Message Type | M | |
| Transaction ID | M | |
| W-AGF-C Name | O | |
| W-AGF-C TNLA To Add List | | 0..1 |
| >W-AGF-C TNLA To Add Item IEs | | 1..<maxnoofTNLAssociations> |
| >>TNLA Transport Layer | M | |
| Information | | |
| >>TNLA Usage | M | |
| W-AGF-C TNLA To Remove List | | 0..1 |
| >W-AGF-C TNLA To Remove Item | | 1..<maxnoofTNLAssociations> |
| IEs | | |
| >>TNLA Transport Layer Address | M | |
| >>TNLA Transport Layer Address | O | |
| W-AGF-U | | |
| W-AGF-C TNLA To Update List | | 0..1 |
| >W-AGF-C TNLA To Update Item IEs | | 1..<maxnoofTNLAssociations> |
| >>TNLA Transport Layer Address | M | |
| >>TNLA Usage | O | |
| Transport Network Layer Address Info | O | |
| Extended W-AGF-C Name | O | |

Referring to Table 106, maxnoofNLAssociations may represent the maximum number of TNL Associations between the W-AGF-C entity (5302) and the W-AGF-U entity (5304). For example, the value for maxnoofTNLAssociations may be 32.

The W-AGF-C configuration update acknowledge message may be sent by the W-AGF-U entity (5304) to the W-AGF-C entity (5302) to acknowledge update of information for the TNL association. Information in the W-AGF-C configuration update acknowledge message is shown in Table 107.

TABLE 107
W-AGF-C Configuration Update Acknowledge Message

| IE/Group Name | Presence | Range |
|---|---|---|
| Message Type | M | |
| Transaction ID | M | |
| W-AGF-C TNLA Setup List | | 0..1 |
| >W-AGF-C TNLA Setup Item IEs | | 1..<maxnoofTNLAssociations> |
| >>TNLA Transport Layer Address | M | |
| W-AGF-C TNLA Failed to Setup List | | 0..1 |
| >W-AGF-C TNLA Failed To Setup | | 1..<maxnoofTNLAssociations> |
| Item IEs | | |
| >>TNLA Transport Layer Address | M | |
| >>Cause | M | |
| Criticality Diagnostics | O | |
| Transport Network Layer Address Info | O | |

The W-AGF-C configuration update failure message may be sent by the W-AGF-U entity (5304) to indicate W-AGF-C Configuration Update failure. Information in the W-AGF-C configuration update failure message is shown in Table 108.

TABLE 108
W-AGF-C Configuration Update Failure Message

| IE/Group Name | Presence |
|---|---|
| Message Type | M |
| Transaction ID | M |
| Cause | M |
| Time To Wait | O |
| Criticality Diagnostics | O |

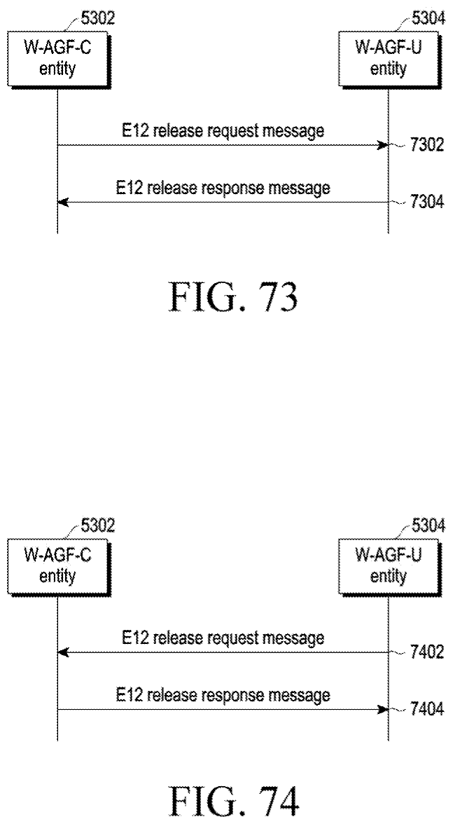

FIG. 73 is a sequence diagram illustrating an E12 release procedure initiated from the W-AGF-C entity (5302), according to an embodiment. As shown in FIG. 73, at operation 7302, the W-AGF-C entity (5302) may send an E12 release request message (e.g., E12AP:E12 RELEASE REQUEST message or the like) to the W-AGF-U entity (5304). Based on the E12 release request message, at operation 7304, the W-AGF-U entity (5304) may send the E12 release response message (e.g., E12AP:E12 RELEASE RESPONSE message) to the W-AGF-C entity (5302).

FIG. 74 is a sequence diagram illustrating an E12 Release procedure initiated from the W-AGF-U entity (5304), according to an embodiment. As shown in FIG. 74, at operation 7402, the W-AGF-U entity (5304) may send the E12 release request message to the W-AGF-C entity (5302). Based on the E12 release request message, at operation 7404, the W-AGF-C entity (5302) may send the E12 release response message to the W-AGF-U entity (5304).

The E12 release request message may be sent by both the W-AGF-C entity (5302) and the W-AGF-U entity (5304) and may be used to request the release of the E12 interface. Information in the E12 release request message is shown in Table 109.

TABLE 109
E12 Release Request Message

| IE/Group Name | Presence |
|---|---|
| Message Type | M |
| Transaction ID | M |
| Cause | M |

The E12 release response message may be sent by both the W-AGF-C entity (5302) and the W-AGF-U entity (5304) as a response to an E12 RELEASE REQUEST message. Information in the E12 release response message is shown in Table 110.

TABLE 110
E12 Release Response Message

| IE/Group Name | Presence |
|---|---|
| Message Type | M |
| Transaction ID | M |

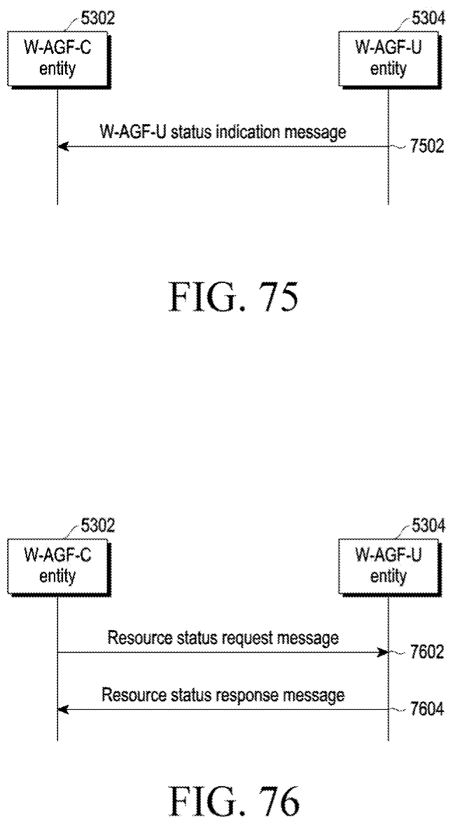

FIG. 75 is a sequence diagram illustrating a W-AGF-U status indication, according to an embodiment. As shown in FIG. 75, at operation 7502, the W-AGF-U entity (5304) may send a W-AGF-U status indication message (e.g., E12AP:W-AGF-U STATUS INDICATION message or the like) to the W-AGF-C entity (5302).

The W-AGF-U status indication message may be sent by the W-AGF-U entity (5304) to indicate to the W-AGF-C its status of overload. Information in the W-AGF-U status indication message is shown in Table 111.

TABLE 111
W-AGF-U Status Indication Message

| IE/Group Name | Presence |
|---|---|
| Message Type | M |
| Transaction ID | M |
| W-AGF-U Overload Information | M |

FIG. 76 is a sequence diagram illustrating a resource status reporting initiation during a success scenario, according to an embodiment. As shown in FIG. 76, at operation 7602, the W-AGF-C entity (5302) may send a resource status request message (e.g., E12AP:RESOURCE STATUS REQUEST message or the like) to the W-AGF-U entity (5304). Based on the resource status request message, at operation 7604, the W-AGF-U entity (5304) may send the resource status response message (e.g., E12AP:RESOURCE STATUS RESPONSE message or the like) to the W-AGF-C entity (5302).

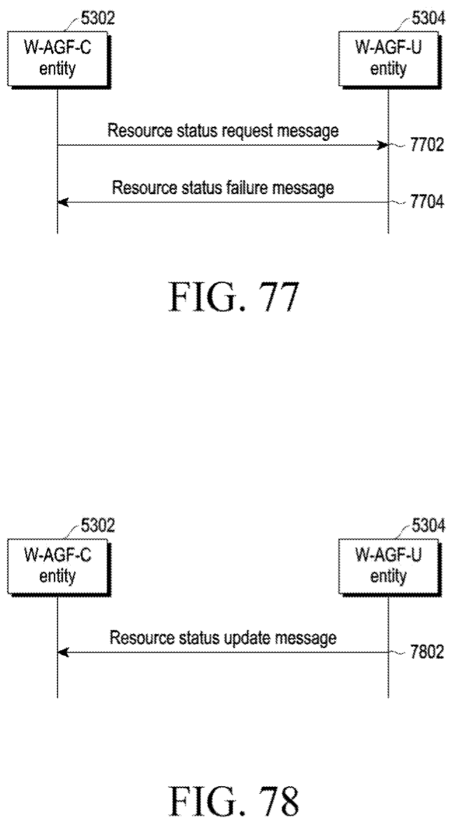

FIG. 77 is a sequence diagram illustrating a resource status reporting initiation during a failure scenario, according to an embodiment. As shown in FIG. 77, at operation 7702, the W-AGF-C entity (5302) may send the resource status request message to the W-AGF-U entity (5304). Based on the resource status request message, at operation 7704, the W-AGF-U entity (5304) may send the resource status failure message (e.g., E12AP:RESOURCE STATUS FAILURE message or the like) to the W-AGF-C entity (5302).

The resource status request message may be sent by a W-AGF-C entity (5304) to the W-AGF-U entity (5304) to initiate the requested measurement according to the parameters given in the message. Information in the resource status request message is shown in Table 112 and Table 113.

TABLE 112
E12 Resource Status Request Message

| IE/Group Name | Presence |
|---|---|
| Message Type | M |
| Transaction ID | M |
| W-AGF-C Measurement ID | M |
| W-AGF-U Measurement ID | C-ifRegistrationRequestStop |
| Registration Request | M |
| Report Characteristics | C-ifRegistrationRequestStart |
| Reporting Periodicity | O |

TABLE 113
E12 Resource Status Request Message Conditions

| Condition | Explanation |
|---|---|
| ifRegistrationRequestStop | This IE may be present if the Registration Request IE is |
| | set to the value “stop” |
| ifRegistrationRequestStart | This IE may be present if the Registration Request IE is |
| | set to the value “start”. |

The resource status response message may be sent by the W-AGF-U entity (5304) to indicate that the requested measurement, for all the measurement objects included in the measurement may be successfully initiated. Information in the resource status response message is shown in Table 114.

TABLE 114
E12 Resource Status Response Message

| IE/Group Name | Presence |
|---|---|
| Message Type | M |
| Transaction ID | M |
| W-AGF-C Measurement ID | M |
| W-AGF-U Measurement ID | M |
| Criticality Diagnostics | O |

The resource status failure message may be sent by the W-AGF-U entity (5304) to indicate that, for any of the requested measurement objects, the measurement may not be initiated. Information in the resource status failure message is shown in Table 115 and Table 116.

TABLE 115
E12 Resource Status Failure Message

| IE/Group Name | Presence |
|---|---|
| Message Type | M |
| Transaction ID | M |
| W-AGF-C Measurement ID | M |
| W-AGF-U Measurement ID | C-ifRegistrationRequestStop |
| Cause | M |
| Criticality Diagnostics | O |

TABLE 116
E12 Resource Status Failure Message Conditions

| Condition | Explanation |
|---|---|
| ifRegistrationRequestStop | This IE may be present if the Registration Request IE is |
| | set to the value “stop” |

FIG. 78 is a sequence diagram illustrating a resource status reporting during a success scenario, according to an embodiment. As shown in FIG. 78, at operation 7802, the W-AGF-U entity (5304) may send a resource status update message to the W-AGF-C entity (5302).

The resource status update message may be sent by W-AGF-U entity (5304) to the W-AGF-C entity (5302) to report the results of the requested measurements. Information in the resource status update message is shown in Table 117 and Table 118.

TABLE 117
E12 Resource Status Update Message

| IE/Group Name | Presence |
|---|---|
| Message Type | M |
| Transaction ID | M |
| W-AGF-C Measurement ID | M |
| W-AGF-U Measurement ID | M |
| TNL Available Capacity Indicator | O |
| Hardware (HW) Capacity Indicator | O |

TABLE 118
E12 Resource Status Update Message Ranges

| Range Bound | Explanation |
|---|---|
| maxnoofSPLMNs | Maximum number of Supported PLMN Ids. Value is 12. |
| maxnoofSliceItems | Maximum number of signalled slice support items. Value is |
| | 1024. |

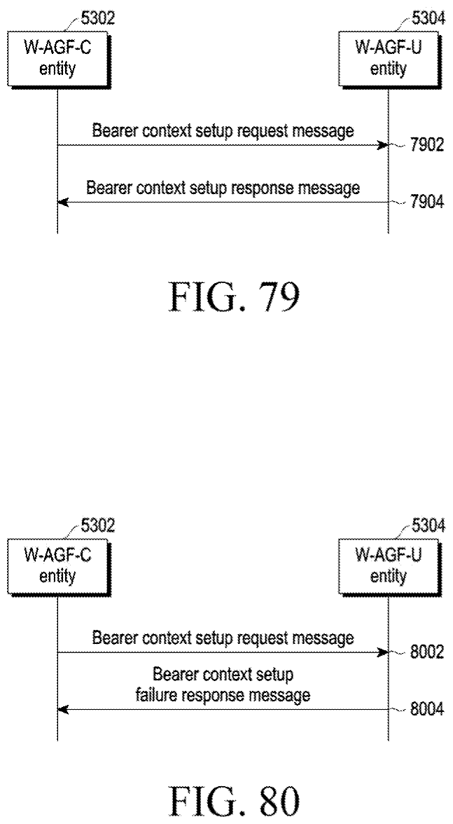

FIG. 79 is a sequence diagram illustrating a bearer context setup procedure during a success scenario, according to an embodiment. As shown in FIG. 79, at operation 7902, the W-AGF-C entity (5302) may send a bearer context setup request message (e.g., E12AP:BEARER CONTEXT SETUP REQUEST message or the like) to the W-AGF-U entity (5304). Based on the bearer context setup request message, at operation 7904, the W-AGF-U entity (5304) may send the bearer context setup response message (e.g., E12AP:BEARER CONTEXT SETUP RESPONSE message or the like) to the W-AGF-C entity (5302).

FIG. 80 is a sequence diagram illustrating a bearer context setup procedure during a failure scenario, according to an embodiment. As shown in FIG. 80, at operation 8002, the W-AGF-C entity (5302) may send the bearer context setup request message to the W-AGF-U entity (5304). Based on the bearer context setup request message, at operation 8004, the W-AGF-U entity (5304) may send the bearer context setup failure response message (e.g., E12AP:BEARER CONTEXT SETUP FAILURE RESPONSE message or the like) to the W-AGF-C entity (5302).

The bearer context setup request message may be sent by the W-AGF-C entity (5302) to request the W-AGF-U entity (5304) to setup a bearer context. Information in the bearer context setup request message is shown in Table 119.

TABLE 119
E12 Bearer Context Setup Request Message

| IE/Group Name | Presence |
|---|---|
| Message Type | M |
| W-AGF-C UE E12AP ID | M |
| Security Information | M |
| Serving PLMN | M |
| Activity Notification Level | M |
| UE Inactivity Timer | O |
| Bearer Context Status Change | O |
| W-AGF assigned UE IP address | M |
| W-AGF | |
| >PDU Session Resource To Setup List | M |
| >>PDU Session Resource To Setup | M |
| Item | |
| >>>PDU Session ID | M |
| >>>PDU Session Type | M |
| >>>Security Indication | O |
| >>>S-NSSAI | M |
| >>>NG UL UP Transport Layer | M |
| Information | |
| >>>PDU Session Inactivity Timer | O |
| . . . | |
| W-AGF UE ID | O |
| Trace Activation | O |

The bearer context setup response message may be sent by the W-AGF-U entity (5304) to confirm the setup of the requested bearer context. Information in the bearer context setup response message is shown in Table 120.

TABLE 120
E12 Bearer Context Setup Response Message

| IE/Group Name | Presence |
|---|---|
| W-AGF-C UE E12AP ID | M |
| W-AGF-U UE E12AP ID | M |
| W-AGF | M |
| > PDU Session Resource Setup List | M |
| >> PDU Session Resource Setup Item | M |
| >>> PDU Session ID | M |
| >>> 5WE PDU Session ID | C |
| | (For 5G-RG) |
| >>> NG DL UP Transport Layer Information | M |
| >>> QoS Flow Setup List | M |
| >>>>> QFI | |
| >>> QoS Flow Failed List | O |
| >>>>> QFI | M |
| . . . | |
| > PDU Session Resource Failed List | O |
| >> PDU Session Resource Failed Item | M |
| >>> PDU Session ID | M |
| >>> 5WE PDU Session ID | C |
| | (For 5G-RG) |
| >>> Cause | M |

The 5GC may inform the AGF of the created PDU session ID in the N2 PDU Session Resource Setup Request. Subsequently the AGF may assign a 5WE session ID and may bind the 5WE session ID to the PDU session ID. The 5WE session ID and the PDU session ID binding may be communicated to the 5G-RG. The 5G-RG may use the 5WE session ID to identify the UP packets of the PDU session. The 5WE Session ID may be used by the W-AGF-C (5302) to create Bearer Context on W-AGF-U as 5WE PDU Session ID for 5G-RG.

The bearer context setup failure message may be sent by the W-AGF-U entity (5304) to indicate that the setup of the bearer context was unsuccessful. Information in the bearer context setup failure message is shown in Table 121.

TABLE 121
E12 Bearer Context Setup Failure Message

| IE/Group Name | Presence |
|---|---|
| Message Type | M |
| W-AGF-C UE E12AP ID | M |
| W-AGF-U UE E12AP ID | O |
| Cause | M |
| Criticality Diagnostics | O |

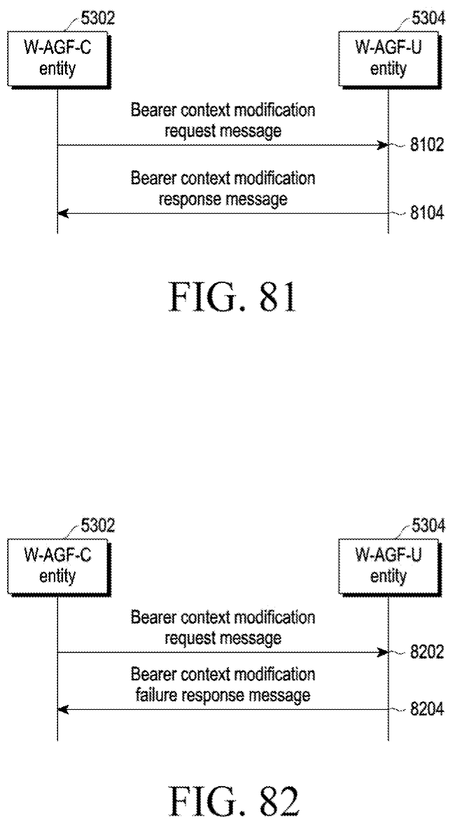

FIG. 81 is a sequence diagram illustrating a bearer context modification procedure during a success scenario, according to an embodiment. As shown in FIG. 81, at operation 8102, the W-AGF-C entity (5302) may send the bearer context modification request message (e.g., E12AP:BEARER CONTEXT MODIFICATION REQUEST message or the like) to the W-AGF-U entity (5304). Based on the bearer context modification request message, at operation 8104, the W-AGF-U entity (5304) may send the bearer context modification response message (e.g., E12AP:BEARER CONTEXT MODIFICATION RESPONSE message or the like) to the W-AGF-C entity (5302).

FIG. 82 is a sequence diagram illustrating a bearer context modification procedure during a failure scenario, according to an embodiment. As shown in FIG. 82, at operation 8202, the W-AGF-C entity (5302) may send the bearer context modification request message to the W-AGF-U entity (5304). Based on the bearer context modification request message, at operation 8204, the W-AGF-U entity (5304) may send the bearer context modification failure response message (e.g., E12AP:BEARER CONTEXT MODIFICATION FAILURE message or the like) to the W-AGF-C entity (5302).

The bearer context modification request message may be sent by the W-AGF-C entity (5302) to request the W-AGF-U entity (5304) to modify a bearer context. Information in the bearer context modification request message is shown in Table 122 and Table 123.

TABLE 122
E12 Bearer Context Modification Request Message

| IE/Group Name | Presence |
|---|---|
| Message Type | M |
| W-AGF-C UE E12AP ID | M |
| W-AGF-U UE E12AP ID | M |
| Security Information | O |
| UE DL Aggregate Maximum Bit Rate | O |
| UE DL Maximum Integrity Protected Data Rate | O |
| Bearer Context Status Change | O |
| New UL TNL Information Required | O |
| UE Inactivity Timer | O |
| Data Discard Required | O |
| W-AGF | |
| > PDU Session Resource To Setup List | O |
| >> PDU Session Resource To Setup Item | M |
| >>> PDU Session ID | M |
| >>> 5WE PDU Session ID | C |
| | (For 5G-RG) |
| >>> NG UL UP Transport Layer Information | M |
| >>> QoS Flows Information To Be Setup List | M |
| >>>> QFIs | M |

TABLE 123
E12 Bearer Context Modification Request Message

| IE/Group Name | Presence |
|---|---|
| > PDU Session Resource To Modify List | O |
| >> PDU Session Resource To Modify Item | M |
| >>> PDU Session ID | M |
| >>> 5WE PDU Session ID | C |
| | (For 5G-RG) |
| >>> NG UL UP Transport Layer Information | M |
| >>> QoS Flows Information To Be Setup List | M |
| >>> QoS Flows To Modify List | M |
| >>> QoS Flows To Remove List | M |
| > PDU Session Resource To Remove List | O |
| >> PDU Session Resource To Remove Item | |
| >>> PDU Session ID | M |
| >>> 5WE PDU Session ID | C |
| | (For 5G-RG) |
| >>> Cause | O |
| W-AGF UE ID | O |
| Activity Notification Level | O |

The bearer context modification response message may be sent by the W-AGF-C (5302) to confirm the modification of the requested bearer context. Information in the bearer context modification response message is shown in Table 124.

TABLE 124
E12 Bearer Context Modification Response Message

| IE/Group Name | Presence |
|---|---|
| Message Type | M |
| W-AGF-C UE E12AP ID | M |
| W-AGF-U UE E12AP ID | M |
| W-AGF | |
| > PDU Session Resource Setup List | O |
| > PDU Session Resource Failed List | O |
| > PDU Session Resource Modified List | O |
| > PDU Session Resource Failed To Modify List | O |
| > Retainability Measurements Information | O |

Table 125 shows the PDU session resource failed list IE.

TABLE 125
E12 PDU Session Resource Failed List IE

| IE/Group Name | Presence | Range |
|---|---|---|
| PDU Session Resource | | 1 . . . |
| Failed Modification Item | | <maxnoofPDUSessionResource> |
| > PDU Session ID | M | |
| > Cause | M | |

Table 126 shows the PDU session resource setup list IE.

TABLE 126
E12 PDU Session Resource Setup List IE

| IE/Group Name | Presence | Range |
|---|---|---|
| PDU Session | | 1 . . . |
| Resource Setup | | <maxnoofPDUSessionResource> |
| Modification Item | | |
| > PDU Session ID | M | |
| > 5WE PDU Session ID | C | |
| | (For 5G-RG) | |
| > Security Result | O | |
| > NG DL UP Transport | M | |
| Layer Information | | |
| > QoS Flow Setup List | | 1 |
| >> QoS Flow Setup Item | | 1 . . . <maxnoofQoSFlows> |
| >>> QFIs | M | |
| > QoS Flow Failed List | | 0 . . . 1 |
| >> QOS Failed Item | | 1 . . . <maxnoofQoSFlows> |
| >>> QFI | M | |
| >>> Cause | M | |
| > Redundant NG DL | O | |
| UP Transport Layer | | |
| Information | | |

Referring to Table 126, maxnoofPDUSessionResource may represent the maximum number of PDU sessions for a UE and maxnoofSPIs may represent the maximum number of SPIs for a UE. For example, the value of maxnoofPDUSessionResource may be 256. As another example, the value of maxnoofSPIs may be 64.

Table 127 shows the PDU session resource modified list IE.

TABLE 127
E12 PDU Session Resource Modified List IE

| IE/Group Name | Presence | Range |
|---|---|---|
| PDU Session Resource | | 1 . . . |
| Modified Item | | <maxnoofQoSFlowSessionResource> |
| > PDU Session ID | M | |
| > 5WE PDU Session ID | C | |
| | (For 5G-RG) | |
| > NG DL UP Transport | O | |
| Layer Information | | |
| > Security Result | O | |
| > PDU Session Data | O | |
| Forwarding Information | | |
| Response | | |
| > QoS Flow Setup List | | 0 . . . 1 |
| >> QoS Flow Setup Item | | 1 . . . <maxnoofQoSFlows> |
| >>> QFI | M | |
| > QOS Flow Modified List | | 0 . . . 1 |
| >> QoS Flow Modified Item | | 1 . . . <maxnoofQoSFlows> |
| >>> QFI | M | |
| > QoS Flow Failed | | 0 . . . 1 |
| To Modify List | | |
| >> QoS Flow Failed | | 1 . . . <maxnoofQoSFlows> |
| To Modify Item | | |
| >>> QFI | M | |
| >>> Cause | M | |
| > Redundant NG DL | O | |
| UP Transport Layer | | |
| Information | | |

Tables 128 and 129 show PDU session resource failed to modify list IE.

TABLE 128
E12 PDU Session Resource Failed To Modify List IE

| IE/Group Name | Presence | Range |
|---|---|---|
| PDU Session Resource | | 1 . . . |
| Failed To Modify Item | | <maxnoofPDUSessionResource> |
| > PDU session ID | M | |
| > 5WE PDU Session ID | C | |
| | (For 5G-RG) | |
| > Cause | M | |

TABLE 129
E12 PDU Session Resource Failed To Modify List IE Ranges

| Range Bound | Explanation |
|---|---|
| maxnoofQoSFlows | Maximum number of QoS Flow for a UE, |
| | the maximum value is 64. |
| maxnoofPDUSessionResource | Maximum number of PDU Sessions for |
| | a UE. Value is 256. |

The bearer context modification failure message may be sent by the W-AGF-U entity (5304) to indicate that the modification of the bearer context was unsuccessful. Information in the bearer context modification failure message is shown in Table 130.

TABLE 130
E12 Bearer Context Modification Failure Message

| IE/Group Name | Presence |
|---|---|
| Message Type | M |
| W-AGF-C UE E12AP ID | M |
| W-AGF-U UE E12AP ID | M |
| Cause | M |
| Criticality Diagnostics | O |

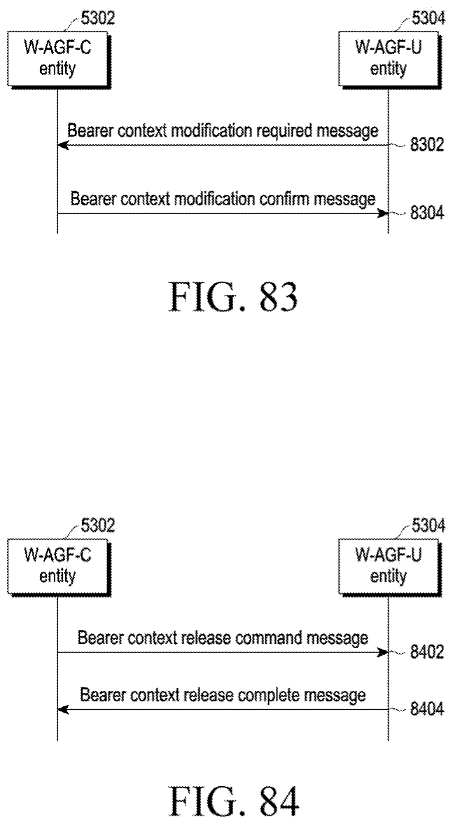

FIG. 83 is a sequence diagram illustrating a bearer context modification required procedure during a success scenario, according to an embodiment. As shown in FIG. 83, at operation 8302, the W-AGF-U entity (5304) may send a bearer context modification required message (e.g., E12AP:BEARER CONTEXT MODIFICATION REQUIRED message or the like) to the W-AGF-C entity (5302). Based on the bearer context modification required message, at operation 8304, the W-AGF-C entity (5302) may send the bearer context modification confirm message (e.g., E12AP:BEARER CONTEXT MODIFICATION CONFIRM message or the like) to the W-AGF-U entity (5304).

The bearer context modification required message may be sent by the W-AGF-U entity (5304) to inform the W-AGF-C entity (5302) that a modification of a bearer context is required (e.g., due to local problems at the W-AGF-U entity (5304)). Information in the bearer context modification required message is shown in Table 131 and Table 132.

TABLE 131
E12 Bearer Context Modification Required Message

| IE/Group Name | Presence |
|---|---|
| Message Type | M |
| W-AGF-C UE E12AP ID | M |
| W-AGF-U UE E12AP ID | M |
| W-AGF | |
| > PDU Session Resource To Modify List | O |
| > PDU Session Resource To Remove List | O |

TABLE 132
E12 Bearer Context Modification Required Message Ranges

| Range Bound | Explanation |
|---|---|
| maxnoofPDUSessionResource | Maximum number of PDU Sessions |
| | for a UE. Value is 256. |

Table 133 shows the PDU session resource to modify list IE.

TABLE 133
E12 PDU Session Resource To Modify List IE

| IE/Group Name | Presence | Range |
|---|---|---|
| PDU Session Resource | | 1 . . . |
| Required To Modify Item | | <maxnoofPDUSessionResource> |
| > PDU Session ID | M | |
| > 5WE PDU Session ID | C | |
| | (For 5G-RG) | |
| > NG DL UP Transport | O | |
| Layer Information | | |
| > QoS Flow To | | 0 . . . 1 |
| Modify List | | |
| >> QoS Flow To | | 1 . . . <maxnoofQoSFlows> |
| Modify Item | | |
| >>> QFIs | O | |
| >>> Cause | O | |
| > QoS Flow To | | 0 . . . 1 |
| Remove List | | |
| >> QoS Flow To | | 1 . . . <maxnoofQoSFlows> |
| Remove Item | | |
| >>> QFI | M | |
| >>> Cause | M | |
| > Redundant NG DL | O | |
| UP Transport Layer | | |
| Information | | |

Table 134 shows the PDU session resource to remove list IE.

TABLE 134
E12 PDU Session Resource To Remove List IE

| IE/Group Name | Presence | Range |
|---|---|---|
| PDU Session Resource | | 1 . . . |
| To Remove Item | | <maxnoofPDUSessionResource> |
| > PDU Session ID | M | |
| > 5WE PDU | C | |
| Session ID | (For 5G-RG) | |
| > Cause | O | |

The bearer context modification confirm message may be sent by the W-AGF-C entity (5302) to confirm the modification of the requested bearer context. The Information in the bearer context modification confirm message is shown in Table 135.

TABLE 135
E12 Bearer Context Modification Confirm Message

| IE/Group Name | Presence |
|---|---|
| Message Type | M |
| W-AGF-C UE E12AP ID | M |
| W-AGF-U UE E12AP ID | M |
| W-AGF | |
| > PDU Session Resource Modified List | O |

FIG. 84 is a sequence diagram illustrating a bearer context release procedure, according to an embodiment. As shown in FIG. 84, at operation 8402, the W-AGF-C entity (5302) may send a bearer context release command message (e.g., E12AP:BEARER CONTEXT RELEASE COMMAND message or the like) to the W-AGF-U entity (5304). Based on the bearer context release command message, at operation 8404, the W-AGF-U entity (5304) may send the bearer context release complete message (e.g., E12AP:BEARER CONTEXT RELEASE COMPLETE message or the like) to the W-AGF-C entity (5302).

The bearer context release command message may be sent by the W-AGF-C entity (5302) to command the W-AGF-U entity (5304) to release an UE-associated logical E12 connection. Information in the bearer context release command message is shown in Table 136.

TABLE 136
E12 Bearer Context Release Command Message

| IE/Group Name | Presence |
|---|---|
| Message Type | M |
| W-AGF-C UE E12AP ID | M |
| W-AGF-U UE E12AP ID | M |
| Cause | M |

The bearer context release complete message may be sent by the W-AGF-U entity (5304) to confirm the release of the UE-associated logical E12 connection. Information in the bearer context release complete message is shown in Table 137.

TABLE 137
E12 Bearer Context Release Complete Message

| IE/Group Name | Presence |
|---|---|
| Message Type | M |
| W-AGF-C UE E12AP ID | M |
| W-AGF-U UE E12AP ID | M |
| Criticality Diagnostics | O |
| Retainability Measurements Information | O |

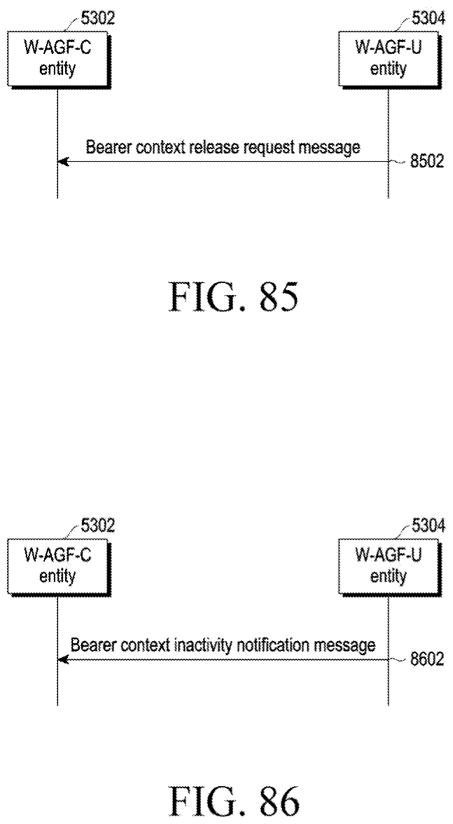

FIG. 85 is a sequence diagram illustrating a bearer context release request procedure, according to an embodiment. As shown in FIG. 85, at operation 8502, the W-AGF-U entity (5304) may send a bearer context release request message (e.g., E12AP:BEARER CONTEXT RELEASE REQUEST message or the like) to the W-AGF-C entity (5302). The bearer context release request message may be sent by the W-AGF-U entity (5304) to request the release of an UE-associated logical E12 connection. Information in the bearer context release request message is shown in Table 138.

TABLE 138
E12 Bearer Context Release Request Message

| IE/Group Name | Presence | Range |
|---|---|---|
| Message Type | M | |
| W-AGF-C UE E12AP ID | M | |
| W-AGF-U UE E12AP ID | M | |
| QoS Flow Status List | | 0 . . . 1 |
| > QoS Flow Status Item | | 1 . . . <maxnoofQoSFlows> |
| >> QFI | M | |
| Cause | M | |

| Range Bound | Explanation |
|---|---|
| maxnoofQoSFlows | Maximum number of QoS Flows |
| | for a UE. Value is 64. |

FIG. 86 is a sequence diagram illustrating a bearer context inactivity notification procedure, according to an embodiment. As shown in FIG. 86, at operation 8602, the W-AGF-U entity (5304) may send a bearer context inactivity notification message (e.g., E12AP:BEARER CONTEXT INACTIVITY NOTIFICATION message or the like) to the W-AGF-C entity (5302). The bearer context inactivity notification message (as shown in Table 139) may be sent by the W-AGF-U entity (5304) to provide information about the UE activity to the W-AGF-C entity (5302).

TABLE 139
E12 Bearer Context Inactivity Notification Message

| IE/Group Name | Presence | Range |
|---|---|---|
| Message Type | M | |
| W-AGF-C UE E12AP ID | M | |
| W-AGF-U UE E12AP ID | M | |
| CHOICE Activity Information | M | |
| > QoS Flow Activity List | | 1 |
| >> QoS Flow Activity Item | | 1 . . . <maxnoofQoSFlows> |
| >>> QFI | M | |
| >>> QoS Flow Activity | M | |
| > PDU Session Resource | | 1 |
| Activity List | | |
| >> PDU Session Resource | | 1 . . . |
| Activity Item | | <maxnoofPDUSessionResource> |
| >>> PDU session ID | M | |
| >>> 5WE PDU Session ID | C | |
| | (For 5G-RG) | |
| >>> PDU Session | M | |
| Resource Activity | | |
| > UE Activity | M | |

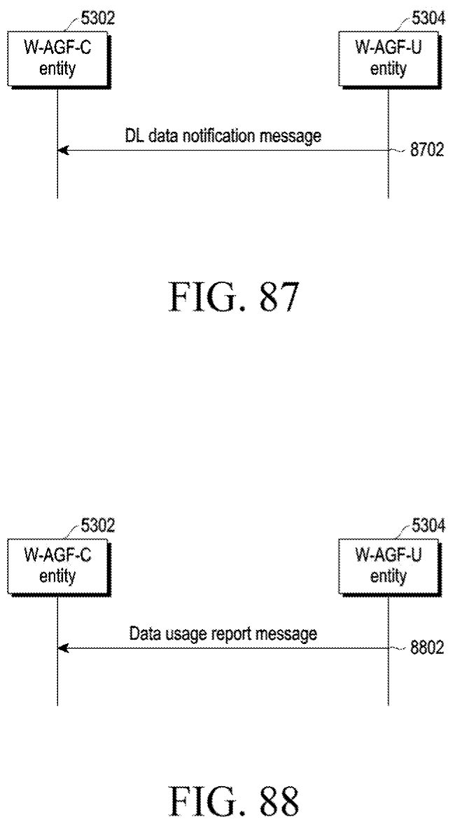

FIG. 87 is a sequence diagram illustrating a DL data notification procedure, according to an embodiment. As shown in FIG. 87, at operation 8702, the W-AGF-U entity (5304) may send a DL data notification message (e.g., E12AP:DL DATA NOTIFICATION message or the like) to the W-AGF-C entity (5302). The DL data notification message may be sent by the W-AGF-U entity (5304) to report data volumes. Information in the DL data notification message is shown in Table 140.

TABLE 140
E12 DL Data Notification Message

| IE/Group Name | Presence | Range |
|---|---|---|
| Message Type | M | |
| W-AGF-C UE | M | |
| E12AP ID | | |
| W-AGF-U UE | M | |
| E12AP ID | | |
| PDU Session To | | 1 |
| Notify List | | |
| > PDU Session | | 1 . . . |
| To Notify Item | | < maxnoofPDUSessionResource> |
| >> PDU Session ID | M | |

FIG. 88 is a sequence diagram illustrating a data usage report procedure, according to an embodiment. As shown in FIG. 88, at operation 8802, the W-AGF-U entity (5304) may send a data usage report message (e.g., E12AP:DATA USAGE REPORT message or the like) to the W-AGF-C entity (5302). The data usage report message may be sent by the W-AGF-U entity (5304) to report data volumes. Information in the data usage report message is shown in Table 141.

TABLE 141
E12 Data Usage Report Message

| IE/Group Name | Presence |
|---|---|
| Message Type | M |
| W-AGF-C UE E12AP ID | M |
| W-AGF-U UE E12AP ID | M |
| Data Usage Report List | M |

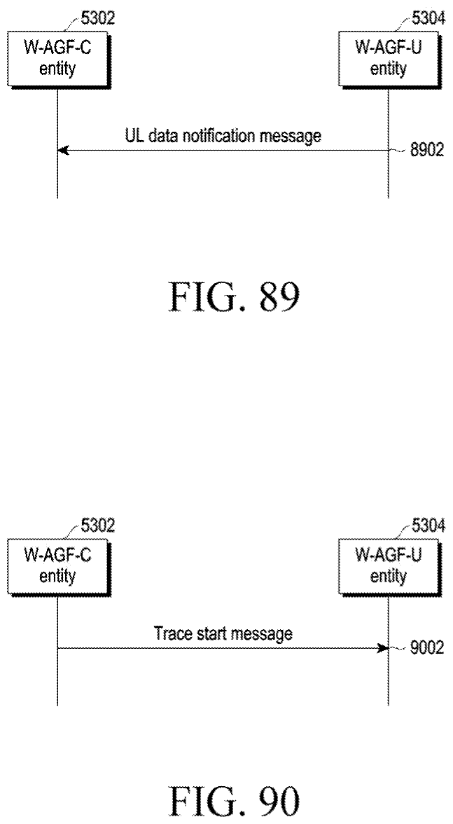

FIG. 89 is a sequence diagram illustrating a UL data notification procedure, according to an embodiment. As shown in FIG. 89, at operation 8902, the W-AGF-U entity (5304) may send a UL data notification message (e.g., E12AP:UL DATA NOTIFICATION message or the like) to the W-AGF-C entity (5302). The UL data notification message may be sent by the W-AGF-U entity (5304) to report data volumes. Information in the UL data notification message is shown in Table 142.

TABLE 142
E12 UL Data Notification Message

| IE/Group Name | Presence | Range |
|---|---|---|
| Message Type | M | |
| W-AGF-C UE | M | |
| E12AP ID | | |
| W-AGF-U UE | M | |
| E12AP ID | | |
| PDU Session To | | 1 |
| Notify List | | |
| > PDU Session | | 1 . . . |
| To Notify Item | | <maxnoofPDUSessionResource> |
| >> PDU Session ID | M | |

FIG. 90 is a sequence diagram illustrating a trace start procedure, according to an embodiment. As shown in FIG. 90, at operation 9002, the W-AGF-C entity (5302) may send a trace start message (e.g., E12AP:TRACE START message or the like) to the W-AGF-U entity (5304). The trace start message may be sent by the W-AGF-C entity (5302) to initiate a trace session for the UE. Information in the trace start message is shown in Table 143.

TABLE 143
E12 Trace Start Message

| IE/Group Name | Presence |
|---|---|
| Message Type | M |
| W-AGF-C UE E12AP ID | M |
| W-AGF-U UE E12AP ID | M |
| Trace Activation | M |

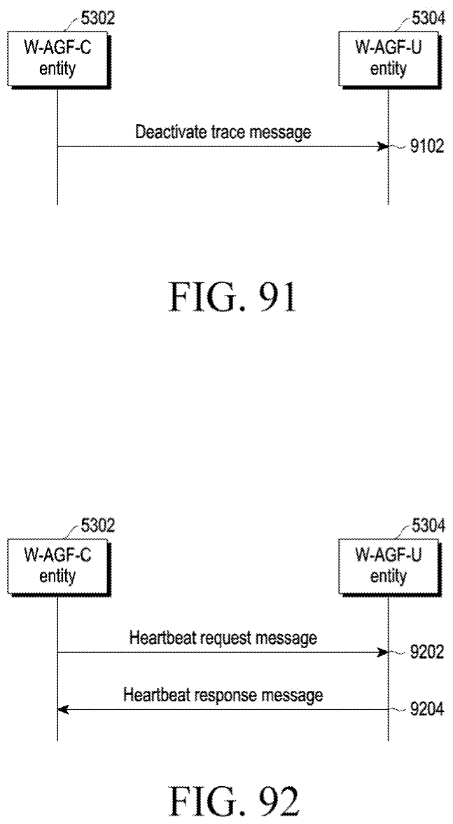

FIG. 91 is a sequence diagram illustrating a deactivate trace procedure, according to an embodiment. As shown in FIG. 91, at operation 9102, the W-AGF-C entity (5302) may send a deactivate trace message (e.g., E12AP:DEACTIVATE TRACE message or the like) to the W-AGF-U entity (5304). The deactivate trace message may be sent by the W-AGF-C entity (5302) to deactivate a trace session. Information in the deactivate trace message is shown in Table 144.

TABLE 144
E12 Deactivate Trace Message

| IE/Group Name | Presence |
|---|---|
| Message Type | M |
| W-AGF-C UE E12AP ID | M |
| W-AGF-U UE E12AP ID | M |
| Trace ID | M |

FIG. 92 is a sequence diagram illustrating a W-AGF-C heartbeat procedure, according to an embodiment. As shown in FIG. 92, at operation 9202, the W-AGF-C entity (5302) may send a heartbeat request message (e.g., W-AGF-C heartbeat related signalling message or the like) to the W-AGF-U entity (5304). Based on the heartbeat request message, at operation 9204, the W-AGF-C entity (5302) may receive the heartbeat response message from the W-AGF-U entity (5304).

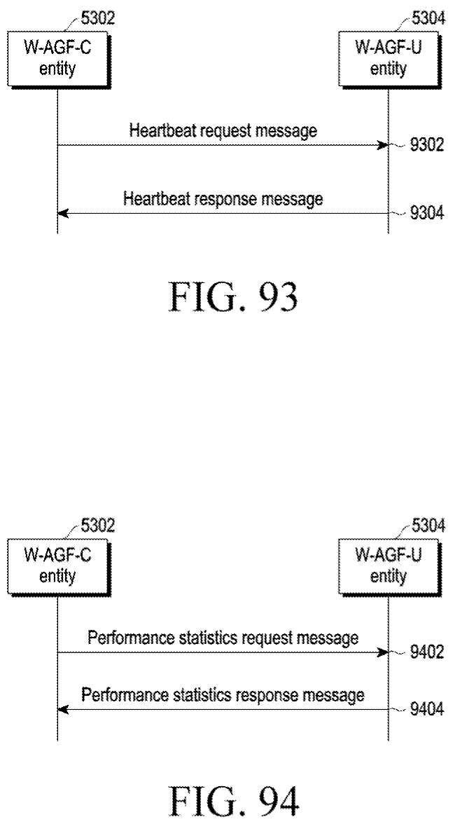

FIG. 93 is a sequence diagram illustrating a W-AGF-U heartbeat procedure, according to an embodiment. As shown in FIG. 93, at operation 9302, the W-AGF-U entity (5304) may send a heartbeat request message to the W-AGF-C entity (5302). Based on the heartbeat request message, at operation 9304, the W-AGF-U entity (5304) may receive the heartbeat response message from the W-AGF-C entity (5302).

The heartbeat request message may be sent by the W-AGF-C entity (5302) or the W-AGF-U entity (5304) to find out if the peer entity is alive. Information in the heartbeat request message is shown in Table 145.

TABLE 145
E12 Heartbeat Request Message

| IE/Group Name | Presence | Condition/Comment |
|---|---|---|
| Recovery Time Stamp | M | This IE may contain the time stamp |
| | | when the E12AP entity was started. |
| Source IP Address | O | This IE may be included when a |
| | | Network Address Translation device |
| | | is deployed in the network. |

The heartbeat response message may be sent as a response to a received heartbeat request message by the W-AGF-C entity (5302) or W-AGF-U entity (5304). Information in the heartbeat response message is shown in Table 146.

TABLE 146
E12 Heartbeat Response Message

| IE/Group Name | Presence | Condition/Comment |
|---|---|---|
| Recovery Time Stamp | M | This IE may contain the time stamp |
| | | when the E12AP entity was started. |

FIG. 94 is a sequence diagram illustrating a performance statistics reporting initiation during a success scenario, according to an embodiment. As shown in FIG. 94, at operation 9402, the W-AGF-C entity (5302) may send a performance statistics request message to the W-AGF-U entity (5304). Based on the performance statistics request message, at operation 9404, the W-AGF-C entity (5302) may receive the performance statistics response message from the W-AGF-U entity (5304).

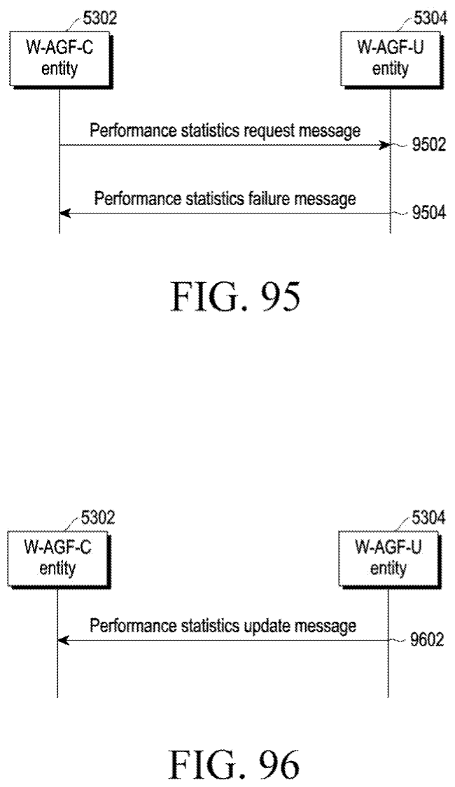

FIG. 95 is a sequence diagram illustrating a performance statistics reporting initiation during a failure scenario, according to an embodiment. As shown in FIG. 95, at operation 9502, the W-AGF-C entity (5302) may send the performance statistics request message to the W-AGF-U entity (5304). Based on the performance statistics request message, at operation 9504, the W-AGF-C entity (5302) may receive the performance statistics failure message from the W-AGF-U entity (5304).

The performance statistics request message may be sent by the W-AGF-C entity (5302) to the W-AGF-U entity (5304) to initiate the requested KPIs according to parameters given in the performance statistics request message. Information in the performance statistics request message is shown in Tables 147 and 148.

TABLE 147
E12 Performance Statistics Request Message

| IE/Group Name | Presence | IE Type and Reference | Semantics Description |
|---|---|---|---|
| Message Type | M | | |
| Transaction ID | M | INTEGER | |
| | | (0 . . . 255, . . . ) | |
| W-AGF-C KPI ID | M | INTEGER | Allocated by W-AGF-C |
| | | (1 . . . 4095, . . . ) | |
| W-AGF-U KPI ID | C-ifKPI | INTEGER | Allocated by W-AGF-U |
| | Registration | (1 . . . 4095, . . . ) | |
| | Request Stop | | |
| KPI Registration | M | ENUMERATED | Type of request for which |
| Request | | (start, stop, . . . ) | the performance statistics |
| | | | is required. |
| KPI Report | C-ifKPI | BITSTRING | Each position in the |
| Characteristics | Registration | (SIZE(32)) | bitmap indicates KPI |
| | Request Start | | object the W-AGF-U is |
| | | | requested to report. |
| | | | 1st Bit = Error Indication |
| | | | Ind Periodic, |
| | | | 2nd Bit = W-AGF-C E12 |
| | | | Setup Failure Ind Periodic, |
| | | | 3rd Bit = W-AGF-C |
| | | | Configuration Update |
| | | | Failure Ind Periodic, |
| | | | 4th Bit = Resource Status |
| | | | Failure Ind Periodic, |
| | | | 5th Bit = Bearer Context |
| | | | Setup Failure Ind Periodic, |
| | | | 6th Bit = Bearer Context |
| | | | Modification Failure Ind |
| | | | Periodic. |
| | | | 7th Bit = Performance |
| | | | Statistics Failure Ind |
| | | | Periodic. |
| | | | 8th Bit = Peer User Plane |
| | | | Feedback Failure Ind |
| | | | Periodic. |
| | | | Other bits may be |
| | | | ignored by the W-AGF-U. |
| KPI Reporting | O | ENUMERATED | Periodicity that may be |
| Periodicity | | (500 ms, 1000 ms, | used for reporting KPIs. |
| | | 2000 ms, 5000 ms, | Also used as the |
| | | 10000 ms, 20000 ms, | averaging window length |
| | | 30000 ms, 40000 ms, | for all performance |
| | | 50000 ms, 60000 ms, | statistics object if |
| | | 70000 ms, 80000 ms, | supported. |
| | | 90000 ms, 100000 ms, | |
| | | 110000 ms, 120000 ms, | |
| | | . . . ) | |

TABLE 148
E12 Performance Statistics Request Message Conditions

| Condition | Explanation |
|---|---|
| ifKPIRegistrationRequestStop | This IE may be present if the KPI |
| | Registration Request IE is set to |
| | the value “stop” |
| ifKPIRegistrationRequestStart | This IE may be present if the KPI |
| | Registration Request IE is set to |
| | the value “start”. |

The performance statistics response message may be sent by the W-AGF-U entity (5304) to indicate that the requested performance statistics (KPIs), for all the performance statistics objects included in the performance statistics message, may be successfully initiated. Information in the performance statistics response message is shown in Table 149.

TABLE 149
E12 Performance Statistics Response Message

| | | IE Type | Semantics |
|---|---|---|---|
| IE/Group Name | Presence | and Reference | Description |
| Message Type | M | | |
| Transaction ID | M | INTEGER | |
| | | (0 . . . 255, . . . ) | |
| W-AGF-C | M | INTEGER | Allocated |
| KPI ID | | (1 . . . 4095, . . . ) | by W-AGF-C |
| W-AGF-U | M | INTEGER | Allocated |
| KPI ID | | (1 . . . 4095, . . . ) | by W-AGF-U |
| Criticality | O | | |
| Diagnostics | | | |

The performance statistics failure message may be sent by the W-AGF-U (5304) to indicate that, for any of the requested performance statistics objects, the performance statistics may not be initiated. Information in the performance statistics failure message is shown in Tables 150 and 151.

TABLE 150
E12 Performance Statistics Failure Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| W-AGF-C | M | INTEGER | Allocated |
| KPI ID | | (1 . . . 4095, . . . ) | by W-AGF-C |
| W-AGF-U | C-ifKPI | INTEGER | Allocated |
| KPI ID | Registration | (1 . . . 4095, . . . ) | by W-AGF-U |
| | Request Stop | | |
| Cause | M | | Ignored by the |
| | | | receiver when |
| | | | the Complete |
| | | | Failure Cause |
| | | | Information IE |
| | | | is included |
| Criticality | O | | |
| Diagnostics | | | |

TABLE 151
E12 Performance Statistics Failure Message Conditions

| Condition | Explanation |
|---|---|
| ifKPIRegistrationRequestStop | This IE may be present if the KPI |
| | Registration Request IE is set to |
| | the value “stop” |

FIG. 96 is a sequence diagram illustrating a performance statistics reporting during a success scenario, according to an embodiment. At 9602, the W-AGF-C entity (5302) may receive the performance statistics update message from the W-AGF-U entity (5304). The performance statistics update message may be sent by the W-AGF-U entity (5304) to the W-AGF-C entity (5302) to report the results of the requested performance statistics. Information in the performance statistics update message is shown in Table 152.

TABLE 152
E12 Performance Statistics Update Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| W-AGF-C | M | INTEGER | Allocated |
| KPI ID | | (1 . . . 4095, . . . ) | by W-AGF-C |
| W-AGF-U | M | INTEGER | Allocated |
| KPI ID | | (1 . . . 4095, . . . ) | by W-AGF-U |
| Error Indication | O | INTEGER | |
| Indicator | | (0 . . . 16777216, . . . ) | |
| W-AGF-C E12 | O | W-AGF-C E12 | |
| Setup Failure | | Setup Failure KPI | |
| Indicator | | | |
| W-AGF-C | O | W-AGF-C | |
| Configuration Update | | Configuration Update | |
| Failure Indicator | | Failure KPI | |
| Resource Status | O | Resource Status | |
| Failure Indicator | | Failure KPI | |
| Bearer Context Setup | O | Bearer Context | |
| Failure Indicator | | Setup Failure KPI | |
| Bearer Context | O | Bearer Context | |
| Modification | | Modification | |
| Failure Indicator | | Failure KPI | |
| Performance Statistics | O | Performance | |
| Failure Indicator | | Statistics | |
| | | Failure KPI | |
| Peer User Plane | O | Peer User | |
| Feedback Failure | | Plane Feedback | |
| Indicator | | Failure KPI | |

The W-AGF-C E12 Setup Failure message may indicate a total number of W-AGF-C E12 Setup messages received from the W-AGF-C entity (5302) and a total number of W-AGF-C E12 Setup Failure messages sent to the W-AGF-C entity (5302). Information in the W-AGF-C E12 Setup Failure message is shown in Table 153.

TABLE 153
W-AGF-C E12 Setup Failure Message

| | | IE Type and | Semantics |
|---|---|---|---|
| IE/Group Name | Presence | Reference | Description |
| Total W-AGF-C | M | INTEGER | Total W-AGF-C |
| E12 Setup | | (0 . . . | E12 setup messages |
| Messages Received | | 16777216, . . . ) | received from |
| | | | W-AGF-C |
| Total W-AGF-C | M | INTEGER | Total W-AGF-C |
| E12 Setup Failure | | (0 . . . | E12 setup failure |
| Messages Sent | | 16777216, . . . ) | messages sent |
| | | | to W-AGF-C |

The W-AGF-C Configuration Update Failure KPI IE may indicate a total number of W-AGF-C Configuration Update messages received from the W-AGF-C entity (5302) and a total number of W-AGF-C Configuration Update Failure messages sent to the W-AGF-C entity (5302). Information in the Configuration Update Failure KPI IE is shown in Table 154.

TABLE 154
E12 Configuration Update Failure KPI IE

| | | IE Type and | Semantics |
|---|---|---|---|
| IE/Group Name | Presence | Reference | Description |
| Total W-AGF-C | M | INTEGER | Total W-AGF-C |
| Configuration Update | | (0 . . . | configuration update |
| Messages Received | | 16777216, . . . ) | messages received |
| | | | from W-AGF-C |
| Total W-AGF-C | M | INTEGER | Total W-AGF-C |
| Configuration Update | | (0 . . . | configuration update |
| Failure Messages Sent | | 16777216, . . . ) | failure messages sent |
| | | | to W-AGF-C |

The Resource Status Failure KPI IE may indicate a total number of Resource Status messages received from the W-AGF-C entity (5302) and a total number of Resource Status Failure messages sent to the W-AGF-C entity (5302). Information in the Resource Status Failure KPI IE is shown in Table 155.

TABLE 155
E12 Resource Status Failure KPI IE

| | | IE Type and | Semantics |
|---|---|---|---|
| IE/Group Name | Presence | Reference | Description |
| Total Resource | M | INTEGER | Total resource status |
| Status Messages | | (0 . . . | messages received |
| Received | | 16777216, . . . ) | from W-AGF-C |
| Total Resource | M | INTEGER | Total resource status |
| Status Failure | | (0 . . . | failure messages sent |
| Messages Sent | | 16777216, . . . ) | to W-AGF-C |

The Bearer Context Setup Failure KPI IE may indicate a total number of Bearer Context Setup messages received from the W-AGF-C entity (5302) and a total number of Bearer Context Setup Failure messages sent to the W-AGF-C entity (5302). Information in the Bearer Context Setup Failure KPI IE is shown in Table 156.

TABLE 156
E12 Bearer Context Setup Failure KPI IE

| | | IE Type and | Semantics |
|---|---|---|---|
| IE/Group Name | Presence | Reference | Description |
| Total Bearer | M | INTEGER | Total bearer context |
| Context Setup | | (0 . . . | setup messages received |
| Messages Received | | 16777216, . . . ) | from W-AGF-C |
| Total Bearer | M | INTEGER | Total bearer context |
| Context Setup Failure | | (0 . . . | setup failure messages |
| Messages Sent | | 16777216, . . . ) | Sent to W-AGF-C |

The Bearer Context Modification Failure KPI IE may indicate a total number of Bearer Context Modification messages received from the W-AGF-C entity (5302) and a total number of Bearer Context Modification Failure messages sent to W-AGF-C entity (5302). Information in the Bearer Context Modification Failure KPI IE is shown in Table 157.

TABLE 157
E12 Bearer Context Modification Failure KPI IE

| | | IE Type and | Semantics |
|---|---|---|---|
| IE/Group Name | Presence | Reference | Description |
| Total Bearer Context | M | INTEGER | Total bearer context |
| Modification Messages | | (0 . . . | modification messages |
| Received | | 16777216, . . . ) | received from W-AGF-C |
| Total Bearer Context | M | INTEGER | Total bearer context |
| Modification Failure | | (0 . . . | modification failure |
| Messages Sent | | 16777216, . . . ) | messages sent to |
| | | | W-AGF-C |

The Performance Statistics Failure KPI IE may indicate a total number of Performance Statistics messages received from the W-AGF-C entity (5302) and a total number of Performance Statistics Failure messages sent to the W-AGF-C entity (5302). Information in the Performance Statistics Failure KPI IE is shown in Table 158.

TABLE 158
E12 Performance Statistics Failure KPI IE

| | | IE Type and | Semantics |
|---|---|---|---|
| IE/Group Name | Presence | Reference | Description |
| Total Performance | M | INTEGER | Total performance |
| Statistics | | (0 . . . | statistics messages |
| Messages Received | | 16777216, . . . ) | received from |
| | | | W-AGF-C |
| Total Performance | M | INTEGER | Total performance |
| Statistics Failure | | (0 . . . | statistics failure |
| Messages Sent | | 16777216, . . . ) | messages sent to |
| | | | W-AGF-C |

The Peer User Plane Feedback Failure KPI IE may indicate a total number of Peer User Plane Feedback messages received from the W-AGF-C entity (5302) and a total number of Peer User Plane Feedback Failure messages sent to the W-AGF-C entity (5302). Information in the Peer User Plane Feedback Failure KPI IE is shown in Table 159.

TABLE 159
E12 Peer User Plane Feedback Failure KPI IE

| | | IE Type and | Semantics |
|---|---|---|---|
| IE/Group Name | Presence | Reference | Description |
| Total Peer User | M | INTEGER | Total peer user plane |
| Plane Feedback | | (0 . . . | feedback messages |
| Messages Received | | 16777216, . . . ) | received from |
| | | | W-AGF-C |
| Total Peer User | M | INTEGER | Total peer user plane |
| Plane Feedback | | (0 . . . | feedback failure |
| Failure Messages | | 16777216, . . . ) | messages sent to |
| Sent | | | W-AGF-C |

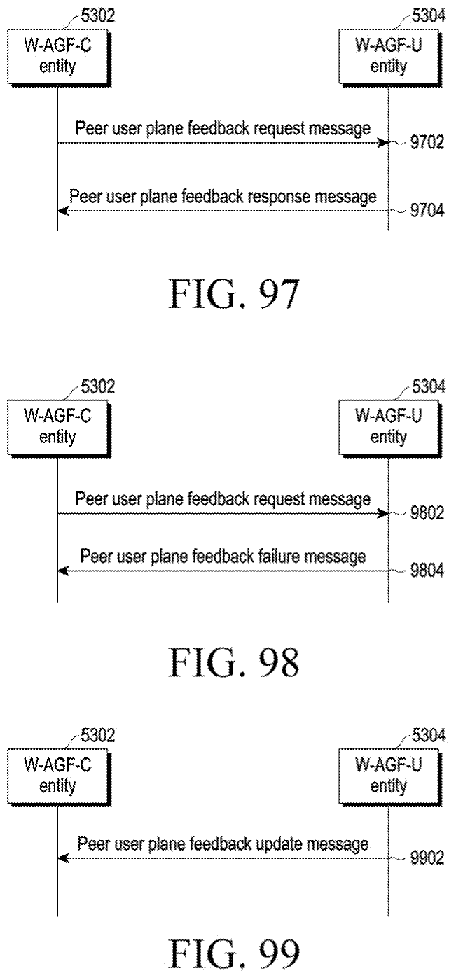

FIG. 97 is a sequence diagram illustrating a peer user plane feedback reporting initiation during a success scenario, according to an embodiment. As shown in FIG. 97, at operation 9702, the W-AGF-C entity (5302) may send a peer user plane feedback request message to the W-AGF-U entity (5304). Based on the peer user plane feedback request message, at operation 9704, the W-AGF-C entity (5302) may receive the peer user plane feedback response message from the W-AGF-U entity (5304).

FIG. 98 is a sequence diagram illustrating a peer user plane feedback reporting initiation during a failure scenario, according to an embodiment. As shown in FIG. 98, at operation 9802, the W-AGF-C entity (5302) may send a peer user plane feedback request message to the W-AGF-U entity (5304). Based on the peer user plane feedback request message, at operation 9804, the W-AGF-C entity (5302) may receive the peer user plane feedback failure message from the W-AGF-U entity (5304).

The peer user plane feedback request message may be sent by a W-AGF-C entity (5302) to the W-AGF-U entity (5304) to initiate the requested peer user plane feedback according to the parameters given in the message. The UPF may be considered as W-AGF-U's user plane peer. Information in the peer user plane feedback request message is shown in Table 160.

TABLE 160
E12 Peer User Plane Feedback Request Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| W-AGF-C Peer | M | INTEGER | Allocated by W-AGF-C |
| UP Feedback ID | | (1 . . . 4095, . . . ) | |
| W-AGF-U Peer | C-ifPeer UP | INTEGER | Allocated by W-AGF-U |
| UP Feedback ID | Feedback | (1 . . . 4095, . . . ) | |
| | Registration | | |
| | Request Stop | | |
| Peer UP Feedback | M | ENUMERATED | Type of request for which |
| Registration Request | | (start, stop, . . . ) | the peer user plane |
| | | | feedback is required. |
| Peer UP Feedback | C-ifPeer UP | BITSTRING | Each position in the |
| Report Characteristics | Feedback | (SIZE(32)) | bitmap indicates Peer |
| | Registration | | UP Feedback object the |
| | Request Start | | W-AGF-U is requested |
| | | | to report. |
| | | | 1st Bit = Peer UP |
| | | | Feedback Ind Periodic, |
| | | | Other bits may be |
| | | | ignored by the W-AGF-U. |
| Peer UP Feedback | O | ENUMERATED | Periodicity that may be |
| Reporting Periodicity | | (500 ms, 1000 ms, | used for reporting Peer |
| | | 2000 ms, 5000 ms, | UP Feedback. Also used |
| | | 10000 ms, 20000 ms, | as the averaging window |
| | | 30000 ms, 40000 ms, | length for all peer user |
| | | 50000 ms, 60000 ms, | plane feedback object if |
| | | 70000 ms, 80000 ms, | supported. |
| | | 90000 ms, 100000 ms, | |
| | | 110000 ms, 120000 ms, | |
| | | . . . ) | |

The peer user plane feedback response message may be sent by the W-AGF-U (5304) to indicate that the requested peer user plane feedback, for all the peer user plane feedback objects included in the peer user plane feedback may be successfully initiated. Information in the peer user plane feedback response message is shown in Table 161.

TABLE 161
E12 Peer User Plane Feedback Response Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| W-AGF-C Peer | M | INTEGER | Allocated |
| UP Feedback ID | | (1 . . . 4095, . . . ) | by W-AGF-C |
| W-AGF-U Peer | M | INTEGER | Allocated |
| UP Feedback ID | | (1 . . . 4095, . . . ) | by W-AGF-U |
| Criticality | O | | |
| Diagnostics | | | |

The peer user plane feedback failure message may be sent by the W-AGF-U (5304) to indicate that, for any of the requested peer user plane feedback objects, the peer user plane feedback may not be initiated. Information in the peer user plane feedback failure message is shown in Table 69.

TABLE 162
E12 Peer User Plane Feedback Failure Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| W-AGF-C Peer | M | INTEGER | Allocated |
| UP Feedback ID | | (1 . . . 4095, . . . ) | by W-AGF-C |
| W-AGF-U Peer | C-ifPeer UP | INTEGER | Allocated |
| UP Feedback ID | Feedback | (1 . . . 4095, . . . ) | by W-AGF-U |
| | Registration | | |
| | Request Stop | | |
| Cause | M | | Ignored by the |
| | | | receiver when the |
| | | | Complete Failure |
| | | | Cause Information |
| | | | IE is included |
| Criticality | O | | |
| Diagnostics | | | |

FIG. 99 is a sequence diagram illustrating a peer user plane feedback reporting during a success scenario, according to an embodiment. At operation 9902, the W-AGF-C entity (5302) may receive the peer user plane feedback update message from the W-AGF-U entity (5304).

The peer user plane feedback update message reports the results of the requested peer user plane feedback. Information in the peer user plane feedback update message is shown in Tables 163 and 164.

TABLE 163
E12 Peer User Plane Feedback Update Message

| | | IE Type and | Semantics |
|---|---|---|---|
| IE/Group Name | Presence | Reference | Description |
| Message Type | M | | |
| Transaction ID | M | INTEGER | |
| | | (0 . . . 255, . . . ) | |
| W-AGF-C Peer | M | INTEGER | Allocated |
| UP Feedback ID | | (1 . . . 4095, . . . ) | by W-AGF-C |
| W-AGF-U Peer | M | INTEGER | Allocated |
| UP Feedback ID | | (1 . . . 4095, . . . ) | by W-AGF-U |
| Peer UP | O | 1 . . . | |
| Feedback | | <maxnoofPeerUPs> | |
| Indicator | | | |
| > Transport | M | BIT STRING | Peer user plane |
| Layer Address | | (SIZE(1 . . . 160, | interface IP address. |
| | | . . . ) | IP address of UPF |
| | | | is considered. |
| >> Peer User | M | INTEGER | Feedback of peer |
| Plane Feedback | | (1 . . . 10) | user plane interface. |
| | | | Value 1 corresponds |
| | | | to the lowest |
| | | | performance and 10 |
| | | | corresponds to the |
| | | | highest performance. |

TABLE 164
E12 Peer User Plane Feedback Update Message Ranges

| Range Bound | Explanation |
|---|---|
| maxnoofPeerUPs | Maximum number of peer user plane interfaces. |
| | Value is 256. |

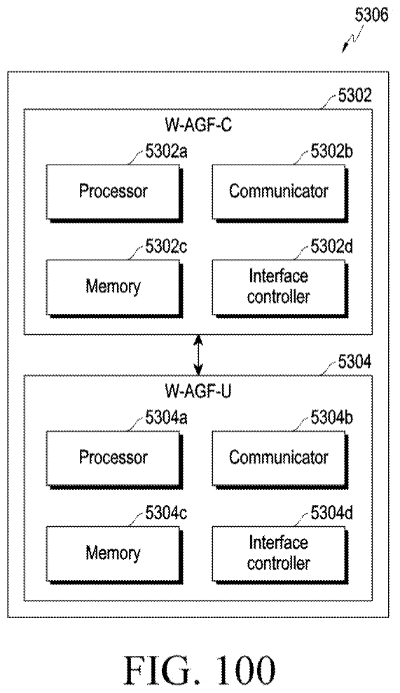

FIG. 100 shows various hardware components of the W-5GAN (5306), according to an embodiment. In an embodiment, the W-5GAN (5306) includes the W-AGF-C entity (5302) and the W-AGF-U entity (5304).

In an embodiment, the W-AGF-C entity (5302) includes a processor (5302a), a communicator (5302b), a memory (5302c), and an interface controller (5302d). The processor (5302a) may be communicatively coupled with the communicator (5302b), the memory (5302c), and the interface controller (5302d).

The interface controller (5302d) may split the functionality of the W-AGF into the control plane functionality, where the control plane functionality may be handled by the W-AGF-C entity (5302). Further, the interface controller (5302d) may add the interface between the W-AGF-C entity (5302) and the W-AGF-U entity (5304). Further, the interface controller (5302d) may monitor at least one of the operations associated with the interface and the services associated with the interface.

The interface controller (5302d) may be physically implemented by analog and/or digital circuits such as, but not limited to, logic gates, integrated circuits, microprocessors, microcontrollers, memory circuits, passive electronic components, active electronic components, optical components, hardwired circuits, or the like, and may optionally be driven by firmware. The interface controller (5302d) may be a part of the processor (5302a) or may be integrally referred to as at least one processor with the processor (5302a).

Further, the processor (5302a) may be configured to execute instructions stored in the memory (5302c) and to perform various processes of the W-AGF-C entity (5302). The communicator (5302b) may be configured for communicating internally between internal hardware components and with external devices via one or more networks. The memory (5302c) may also store instructions to be executed by the processor (5302a). The memory (5302c) may include non-volatile storage elements. Examples of such non-volatile storage elements may include, but not be limited to, magnetic hard discs, optical discs, floppy discs, flash memories, and/or forms of EPROMs and/or EEPROMs. The memory (5302a) may, in some examples, be considered a non-transitory storage medium. The term “non-transitory” may indicate that the storage medium may not be embodied in a carrier wave or a propagated signal. However, the term “non-transitory” may not be interpreted that the memory (5302c) may be non-movable. In certain examples, a non-transitory storage medium may store data that may, over time, change (e.g., in RAM or cache).

In an embodiment, the W-AGF-U entity (5304) may include a processor (5304a), a communicator (5304b), a memory (5304c), and an interface controller (5304d). The processor (5304a) may be communicatively coupled with the communicator (5304b), the memory (5304c), and the interface controller (5304d).

The interface controller (5304d) may split the functionality of the W-AGF into the user plane functionality, where the user plane functionality may be handled by the W-AGF-U entity (5304). Further, the interface controller (5304d) may add an interface between the W-AGF-C entity (5302) and the W-AGF-U entity (5304). Further, the interface controller (5304d) monitors at least one of the operation associated with the interface and the service associated with the interface.

The interface controller (5304d) may be physically implemented by analog and/or digital circuits such as, but not limited to, logic gates, integrated circuits, microprocessors, microcontrollers, memory circuits, passive electronic components, active electronic components, optical components, hardwired circuits, or the like, and may optionally be driven by firmware. The interface controller (5304d) may be a part of the processor (5304a) or may be integrally referred to as at least one processor with the processor (5304a).

The interface controller (e.g., 5302d or 5304d) may monitor an operation associated with the interface and/or a service associated with the interface. The operation may be and/or may include, for example, but not be limited to, the user plane traffic procedure, the interface management procedure, the bearer management procedure, the trace start procedure, the deactivate trace procedure, and/or the load management procedure. The service may be and/or may include, for example, but not be limited to, a UE-associated service and/or a non UE-associated service.

The interface management procedure may be, for example, but not be limited to, the reset procedure initiated from the W-AGF-C entity (5302), the reset procedure initiated from the at least one W-AGF-U entity (5304), the error indication procedure originated at the W-AGF-C entity (5302), the error indication procedure originated at the at least one W-AGF-U entity (5304), the W-AGF-U E12 setup procedure, the W-AGF-C E12 setup procedure, the W-AGF-U configuration update procedure, the W-AGF-C configuration update procedure, the E12 release procedure, and/or the W-AGF-U status indication procedure.

The bearer management procedure may be, for example, but not be limited to, the bearer context setup procedure, the bearer context release request procedure initiated by the at least one W-AGF-U entity (5304), the bearer context release procedure initiated by the W-AGF-C entity (5302), the bearer context modification procedure initiated by the W-AGF-C entity (5302), the bearer context modification required procedure initiated by the at least one W-AGF-U entity (5304), the bearer context inactivity notification procedure, the data usage report procedure, the DL data notification procedure, and the UL data notification procedure. The load management procedure may be, for example, but not be limited to, a resource status reporting initiation procedure, resource status reporting procedure.

The interface controller (5304d) may be physically implemented by analog and/or digital circuits such as, but not limited to, logic gates, integrated circuits, microprocessors, microcontrollers, memory circuits, passive electronic components, active electronic components, optical components, hardwired circuits, or the like, and may optionally be driven by firmware.

Further, the processor (5304a) may be configured to execute instructions stored in the memory (5304c) and to perform various processes of the W-AGF-U entity (5304). The processor (5302a), the processor (5304a), the interface controller (5302d) and the interface controller (5304d) may be integrally referred to as at least one processor of the W-AGF (5306). The communicator (5304b) may be configured for communicating internally between internal hardware components and with external devices via one or more networks. The memory (5304c) may also store instructions to be executed by the processor (5304a). The memory (5304c) may include non-volatile storage elements. Examples of such non-volatile storage elements may include, but not be limited to, magnetic hard discs, optical discs, floppy discs, flash memories, and/or forms of EPROMs and/or EEPROMs. The memory (5304c) may, in some examples, be considered a non-transitory storage medium. The term “non-transitory” may indicate that the storage medium may not be embodied in a carrier wave or a propagated signal. However, the term “non-transitory” may not be interpreted that the memory (5304c) may be non-movable. In some examples, a non-transitory storage medium may store data that may, over time, change (e.g., in RAM and/or cache).

Although FIG. 100 shows various hardware components of the W-5GAN (5306), it is to be understood that other embodiments are not limited thereon. In other embodiments, the W-5GAN (5306) may include less or more components. Further, the labels or names of the components are used only for illustrative purpose and may not limit the scope of the present disclosure. One or more components may be combined together to perform the same and/or a substantially similar function in the W-5GAN (5306).

FIG. 101 is a flowchart (10100) illustrating methods for managing the W-AGF operation in a W-5GAN (5306), according to an embodiment.

At operation 10102, the method may include configuring (or splitting) the W-AGF function as the W-AGF-C entity (5302) and the W-AGF-U entity (5304). At operation 10104, the method may include handling the control plane signalling by the W-AGF-C entity (5302) and the user plane signalling by the W-AGF-U entity (5304).

The method may be implemented in the CUPS on W-AGF by splitting W-AGF into the W-AGF-C entity (5302) and the W-AGF-U entity (5304) and by introducing the interface (e.g., E12 interface) between the W-AGF-C entity (5302) and the W-AGF-U entity (5304).

The various actions, acts, blocks, steps, or the like in the flowcharts (e.g., flowcharts 5200 and 10100) may be performed in the order presented, in a different order or simultaneously. Further, in some embodiments, some of the actions, acts, blocks, steps, or the like may be omitted, added, modified, skipped, or the like without departing from the scope of the present disclosure.

The foregoing description of the specific embodiments may so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art may recognize that the embodiments herein may be practiced with modification within the spirit and scope of the embodiments as described herein.

What is claimed is:

1. A method for managing an operation of a wireline access gateway function (W-AGF) in a wireless network, the method comprising:
transmitting, by a W-AGF control plane (W-AGF-C) entity of the W-AGF to a W-AGF user plane (W-AGF-U) entity of the W-AGF, a performance statistics request message for at least one object; and
receiving, by the W-AGF-C entity from the W-AGF-U entity, a performance statics response message in response to the performance statistics request message.

2. The method of claim 1, wherein the performance statistics request message includes at least one of a message type, transaction identifier (ID), a W-AGF-C key performance indicator (KPI) ID, a W-AGF-U KPI ID, a KPI Registration Request, KPI report characteristics, and a KPI reporting periodicity.

3. The method of claim 2, wherein the KPI report characteristics indicate the at least one object.

4. The method of claim 1, wherein the performance statics response message includes at least one of a message type, transaction identifier (ID), a W-AGF-C key performance indicator (KPI) ID, a W-AGF-U KPI ID and criticality diagnostics.

5. The method of claim 1, further comprising
receiving, by the W-AGF-C entity from the W-AGF-U entity, a performance statistics update message including at least one key performance indicator (KPI) for the at least one object.

6. The method of claim 5, wherein the performance statistics update message further includes at least one of a message type, transaction identifier (ID), a W-AGF-C key performance indicator (KPI) ID, a W-AGF-U KPI ID, an error indication indicator and criticality diagnostics.

7. The method of claim 1, wherein the at least one object comprises at least one of W-AGC-C E12 setup failure, W-AGC-C configuration update failure, resource status failure, bearer context setup failure, bearer context modification failure, performance statistics failure, and peer user plane feedback failure.

8. The method of claim 1, further comprising:
transmitting, by the W-AGF-C entity to the W-AGF-U entity, a peer user plane feedback request message for at least one peer up feedback object; and
receiving, by the W-AGF-C entity from the W-AGF-U entity, a peer user plane feedback response message in response to the peer user plane feedback request message.

9. The method of claim 8, wherein the peer user plane feedback request message includes at least one of a message type, transaction identifier (ID), a W-AGF-C peer user plane (UP) feedback ID, a W-AGF-U peer UP feedback ID, a peer UP feedback registration request, peer UP feedback report characteristics, and a peer UP feedback reporting periodicity.

10. The method of claim 9, wherein the peer UP feedback report characteristics indicate the at least one peer up feedback object.

11. The method of claim 8, wherein the performance statics response message includes at least one of a message type, transaction identifier (ID), a W-AGF-C peer user plane (UP) feedback ID, a W-AGF-U peer UP feedback ID and criticality diagnostics.

12. The method of claim 8, further comprising:
receiving, by the W-AGF-C entity from the W-AGF-U entity, a peer user plane feedback update message including a peer user plane feedback for the at least one peer up feedback object.

13. The method of claim 12, wherein the peer user plane feedback update message further includes at least one of a message type, transaction identifier, ID, a W-AGF-C peer user plane, UP, feedback ID, a W-AGF-U peer UP feedback ID, a peer UP feedback indicator and a transport layer address.

14. An apparatus for a wireline access gateway function (W-AGF) in a wireless network, comprising:
a memory storing instructions; and
at least one processor configured to, when executing the instructions, cause the apparatus to perform operations comprising:
transmitting, by a W-AGF control plane (W-AGF-C) entity of the W-AGF to a W-AGF user plane (W-AGF-U) entity of the W-AGF, a performance statistics request message for at least one object; and
receiving, by the W-AGF-C entity from the W-AGF-U entity, a performance statics response message in response to the performance statistics request message.

15. The apparatus of claim 14, wherein the operations further comprises:
receiving, by the W-AGF-C entity from the W-AGF-U entity, a performance statistics update message including at least one key performance indicator (KPI) for the at least one object.

16. The apparatus of claim 14, wherein the at least one object comprises at least one of W-AGC-C E12 setup failure, W-AGC-C configuration update failure, resource status failure, bearer context setup failure, bearer context modification failure, performance statistics failure, and peer user plane feedback failure.

17. The apparatus of claim 14, wherein the operations further comprises:
transmitting, by the W-AGF-C entity to the W-AGF-U entity, a peer user plane feedback request message for at least one peer up feedback object; and
receiving, by the W-AGF-C entity from the W-AGF-U entity, a peer user plane feedback response message in response to the peer user plane feedback request message.

18. The apparatus of claim 17, wherein the operations further comprises:
receiving, by the W-AGF-C entity from the W-AGF-U entity, a peer user plane feedback update message including a peer user plane feedback for the at least one peer up feedback object.

19. A non-transitory computer readable storage medium storing instructions which, when executed by at least one processor of an apparatus for a wireline access gateway function (W-AGF) in a wireless network, cause the apparatus to perform operations comprising:
transmitting, by a W-AGF control plane (W-AGF-C) entity of the W-AGF to a W-AGF user plane (W-AGF-U) entity of the W-AGF, a performance statistics request message for at least one object; and
receiving, by the W-AGF-C entity from the W-AGF-U entity, a performance statics response message in response to the performance statistics request message.

20. The non-transitory computer readable storage medium of claim 19, wherein the at least one object comprises at least one of W-AGC-C E12 setup failure, W-AGC-C configuration update failure, resource status failure, bearer context setup failure, bearer context modification failure, performance statistics failure, and peer user plane feedback failure.
